(19) United States
(12) Patent Application Publication
(10) Pub. No.: US 2025/0051208 A1
(43) Pub. Date: Feb. 13, 2025

(54) SYSTEMS AND METHODS FOR HIGH-EFFICIENCY NUTRIENT REMOVAL AND RECOVERY FROM WASTE STREAMS

(71) Applicant: UNIVERSITY OF SOUTH FLORIDA, Tampa, FL (US)

(72) Inventors: Daniel H. YEH, Tampa, FL (US); Itzé Alejandra KENNEY, Tampa, FL (US); Cynthia J CASTRO, Tampa, FL (US); Hsiang-Yang SHYU, Tampa, FL (US); Ahmet Erkan UMAN, Tampa, FL (US)

(21) Appl. No.: 18/710,601

(22) PCT Filed: Nov. 16, 2022
(86) PCT No.: PCT/US2022/050166

§ 371 Date: May 15, 2024

Related U.S. Application Data
(60) Provisional application No. 63/264,124, filed on Nov. 16, 2021.

(51) Int. Cl. C02F 9/00; B01D 61/14; B01D 61/16; B01D 61/18; B01D 63/06; B01D 69/02; B01D 71/34; C02F 1/00; C02F 1/28; C02F 1/44; C02F 1/52; C02F 3/28

(52) U.S. Cl. CPC C02F 9/00; B01D 61/145; B01D 61/16; B01D 61/18; B01D 63/06; B01D 69/02; B01D 71/34; B01D 2311/04; B01D 2315/10; B01D 2325/02833; C02F 1/004; C02F 1/281; C02F 1/444; C02F 2001/5218; C02F 1/5245; C02F 3/2866; C02F 2209/03; C02F 2303/16

(57) ABSTRACT

Provided is a solid precipitation reactor useful for waste-water treatment. The reactor can include a reaction chamber configured to receive feedwater and to allow particulates to at least partially precipitate from the feedwater to form an effluent, and a membrane module having at least one membrane filter configured to receive effluent from the reaction chamber and to filter suspended particulates from the effluent to produce a permeate and a concentrate. The concentrate can be reintroduced to the re-action chamber to allow additional particulates to precipitate. Systems and methods for wastewater treatment, and methods for regenerating a zeolite cation exchanger, using the solid precipitation reactor are also provided.

### CROSS-REFERENCE TO RELATED APPLICATIONS

The present application claims priority to U.S. Provisional Patent Application No. 63/264,124 that was filed Nov. 16, 2021, the entire contents of which are hereby incorporated by reference.

### FIELD OF THE INVENTION

The disclosed technology is generally directed to nutrient recovery. More particularly the technology is directed to solid precipitation reactors.

### BACKGROUND OF THE INVENTION

Developing countries, as well as rural areas in developed countries, are in need of reliable and affordable wastewater treatment that can target high concentrations of ammonium (NH₄⁺) in a small scale. The need for this solution stems from various eutrophic waste streams that are produced globally in areas that may not have the resources for a large-scale treatment facility. If not properly treated, high concentrations of NH₄⁺ can lead to devastating effects on the environment and human health. Problems and limitations of typical centralized approaches are becoming more apparent as populations continue to grow around the world. High cost associated with building, maintaining, and operating centralized wastewater treatment makes them unfeasible in areas where households are dispersed and have low population densities. Additionally, retrofitting a centralized system into an already urbanized area may not be viable due to high population density in certain areas. Land availability is a constraint that favors non-biological treatment systems. Decentralized wastewater treatment systems (DWTS) are defined by their ability to treat and dispose, at or near the source, relatively small volumes of wastewater for the purposes of protecting human health and the environment. Unlike centralized systems, DWTS are not connected to a central hub but instead often operate independently. There are currently different DWTS that are used worldwide, each with their own advantages and disadvantages. The work disclosed herein seeks to serve an additional alternative that can both remove and recover NH₄⁺.

The physiochemical process of a precipitation reactor is limited by the settling rate of precipitate. Precipitate form at various rates and contain different densities. Since the main driver for the separation and recovery of precipitated solids is gravity, this results in long waiting times. In some instances, depending on the settling velocity, a large amount of space is also needed to achieve settling. Time and space serve as the main concerns surrounding the conventional physiochemical processes of precipitation and separation. Thus, there remains a need for systems and methods for high-efficiency nutrient removal and recovery from waste streams.

### BRIEF SUMMARY OF THE INVENTION

In one aspect, the present disclosure provides a solid precipitation reactor. The solid precipitation reactor can comprise a reaction chamber configured to receive feedwater and to allow particulates to at least partially precipitate from the feedwater to form an effluent. The solid precipitation reactor can further comprise a membrane module having at least one membrane filter configured to receive effluent from the reaction chamber and to filter suspended particulates from the effluent to produce a permeate and a concentrate. In some embodiments, the concentrate is reintroduced to the reaction chamber to allow additional particulates to precipitate.

In some embodiments, the reaction chamber of the solid precipitation reactor comprises a completely stirred reactor (CSTR) or a fluidized bed reactor (FBR). In some embodiments, the at least one membrane filter of the solid precipitation reactor comprises at least one ultrafiltration membrane filter. In some embodiments, the membrane module of the solid precipitation reactor is at least partially submerged into the reaction chamber. In some embodiments, the membrane module is configured for one of crossflow or dead-end filtration.

In some embodiments, the at least one membrane filter of the solid precipitation reactor is a crossflow tubular ultrafiltration membrane. In some embodiments, the at least one membrane filter is made of a polyvinylidene fluoride, polyethersulfone, polyacrylonitrile, or ceramic material. In some embodiments, the at least one membrane filter comprises tubular, flat sheet, or hollow fiber. In some embodiments, the at least one membrane filter has a pore size between 0.005 micrometers and 0.2 micrometers.

In some embodiments, the solid precipitation reactor further comprises an agitator system configured to mix the feedwater within the reaction chamber.

In some embodiments, the solid precipitation reactor further comprises a solids harvesting loop wherein suspended particulates in the reactor are removed and the liquid effluent is returned to the reactor. In some embodiments, the solids harvesting loop comprises a media filter. In some embodiments, the solids harvesting loop comprises a filtration sock or a paper filter. For example, the media filter, filtration sock, or paper filter can have pore sizes between 1 micrometer to 500 micrometers, such as between 1 micrometer to 100 micrometers.

The reaction chamber of the solid precipitation reactor can operate in a continuous mode, a batch mode, or a combination thereof.

In some embodiments, the solid precipitation reactor further comprises a pump system configured to control the flow of wastewater through the reaction chamber and membrane module.

In some embodiments, the solid precipitation reactor further comprises a transducer system. For example, the transducer system can measure at least one of a pressure of the feedwater, a pressure of the permeate, or a pressure of the concentrate.

In some embodiments, the solid precipitation reactor is configured for precipitation of magnesium ammonium phosphate (MAP).

In another aspect, the present disclosure provides a system for wastewater treatment. The system can comprise a digesting unit configured to received wastewater and to pre-treat the wastewater to produce feedwater. The system can further comprise the solid precipitation reactor as described herein that receives feedwater from the digesting unit to produce a permeate. The system can further comprise an ion exchange unit that receives the permeate from the reaction chamber of the solid precipitation reactor to produce treated permeate. The ion exchange unit can comprise, for example, a zeolite cation exchanger.

In some embodiments, the ion exchange unit of the system for wastewater treatment is configured for regeneration by a regeneration solution to produce a waste solution, such as a zeolite waste solution generated from the zeolite bed. In some embodiments, the system is configured such that the waste solution (such as the zeolite waste solution) is recycled to the solid precipitation reactor to produce a recycled permeate. In some embodiments, the system is configured such that the recycled permeate is reintroduced to the ion exchange unit.

In another aspect, the present disclosure provides a vehicle for water treatment. The vehicle can comprise the solid precipitation reactor as described herein, which is mounted onto a mobile carrier. In some embodiments, the vehicle is configured to regenerate a zeolite cation exchanger using a regeneration solution to produce a zeolite waste solution, wherein the zeolite waste solution is fed to the solid precipitation reactor. In some embodiments, the vehicle is equipped with the regeneration solution. In some embodiments, the vehicle is equipped with the zeolite cation exchanger.

In another aspect, the present disclosure provides a method for treating wastewater. The method can comprise injecting wastewater comprising ammonium ions (NH₄⁺) and phosphate ions (PO₄³⁻) into the solid precipitation reactor as described herein. The method can further comprise contacting the injected wastewater in the reactor with magnesium ions (Mg²⁺) and optionally additional phosphate ions (PO₄³⁻), thereby producing a mixture comprising a solid. The method can further comprise filtering the mixture thereby isolating the solid and producing precipitation-treated water.

In some embodiments, the wastewater comprises 0.1-100 g-N/L NH₄⁺. In some embodiments, the wastewater comprises 0.1-1 g/L PO₄³⁻. In some embodiments, the molar ratio of NH₄⁺:PO₄³⁻:Mg²⁺ is between 1:1:1 to 1:1.1:1.4. In some embodiments, no less than 94% of NH₄⁺ in the wastewater is recovered as the solid. In some embodiments, the solid comprises magnesium ammonium phosphate (MAP). In some embodiments, the solid comprises struvite (MgNH₄PO₄·6H₂O) or dittmarite (MgNH₄PO₄·H₂O) crystals. The method for treating wastewater as described herein can be performed in batches or continuously.

In some embodiments, the pH of the wastewater is alkaline. In some embodiments, the membrane's transmembrane pressure (TMP) of the reactor is below 0.26 bar for no less than 3 days. In some embodiments, the method for treating wastewater further comprises, prior to injecting the wastewater into the reactor, pretreating a wastewater reservoir with a digesting unit to generate feedwater for the reactor. For example, the method can comprise treating the wastewater with a digesting unit to generate a feedwater and injecting the feedwater into the solid precipitation reactor.

In some embodiments, the method for treating wastewater further comprises contacting the precipitation-treated water with a zeolite cation exchanger to generate ion exchange-treated water. For example, the zeolite cation exchanger for the system, the vehicle, and the method as described herein can comprise clinoptilolite, chabazite, erionite, mordenite, or synthetic zeolite.

The method of any one of claim 37-38, further comprising contacting the zeolite cation exchanger with a regenerating solution to produce a regenerated zeolite cation exchanger and a zeolite waste solution. For example, the regeneration solution can comprise NaCl, CaCl₂, MgCl₂, KCl, or a combination thereof. In some embodiments, the method further comprises recycling the zeolite waste solution to the solid precipitation reactor to generate the solid and a recycled permeate, and reintroducing the recycled permeate to the zeolite cation exchanger.

In some embodiments, the zeolite waste solution comprises 0.01 g/L NH₄⁺ to 100 g/L NH₄⁺. In some embodiments, no less than 94% of NH₄⁺ from the zeolite waste solution is recovered in the solid. In some embodiments, the zeolite waste solution is treated with Mg²⁺ and PO₄³⁻ to achieve between 1:1:1 to 1:1.1:1.4 molar ratio of NH₄⁺:PO₄³⁻:Mg⁺.

In another aspect, the present disclosure provides a method of regenerating a zeolite cation exchanger having bound ammonium ions. The method can comprise contacting the zeolite cation exchanger having bound ammonium ions with a regenerating solution to produce a regenerated zeolite cation exchanger and a zeolite waste solution comprising the ammonium ions. The method can further comprise introducing the zeolite waste solution to the solid precipitation reactor as described herein to generate a solid and a permeate. In some embodiments, the solid comprises struvite.

In some embodiments, the method of regenerating a zeolite cation exchanger further comprises recycling the permeate to the zeolite cation exchanger to regenerate the zeolite cation exchanger. In some embodiments, the method further comprises contacting wastewater comprising ammonium ions with a fresh zeolite cation exchanger to generate the zeolite cation exchanger having bound ammonium ions. In some embodiments, the method further comprises pretreating a wastewater reservoir with a digesting unit to generate feedwater. For example, the method can comprise treating the wastewater with a digesting unit to generate a feedwater and contacting the feedwater with the fresh zeolite cation exchanger. As used herein, “fresh” zeolite cation exchangers include zeolites that have not been exposed to wastewater or feedwater and zeolites that have been regenerated by the methods disclosed herein and have not been again exposed to wastewater or feedwater.

In some embodiment, the solid precipitation reactor for regenerating a zeolite cation exchanger is mounted onto a mobile carrier. The mobile carrier, for example, can be equipped with the regenerating solution.

In another aspect, the present disclosure provides a system for wastewater treatment. The system can comprise a digesting unit configured to received wastewater and to pre-treat the wastewater to produce feedwater. The system can further comprise ion exchange unit comprising a zeolite cation exchanger, the ion exchange unit being configured to receive feedwater from the digesting unit to produce zeolite-treated water, whereby ammonium ions in the feedwater bind to the zeolite cation exchanger. In some embodiments, the system further comprises a solid precipitation reactor as described herein. The solid precipitation reactor can be configured to regenerate the zeolite cation exchanger having bound ammonium ions. In some embodiments, the zeolite cation exchanger having bound ammonium ions is contacted with a regenerating solution to produce a zeolite waste solution comprising ammonium ions. In some embodiments, the zeolite waste solution is introduced to the solid precipitation reactor to generate a solid and a permeate. In some embodiments, the system is configured such that the permeate is recycled to the zeolite cation exchanger to regenerate the zeolite cation exchanger.

In some embodiments, the solid precipitation reactor of the system for wastewater treatment is mounted onto a mobile carrier. The mobile carrier, for example, can be equipped with the regenerating solution. In some embodiments, the digesting unit of the system for wastewater treatment comprises an anaerobic biodigester. In some embodiments, the anaerobic biodigester comprises a septic tank. In some embodiments, the anaerobic biodigester comprises an anaerobic membrane bioreactor (AnMBR).

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A is a schematic view of system for membrane assisted recovery of solids (MARS system), according to aspects of the disclosure, including a reactor and a membrane module.

FIG. 1B is a schematic view illustrating a first stage of operation of the MARS system of FIG. 1A.

FIG. 1C is a schematic view illustrating a second stage of operation of the MARS system of FIG. 1A.

FIG. 1D is a schematic view illustrating a third stage of operation of the MARS system of FIG. 1A.

FIG. 1E is a schematic view illustrating a fourth stage of operation of the MARS system of FIG. 1A.

FIG. 1F is a schematic view illustrating a waste treatment system incorporating the MARS system of FIG. 1A and a zeolite bed for nutrient removal.

FIG. 1G is a schematic view illustrating the waste treatment system FIG. 1F being operated in a recovery mode to recover the zeolite bed.

FIG. 1H is schematic view of a mobile MARS system for providing septic tank maintenance service.

FIG. 1I is a detail view of the membrane module of FIG. 1A, highlighting the locations of influent/effluent lines, sampling ports, and pressure transducers.

FIG. 2 is a transducer calibration curve, converting voltage units to pressure units for the permeate, concentrate, and feed.

FIG. 3 shows a schematic of Ammonium Magnesium Phosphate (MAP) flask-precipitation reactor that is mechanically stirred and operated as a Completely Stirred Reactor (CSTR).

FIG. 4 is a schematic of MARS in a membrane longevity study.

FIG. 5 shows concentration of NH₄⁺—N over time for both the pH studies and NaCl studies.

FIG. 6 shows final TSS generated for each experiment.

FIG. 7 shows solid analysis results from preliminary CSTR studies, including XRD reference pattern of Ditmaritte.

FIG. 8 shows solid analysis results from preliminary CSTR studies, including culmination of XRD results from the pH trials.

FIG. 9 shows SEM images from preliminary studies. Panel A shows pH 9 solid sample after heating. Panel b shows NaCl-60 solid sample after heating.

FIG. 10 shows transmembrane pressure (TMP) and total suspended solids (TSS) of the first 90 minutes of the membrane longevity study.

FIG. 11 shows multi-day TMP, reporting the linear TMP increase rate.

FIG. 12 shows sample locations highlighted on a simple schematic of the control. drawing not to scale.

FIG. 13 shows a schematic of MARS in the filtrate recycle (FR) stage.

FIG. 14 shows a schematic of MARS in the dewatering (DWR) stage.

FIG. 15 shows a simple schematic illustrating sample locations for both the CSTR and the ultrafiltration (UF) subassembly.

FIG. 16 shows a membrane module schematic in different orientations. Panel A shows UF membrane module in experimental and CWF test orientation. Panel B shows membrane cleaning, either physical or chemical, module orientation.

FIG. 17 shows directions of pumps during physical/chemical cleaning. Panel (a) shows feed and permeate pump being operated in the forward direction. Panel (b) shows feed pump being operated in the backward direction and permeate in the forward direction. Panel (c) shows feed pump being turned off and permeate in the backward direction (backwashing).

FIG. 18 shows CSTR settling experiment results: settling profile for MAP precipitation control.

FIG. 19 shows CSTR settling experiment results: Turbidity of MARS Reaction (RXN) stage trials.

FIG. 20 shows turbidity of MARS (DWR), with each stage highlighted.

FIG. 21 shows residual NH₄⁺—N ion concentrations for settling and MARS experiments.

FIG. 22 shows other MAP residual ion concentrations for settling and MARS experiments, including concentration of phosphate as phosphorus (PO₄³⁻—P).

FIG. 23 shows other MAP residual ion concentrations for settling and MARS experiments, including concentration of magnesium (Mg²⁺).

FIG. 24 shows membrane performance results for MARS (RXN) experiments, including TSS over time.

FIG. 25 shows membrane performance results for MARS (RXN) experiments: TMP over time.

FIG. 26 shows TMP and TSS over time for MARS dewatering (DWR).

FIG. 27 shows continuous flux and percent of total volume recovered for MARS (DWR).

FIG. 28 shows average total resistance results from clean water flux tests.

FIG. 29 shows clean water flux test results. Reporting the specific flux with an emphasis on whether a test was conducted after an experiment, physical cleaning or chemical cleaning.

FIG. 30 shows a detailed schematic of fluidized bed reaction (FBR) used for MARS continuous mode experiments.

FIG. 31 shows original continuous MARS influent design, Panel A shows a simple schematic of MARS, highlighting the first failed iteration of a merged feed line into the FBR. Panel B shows images of a clog that occurred within the merged feed line.

FIG. 32 shows a final iteration of separate feed lines introduced to the FBR through an extended funnel. Important continuous MARS components are denoted with their respective IDs.

FIG. 33 shows an operational strategy for MARS in continuous operation: Mixing Loop (MXL)

FIG. 34 shows an operational strategy for MARS in continuous operation: Filter Recycling Loop (FRL)

FIG. 35 shows an additional operational strategy for MARS in continuous operation: Harvesting Solids Loop (HSL)

FIG. 36 shows an additional operational strategy for MARS in continuous operation: Membrane Cleaning Loop (MCL).

FIG. 37 shows a schematic of one of the three different stages used for MARS continuous mode: Reaction (RXN).

FIG. 38 shows a schematic of one of the three different stages used for MARS continuous mode: Filtrate Recycling (FR).

FIG. 39 shows a schematic of one of the three different stages used for MARS continuous mode: Continuous (CTS).

FIG. 40 shows eutrophic ion concentrations of continuous MARS experiments: Concentration of NH₄⁺—N.

FIG. 41 shows eutrophic ion concentrations of continuous MARS experiments: Concentration of PO₄³⁻—P.

FIG. 42 shows Magnesium effluent concentrations of continuous MARS experiments.

FIG. 43 shows additional effluent qualities of continuous MARS experiments: Turbidity over time.

FIG. 44 shows additional effluent qualities of continuous MARS experiments: conductivity over time.

FIG. 45 shows additional effluent qualities of continuous MARS experiments: pH over time.

FIG. 46 shows additional effluent qualities of continuous MARS experiments: temperature over time.

FIG. 47 shows Intermittent TMP and membrane feed TSS for all continuous MARS experiments: MARS high loading (HL).

FIG. 48 shows Intermittent TMP and membrane feed TSS for all continuous MARS experiments: MARS (HL-NaCl).

FIG. 49 shows Intermittent TMP and membrane feed TSS for all continuous MARS experiments: MARS low loading (LL).

FIG. 50 shows intermittent flux and cumulative permeate volume collected for all continuous MARS experiments: MARS (HL).

FIG. 51 shows intermittent flux and cumulative permeate volume collected for all continuous MARS experiments: MARS (HL-NaCl).

FIG. 52 shows intermittent flux and cumulative permeate volume collected for all continuous MARS experiments: MARS (LL).

FIG. 53 shows solids harvested from MARS in continuous mode: harvested solids TSS during the continuous (CTS) stage.

FIG. 54 shows solids harvested from MARS in continuous mode: panel b shows percentage of solids recovered through the solids harvesting for MARS (HL), panel c shows MARS (HL-NaCl), and panel d shows MARS (LL).

FIG. 55 shows theoretical and harvested dry mass from continuous experiments.

FIG. 56 shows percent difference between theoretical dry mass and actual dry mass. Collected from the harvesting loop and the reactor each the experiment concluded Panel (a) shows MARS HL, Panel (b) shows MARS HL-NaCl, and Panel (c) shows MARS (LL).

FIG. 57 shows XRD results for continuous MARS. Panel (a) shows MARS (LL) solids obtained from the harvesting solids loop (HSL). Panel (b) shows MARS (LL) Permeate. Panel (c) shows struvite line graph reference (00-015-0762). Plots created using Panalytical Highpoint.

FIG. 58 shows images from SEM of MARS (LL) solids recovered during the CTS stage and it's permeate. Panel (a) shows solids from MARS (LL) solids harvesting loop. Panel (b) shows solids from MARS (LL) permeate.

FIG. 59 shows XRF results for MARS (LL) and MARS (LL) Permeate.

FIG. 60 shows stationary installation of MARS in a Z-MARS integration scheme. Panel (a) shows Z-MARS operated to extend the life of the zeolite bed. Panel (b) shows Z-MARS operated to regenerate the saturated zeolite bed.

FIG. 61 shows a general concept idea of how MARS could be installed within a moving truck to service various DTWS in different locations.

FIG. 62 shows conventional septic tank and drainage field schematics. Panel (a) shows septic tank with effluent discharging to the surface. Panel (b) shows septic tank with effluent discharging to the subsurface.

FIG. 63 shows a schematic of a zeolite bed installed in series with a conventional septic tank.

FIG. 64 shows a concept of mobile MARS providing septic tank maintenance service.

### DETAILED DESCRIPTION OF THE INVENTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof, herein is meant to encompass the items listed thereafter and equivalents thereof as well as additional items. Unless specified or limited otherwise, the terms “mounted,” “connected,” “supported,” and “coupled,” and variations thereof, are used broadly and encompass both direct and indirect mountings, connections, supports, and couplings. Likewise, “connected” and “coupled” are not restricted to physical or mechanical connections or couplings unless identified as such. Furthermore, throughout the description, terms such as front, back, side, top, bottom, up, down, upper, lower, inner, outer, above, below, and the like are used to describe the relative arrangement and/or operation of various components of the example embodiment; none of these relative terms are to be construed as limiting the construction or alternative arrangements that are within the scope of the claims.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

The following discussion is presented to enable a person skilled in the art to make and use embodiments of the disclosure. Given the benefit of this disclosure, various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

Disclosed herein is a solid precipitation reactor for high efficiency nutrient removal and recovery from waste streams. The precipitation and recovery of solids is usually a physical and chemical process. The chemical process hinges on the addition of the correct reagents and sufficient contact time to induce chemical precipitation. The precipitation process may vary depending on the precipitation reaction of interest. Parameters such as reaction time, nucleation, and dosage of reactants (i.e., nutrients) are all dependent on the reaction being studied. The physical component of the precipitation process may be at least partially determined by gravity. A common way to separate the solids formed from the bulk liquid is to allow for the solids to settle. This may require a sizeable amount of land, depending on the density of the solids being formed, and requires a significant amount of time for settling to occur. Therefore, in conventional physiochemical process, operations can be limited by time and space.

Disclosed herein is a solid precipitation reactor system that can include a reactor (i.e., reaction chamber) configured to receive feedwater and to allow particulates to at least partially precipitate from the feedwater to form an effluent, and a membrane module (i.e., a filtration module) having a membrane filter configured receive effluent from the reactor and to filter suspended particulates from the effluent to produce a permeate and a concentrate. As will be described in greater detail below, in some operating scenarios, concentrate from the membrane module can be reintroduced to the reactor to allow additional particulates to precipitate.

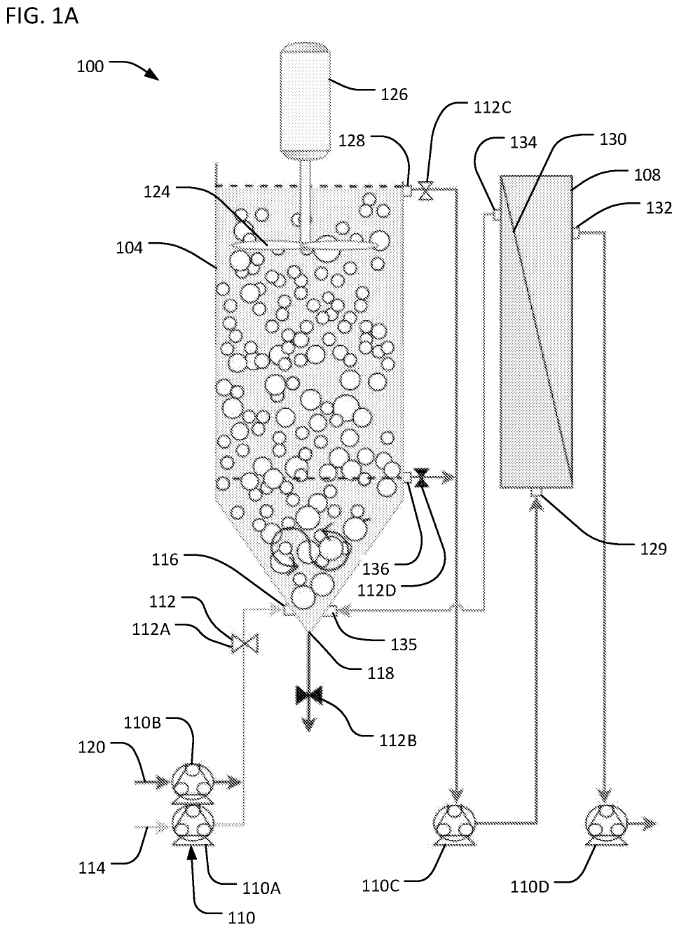

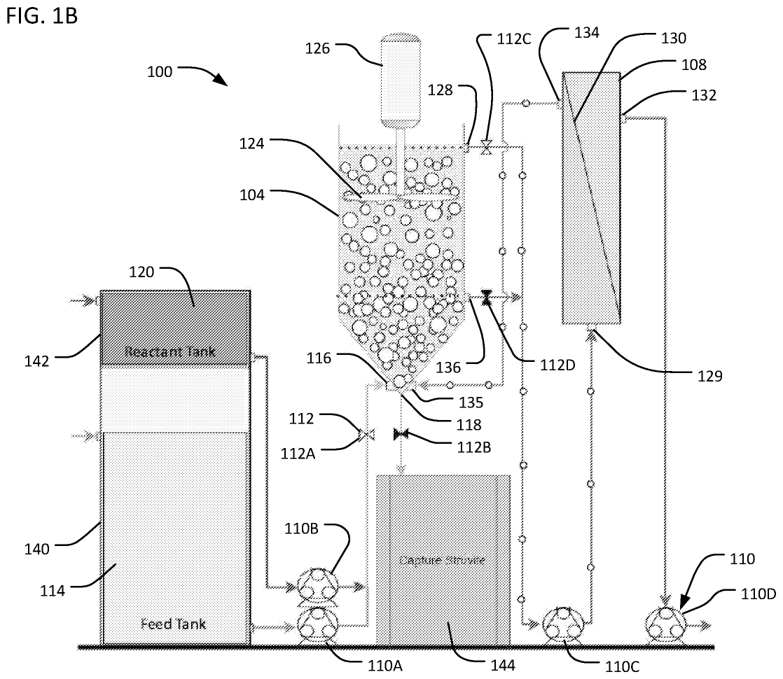

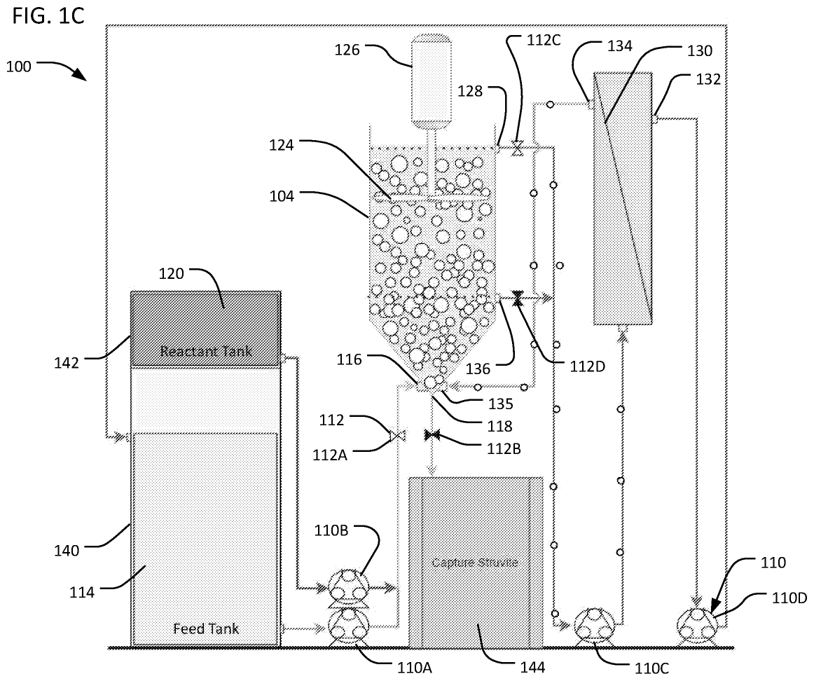

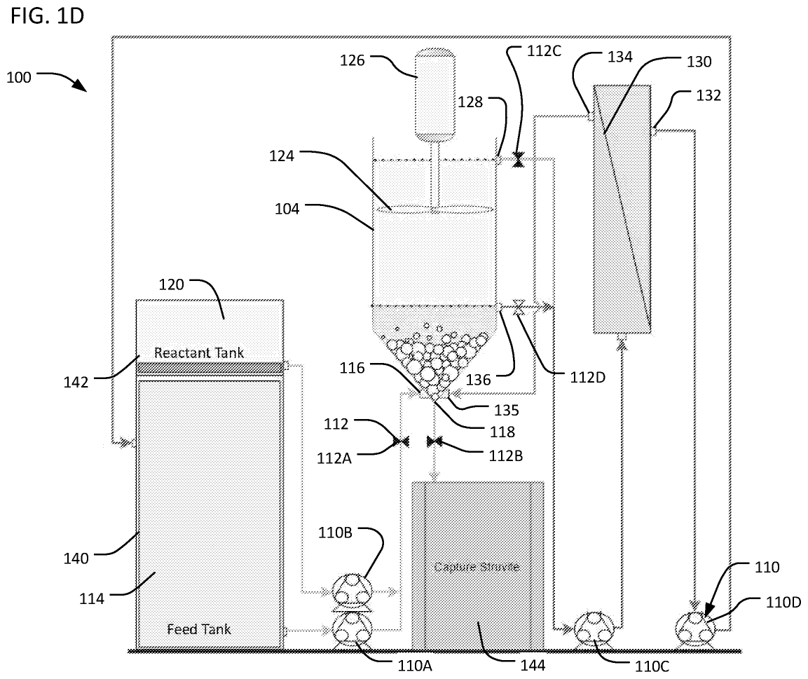

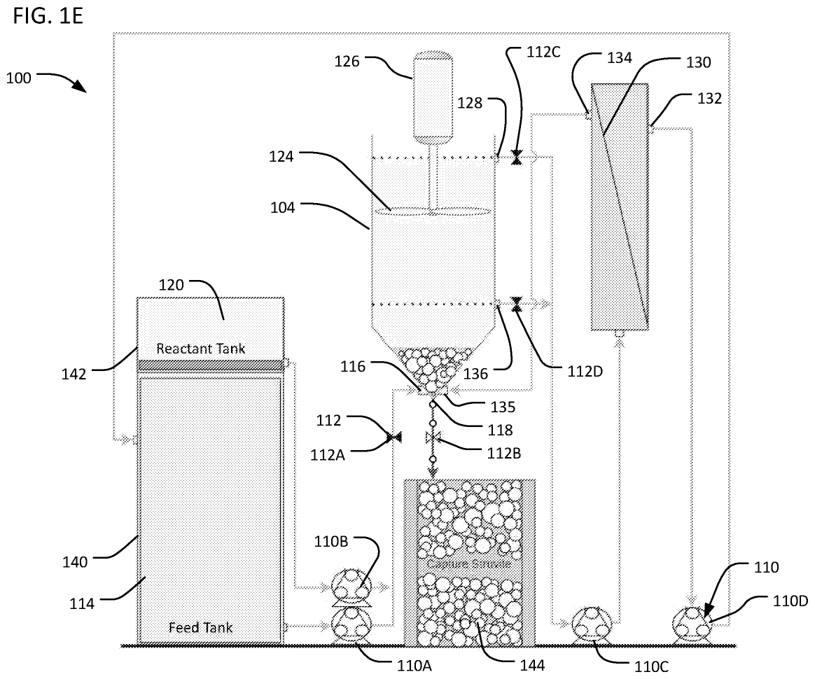

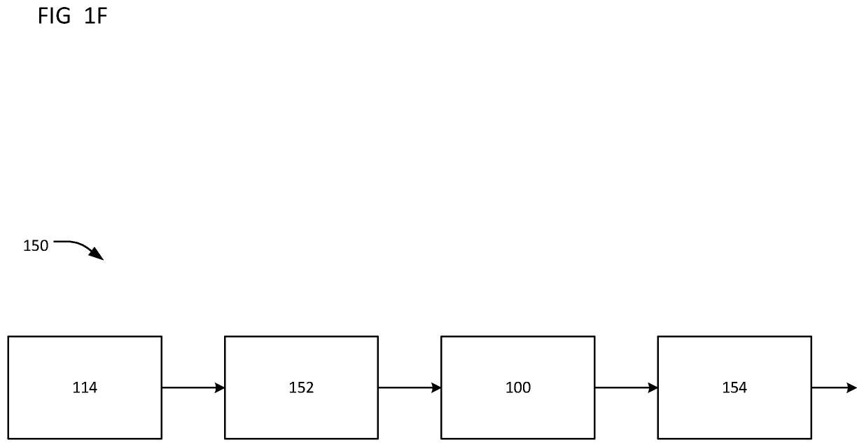

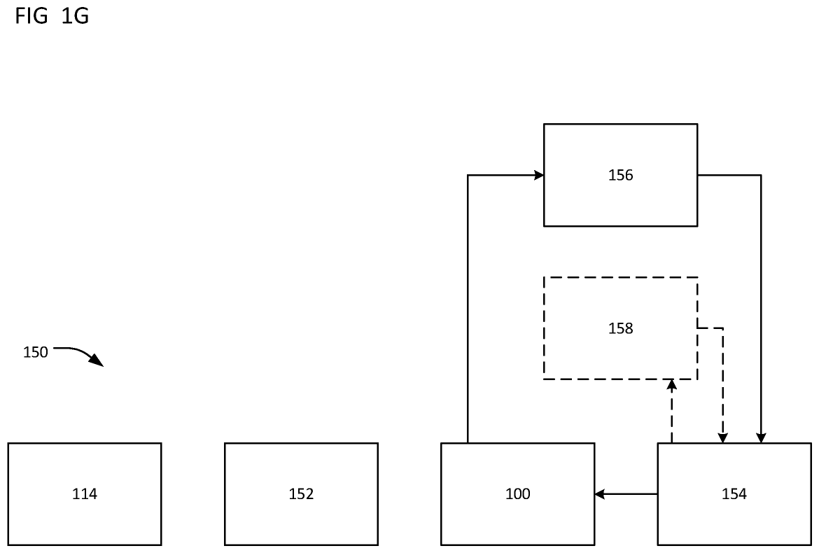

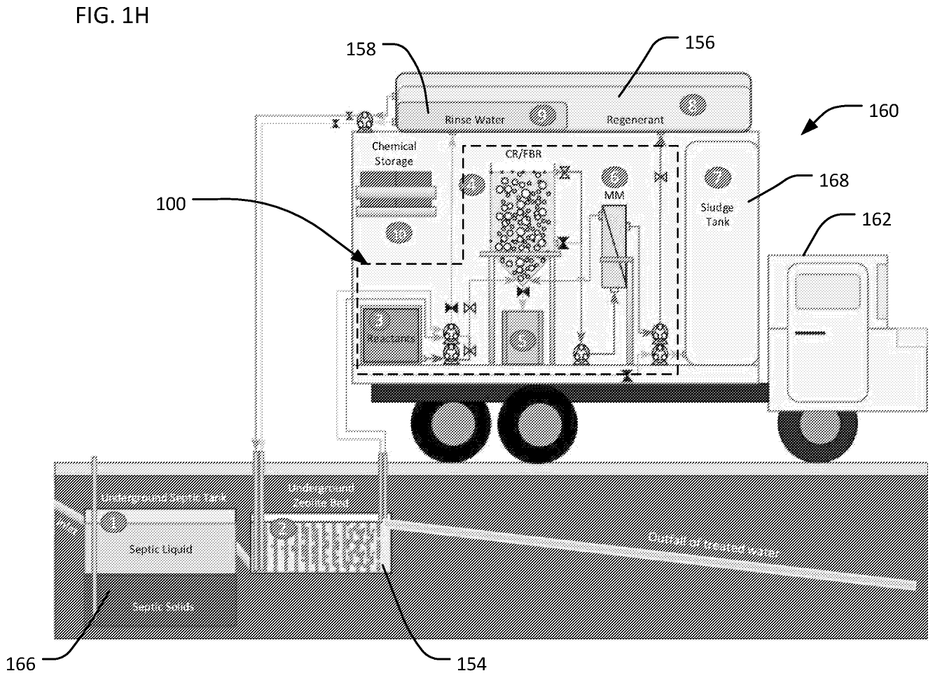

FIG. 1A illustrates an example system 100 for membrane assisted recovery of solids (i.e., a MARS system or a solids precipitation reactor system), which can operate as a standalone system, or which can be integrated as a subsystem in a larger treatment system. The MARS system 100 can include a reactor 104 (e.g., a reaction chamber) and a membrane module 108 (e.g., a filter) that are arranged to filter particulates from a feedwater source (e.g., wastewater from domestic, agricultural, landfill, or other industrial sources) to produce a permeate that can be used for downstream processes. Correspondingly, the system 100 can further include a pump system 110 having one or more pumps (e.g., a peristaltic or other type of pump) and a valve system 112 having one or more valves 112, which can be selectively operated to control the flow of feedwater and other fluids through the system 100 (e.g., by manual activation or by an electronic control system, not shown). That is, the pumps 110 can be operated to cause the flow of feedwater through the MARS system 100 and the valves 112 can be operated to control how and where the feedwater flows (e.g., how the feedwater flows between the reactor 104 and the membrane module 108). Additionally, the MARS system 100 can include pressure gauges, shut-off valves, and or sample tape to allow the MARS system 100 to be monitored without needing to pause operation of the MARS system 100.

As used herein, “feedwater” or “waste stream” or “wastewater” or “wastewater sources” are defined as a liquid with one or more nutrients, such as source separated urine, leachate, ion exchange (IE) regenerative solution, municipal wastewater, swine farm waste, or landfill leachate. Waste streams may contain one or more nutrients and may originate from one or more of the aforementioned sources, but may typically include nutrients, such as ammonium (NH₄⁺), phosphate (PO₄³⁻), magnesium (Mg²⁺), potassium (K⁺), calcium (Ca²⁺) and any combination thereof. For example, domestic and agricultural waste can contain ammonium and phosphate, but little to no magnesium, while industrial waste can include comparatively higher levels of ammonium and sometimes phosphates or magnesium. In some embodiments, the wastewater can contain between 0.01 g/L NH₄⁺ to 10 g/L NH₄⁺, between g/L NH₄⁺ to 10,000 g/L NH₄⁺, between 0.01 g/L NH₄⁺ to 100 g/L NH₄⁺, between 1 g/L NH₄⁺ to 1,000 g/L NH₄⁺, between 1 g/L NH₄⁺ to 2,000 g/L NH₄⁺, or between 1 g/L NH₄⁺ to 500 g/L NH₄⁺. In other embodiments, the wastewater contains between 0.1 g/L PO₄³⁻ to 1 g/L PO₄³⁻ between 0.01 g/L PO₄³⁻ to 5 g/L PO₄³⁻, between 0.001 g/L PO₄³⁻ to 5 g/L PO₄³⁻, or between 0.1 g/L PO₄³⁻ to 15 g/L PO₄³.

In some cases, a molar ratio of NH₄⁺:PO₄³⁻:Mg²⁺ can be no lower than 1:1:1 and not higher than 1:1.1:1.4. In other embodiments, the molar ratio of NH₄⁺:PO₄³⁻:Mg²⁺ may vary up to 20% in any one nutrient or any combination of nutrients above or below a 1:1:1 molar ratio of NH₄⁺: PO₄³⁻:Mg²⁺.

“Particulates” or “precipitate” or “solids” are defined as a substance precipitated from the feedwater. A skilled artisan understands that the specific properties of the particulates (i.e., composition, morphology, diameter, aspect ratio, polymorphism, phase, color, crystallinity, solubility) may depend on features of the feedwater and the precipitation reaction conditions. In certain cases, these features may include pH, temperature, pressure, concentration, nucleation, crystal growth, reaction time, molar ratio, presence or absence of foreign ions (such as calcium, potassium, sodium, or heavy metals including copper, zinc, arsenite, aluminum, or arsenate), supersaturation of one or more components (i.e., nutrients), feeding sequence, mixing intensity and duration, seeding, presence or absence of organic substances, and any combination thereof. In some embodiments, the particulates may be crystalline (i.e., crystals) and in other cases the particulates may be non-crystalline (i.e., amorphous).

As mentioned above, in some cases, particulates can contain ammonium (NH₄⁺), phosphate (PO₄³⁻), and magnesium (Mg²⁺), which may precipitate into a solid in a 1:1:1 ratio, known as Magnesium Ammonium Phosphate (MAP). Aspects of the precipitation reaction, including ion removal, are described in greater detail below, but in some cases, it may be preferrable to add additional ammonium, phosphate, or magnesium to maintain the 1:1:1 ratio to help the reaction continue to completion. In some embodiments, MAP may be found in struvite (MgNH₄PO₄·6H₂O) or dittmarite (MgNH₄PO₄·H₂O) crystals phases, which can settle to the bottom of a reactor where they can be removed from the system. In some cases, the MAP precipitate may include particulates or aggregates of particulates between 10 micrometers to 50 micrometers. In other embodiments, the MAP precipitate particulates or aggregates of particulates can be between 15 micrometers to 3 millimeters. In other embodiments, the MAP precipitate particulates or aggregates of particulates can be between 1 micrometer to 3 millimeters. In general, particulates may be suspended in the feedwater as a short-lived suspension or a long-standing suspension. A suspension can be defined as a heterogenous mixture of a fluid that contains solid particles that may be sufficiently large for sedimentation. The particulates of a short-lived suspension may sediment within minutes. The particulates of a long-standing suspension may not sediment for at least one hour. Suspensions may be reformed by physical agitation.

Correspondingly, a reaction chamber can be configured as a solid precipitation reactor (e.g., a crystallization reactor) that can receive and selectively retain feedwater to allow particulates to precipitate out of the feedwater, where they can be collected. For example, as illustrated in FIG. 1A, the reactor 104 can be a generally hollow vessel that can receive feedwater 114 having nutrients, which can be in the form of particulates suspended in a carrier liquid (e.g., liquid water) or solubilized ions in a carrier liquid. More specifically, a first pump 110A can be operated to pump feedwater 114 from a feedwater source and into the reactor 104, via a reactor inlet 116. A first valve 112A can be positioned between the first pump 110A and the reactor inlet 116.

In some embodiments, a reactant can also be supplied to a reaction chamber to react with the feedwater 114 in a precipitation reaction that can increase the rate at which particulates precipitate from the solute. For example, as illustrated in FIG. 1A, reactant 120 can be introduced to the reaction chamber via the reactor inlet 116 via operation of a second pump 110B. The first valve 112A can be positioned between the second pump 110B and the reactor inlet 116. However, in other embodiments, other arrangements for the introduction of reactant are possible. For example, the reactant can be introduced through a separate reactor inlet, which can be controlled be another valve.

Addition of reactant 120 is not required but may improve precipitation by acting as a seed material (e.g., starter crystals, ion-exchange resin, sorbent material, etc.) that can initiate or accelerate precipitation. The particular reactant being used may depend on the specific chemistry of the reaction being housed within the reactor 104 (i.e., depending on the chemical makeup of the feedwater 114 and the desired end product to be removed from the reactor 104). Correspondingly, in some cases a pH buffering or pH altering material (e.g., sodium hydroxide, air, magnesium oxide, magnesium hydroxide, potassium hydroxide, potassium carbonate,) can also be added to the reactor 104 to facilitate the desired reaction. For example, a pH greater than 9.1 can, in some cases, result in volatilization of ammonia, while a lower pH can favor precipitation of other types of particulates. In some embodiments, the pH of the reactor 104 described herein may be as low as pH 8 and as high as pH 9. In other embodiments, the pH of the reactor described herein may be as low as pH 7 and has high as pH 10.5. In other embodiments, the pH of the reactor described herein may be as low as pH 7 and has high as pH 13.

Once introduced into the reactor 104, the feedwater 114 and/or reactant 120 can be selectively retained therein to allow for at least a portion of the particulates to precipitate from the solute to settle and accumulate at the bottom of the reactor 104 (e.g., via gravity), where they can be collected via an exit port 118. In some cases, a second valve 112B can be provided to control the opening and closing of the exit port 118. As the precipitate settles, the solute can generally remain above the settled solids, which can be used as an effluent in later steps, as described in greater detail below. Correspondingly, ‘effluent’ can be defined as a liquid, that may or may not contain particulates (e.g., non-precipitated particulates), which can flow onward from the reactor 104, sometimes towards the membrane module 108.

The particular dwell time required for precipitation can vary depending on the type of particulates being generated, or other aspects of the system, such as the type of reactor. For example, as illustrated in FIG. 1A, the reactor 104 can be configured as a completely stirred reactor (CSTR) that can continually mix the feedwater 114 and reactant 120 held within the reactor 104. To that end, the MARS system 100 can include an agitator system to mix the feedwater 114 and reactant 120 in the reactor 104. As shown in FIG. 1A, the agitator system can include a blade 124 that is disposed within the feedwater 114 and operatively coupled to a motor 126. Correspondingly, operation of the motor 126 causes the blade 124 to spin, thereby mixing the feedwater 114 within the reactor 104. Operation of the agitator system can improve mixing between the feedwater 114 and reactant 120, which may increase the rate of the precipitation reaction and improve yield. In some cases, baffles can be provided in the reactor 104 to improve mixing and prevent short-circuiting by helping to ensure adequate retention time of the fluid (e.g., the feedwater 114 and reactant 120) in the reactor 104.

The speed at which mixing occurs may vary depending on the particular application and, for example, may occur at less than about 50 RPM, between about 50 RPM and 75 RPM, between about 100 RPM and 125 RPM, between about 125 RPM and 150 RPM, between about 150 RPM and 175 RPM, between about 175 RPM and 200 RPM, between about 200 RPM and 225 RPM, between about 225 RPM and 250 RPM, between about 250 RPM and 275 RPM, between about 250 RPM and 300 RPM, between about 250 RPM and 325 RPM, between about 250 RPM and 350 RPM, between about 250 RPM and 375 RPM, between about 250 RPM and 400 RPM, inclusive.

In other case, other types of agitators or reactors can also be used. For example, in some embodiments, a reactor can be configured as a fluidized bed reactor (FBR). With an FBR, the introduction of the feedwater can be configured to cause mixing within the reactor. For example, in some cases, feedwater can be introduced through a port near the bottom of the reactor via operation by a pump at a particular volumetric flow rate (e.g., about 1,700 mL/min) to cause a desired rate of mixing. Relatedly, depending on the means of mixing within the reactor, the reactor can also be specifically shaped to help induce mixing or settling of the particulates at the bottom of the reactor. Correspondingly, baffles can be provided within the reactor, as can achieve a desired flow characteristic or regime within the reactor. In another embodiment, in one embodiment the agitator system may include a magnetic stir bar under the influence of a magnetic stir plate.

As mentioned above, settling of the particulates can leave an effluent that can generally be disposed above the settled solids. The effluent can generally contain fewer or smaller particulates that can be more resistant to settling, particularly where mixing may be occurring. To help reduce particulate matter in the effluent even further, the effluent can be pumped to flow to the membrane module 108 to filter remaining suspended particulates. Specifically, a third pump 110C can be operated to cause effluent to flow from the reactor 104 to the membrane module 108, which may be additionally controlled by a third valve 112C. The effluent can flow from a reactor outlet 128 (e.g., an effluent outlet) an into an effluent inlet 129 of the membrane module 108. The reactor outlet 128 can be positioned so as to maximize the amount of effluent that flows to the membrane module 108, while minimizing the amount of settled precipitate that may flow to the membrane module 108. For example, the reactor outlet 128 can be positioned generally away from a particulate collection region of the reactor 104 (e.g., to be above an approximate maximum level of settled solids). In other embodiments, the reactor outlet 128 can be provided as a floating valve within the reactor 104 that can remove effluent from the surface of the liquid volume in the reactor 104, which may reduce system complexity and improve overall performance, for example, during decanting, as described in greater detail below.

A membrane module is a filter module that is configured to filter remaining particulates from the effluent. In general, effluent flows into an upstream side of the membrane module 108, which contains a filter element 130 (e.g., a membrane filter). In some embodiments, the filter element 130 may contain between 1-10 membrane filters, between 1-20 membrane filters, between 5-8 membrane filters, between 10-20 membrane filters, between 6-8 membrane filters, between 11-15 membrane filters, between 1-50 membrane filters, or between 20-30 membrane filters.

Each membrane filter can be configured in various ways depending on the particular application. For example, in some embodiments, a membrane filter may be configured as a tubular module, a hollow fiber module, a spiral-wound module, or a plate and frame module. Similarly, membrane filters can be formed from various materials. For example, in some embodiments, a membrane filter can be a polymeric membrane cast on plastic or porous paper components, a ceramic, or polyvinylidene fluoride (PVDF), polyethersulfone (PES), polyacrylonitrile (PAN), etc. Further, the filter membranes can be arranged for different types of flow within a membrane module. In particular, in some embodiments, effluent can flow generally perpendicularly to the filtration membrane of the membrane module, in so called “conventional filtration.” In other embodiments, effluent can flow generally tangentially to the filtration membrane of the membrane module, in so called “crossflow filtration.” In still other embodiments, a membrane module can be submerged within a reactor, in so called “dead end flow,” so that permeate can be discharged directly from the reactor, and thereby removing the need to transport concentrate back to the reactor. Instead, any liquid that does not pass through the membrane module can be immediately mixed into the rest of the fluid to continue the precipitation reaction.

Generally, filters have pores that can be sized to allow the effluent to pass through the filters while retaining remaining particulates of a certain size, thereby producing permeate (i.e., a filtrate) that contains less than or equal to a maximum concentration or size of particulates on a downstream side of the membrane module 108. Filter membrane pore size can sometimes be selected to be about one tenth of the particle size to be separated. Accordingly, in some embodiments, the membrane filter pore size can be between about 0.003 micrometers and 0.5 micrometer, between about 0.001 micrometers and 0.05 micrometers, or between about 0.2 micrometers and 0.04 micrometers, as well as other ranges as required by a particular application.

In some cases, pore size can be selected to provide a particular quality of filtration. For example, a filter can be a microfiltration (MF) filter configured to separate suspended material with particle size of 0.01 micrometers or larger at operating pressures ranging from 5 to 45 psi, an ultrafiltration (UF) filter configured to separate suspended material with particle size of 0.005 micrometers or larger (e.g., with molecular weights greater than 1000 Dalton) at operating pressures ranging from 7 to 150 psi, a nanofiltration (NF) filter configured to separate divalent or multivalent ions and to allow the passage of water, monovalent ions, and low molecular weight substances (less than 250 Dalton) at operating pressures ranging from 120 to 600 psi, or a reverse osmosis (RO) filter configured to separate all particles and ionic species with molecular weights above 50 Dalton at operating pressures ranging from 300 to 1100 psi.

In general, the type of filter element can be selected to optimize permeate production with reduced filter fouling. For example, in one experiment, combining an ammonium magnesium phosphate (MAP) crystallization reactor with a single-stage tubular ultrafiltration (UF) was found to expedite nutrient recovery and to allow for processing of large volumes of waste streams, all while achieving over 90% removal of NH₄⁺ and can sustaining adequate filtration for approximately three days before fouling. In certain cases, the solid precipitation reactor described herein may achieve over 10% removal of NH₄⁺, over 20% removal of NH₄⁺, over 30% removal of NH₄⁺, over 40% removal of NH₄⁺, over 50% removal of NH₄⁺, over 60% removal of NH₄⁺, over 70% removal of NH₄⁺, over 80% removal of NH₄⁺, over 90% removal of NH₄⁺, over 91% removal of NH₄⁺, over 92% removal of NH₄⁺, over 93% removal of NH₄⁺, over 94% removal of NH₄⁺, over 95% removal of NH₄⁺, over 96% removal of NH₄⁺, over 97% removal of NH₄⁺, over 98% removal of NH₄⁺, or over 99% removal of NH₄⁺.

In some examples, membrane filter fouling may be assessed using transmembrane pressure (TMP). In certain examples, a rising TMP indicates fouling of the membrane filter (e.g., the filter element 130). Low or steady TMP measurements may indicate the membrane filter is not fouled or fouling. In a certain case, the TMP may remain below 0.26 bar and may indicated that the membrane filter is not fouled. In certain examples of the solid precipitation reactor, the TMP may remain below 0.26 bar for at least seven days, at least six days, at least five days, at least four days, least three days, at least two days, at least one day, at least half a day, or at least six hours.

The permeate can exit the downstream side of the membrane module 108 via a permeate port 132, for example, via operation of the fourth pump 110D, to be used in a variety of downstream processes, or to be subjected to one or more final treatment processes to remove any remaining nutrients, such as ammonium or nitrogen (e.g., by capacitive deionization, microbial fuel cells, zeolite treatment, etc.). However, not all the particulates and carrier liquid flow through the filter element 130, resulting in concentrate (i.e., retentate) that contains an elevated concentration of particulates on the upstream side of the filter element 130. The concentrate can exit the membrane module 108 via a concentrate exit 134 to flow back to the reactor 104 (e.g., through a concentrate inlet 135) to allow for further precipitation and filtering, as generally described above. In some cases, the MARS system 100 can be operated in such a manner, for example, by driving the third pump 110C in reverse, to cause concentrate to flow out of the effluent inlet 129 and back the reactor 104 via the reactor outlet 128, or through a concentrate inlet 136, depending on an open or closed state of the third valve 112C or a fourth valve 112D, respectively.

In operation, a MARS system, as generally described above, can be operated in various stages to remove particulates from a feedwater source. For example, FIG. 1B illustrates the MARS system 100 connected to a feedwater source 140, reactant source 142, and a collection tank 144 for collecting particulates from the feedwater 114. In FIG. 1B, the MARS system 100 is shown operating in a first stage (e.g., a flow-through or continuous stage) in which particulates are allowed to precipitate and accumulate within the reactor 104, while permeate is continuously discharged. In the first stage, the first and second pumps 110A, 110B can be operated to pump reactant 120 and feedwater 114 into the reactor 104. At the same time, the motor 126 can be operated to mix the contents of the reactor 104 and allow precipitation of particulates (e.g., struvite, MAP, or another precipitated material) to accumulate at the bottom of the reactor 104.

Additionally, effluent can be pumped out of the reactor 104 by the third pump 110C to flow to the membrane module 108. As mentioned above, the particles suspended in the effluent can be separated by the filter element 130 to form a concentrate on the upstream side of the filter element 130 and a permeate on the downstream side of the filter element 130, which is comparatively free of particulates. The concentrate can flow back to the reactor 104 for further processing via the concentrate exit 134, and the permeate can exit the MARS system 100 or be returned to the feedwater tank via operation of the fourth pump 110D. In general, operations at the flow-through stage can be done so as to maintain a desired fluid level within the reactor 104. In some cases, the second valve 112B can be at least partially opened to allow accumulated precipitate to exit the reactor 104 via the exit port 118, where they can be collected in the collection tank 144. Referring now to FIG. 1C, the MARS system 100 can also be operated in a second stage (i.e., a formation or reaction stage) to enhance precipitation in a reactor. The second stage can be a closed loop that can increase hydraulic retention time for precipitation in the reactor 104. Specifically, as compared to the first stage in which permeate is extracted from the MARS system 100, the permeate is pumped back to the feedwater source 140 to be reintroduced into the reactor 104. In this way, the MARS system 100 can treat a large volume of feedwater 114, which may be highly contaminated, since the membrane module 108 returns permeate back to the reactor 104 to once again become feedwater 114. In some cases, the second stage can further include a settling stage, in which agitation and pumps cease to operate to improve settling of particulates to the bottom of the reactor 104.

In the second stage, it is possible that some reactant, such as unprecipitated or solubilized nutrients, can pass through the membrane module 108 with the permeate, which is why it may be recirculated back into the feedwater source 140. From the feedwater source 140 the reactant-containing feedwater can be introduced into the reactor 104 to be remixed, thereby allowing for enhanced precipitation, which may be due at least in part to the extended period of time that the reactant is retained in the reactor 104.

Additionally, it is possible that some particulates may accumulate on the filter element 130 within the membrane module 108, which may increase a rate of membrane fouling. Accordingly, to increase longevity of the filter element 130, intermittent backwashing may occur, for example, by operating the third and fourth pumps 110C, 110D in reverse to cause feedwater 114 to flow from the feedwater source 140, through the membrane module 108 and into the reactor 104. This backflow of the feedwater 114 can, in some cases, function as filtrate recycling stage that can push particulates off of the filter element 130 and back into the reactor 104. Correspondingly, in some cases, filter element performance may be monitored through flux and transmembrane pressure (TMP). Flux may be monitored intermittently or continuously (e.g., using a pressure transducer, not shown). In some embodiments, increasing TMP measurements over operation time can indicate fouling of a filter element. In some cases, pressure transducers can be used to monitor pressures at other locations, for example, the effluent, permeate, and concentrate inlets of the membrane module.

Referring now to FIG. 1D, the MARS system 100 can be operated in third stage (e.g., a decant or dewatering stage), which can be useful to remove liquid from the reactor 104 and to produce a recoverable amount of bulk liquid from the MARS system 100. In the third stage, effluent from the reactor 104 can be extracted from the concentrate inlet 136, which is positioned proximate a bottom of the reactor 104 and generally lower than the reactor outlet 128. Correspondingly, the first, second and third valves 112A-C can be closed and the fourth valve 112D can be opened while the third and fourth pumps 110C, 110D can be operated to cause effluent to flow from the reactor 104, through the membrane module 108, and back to the feedwater source 140. In this way, the reactor 104 can be substantially drained of effluent, leaving any accumulated precipitate within the reactor 104. The amount of fluid that is decanted can be specifically selected so as not to introduce large amounts of settled precipitate into the membrane module 108, which can result in fouling.

Referring now to FIG. 1E, the MARS system 100 can be operated in a fourth or recovery stage to collect any accumulated precipitate or remaining effluent within the reactor 104. As shown in FIG. 1E, to drain the reactor 104 of precipitates, the first, third, and fourth valves 112A, 112C, 112D can be closed and the pumps 110 can be off so as not to move fluid about the MARS system 100. However, the second valve 112B can be opened to allow the contents of the reactor 104 to flow out of the exit port 118 and into the collection tank 144. In some cases, the collection tank 144 can be a watertight container that can hold both settled precipitate and effluent, which can be later transferred to a drying bed. In other cases, the collection tank 144 can be permeable container that can allow any remaining effluent to drain from the collection tank 144, leaving the collected solids. For example, in some cases, the solids and liquids that exit the reactor 104 via the exit port 118 can be transported to a collection tank 144, which can be configured as a filter (e.g., a gravity fed filter). Accordingly, solids can be further separated from the effluent, which can be reintroduced to the reactor 104. In this way, dewatering of the solids can occur on site and an unreacted reactant can be reintroduced to the reactor 104 to improve overall yield and continue the precipitation reaction. In some embodiments, the filter may be a paper filter or a filtration sock. In some embodiments, the pore size range of the filter may be between 1 micrometers to 500 micrometers, between 0.1 micrometers and 500 micrometers, between 5 micrometers and 100 micrometers, between 1 micrometer and 300 micrometers, or between 1 micrometers and 100 micrometers. When full, the filter containing harvested precipitate may be removed for drying, and replaced with a new media filter. In another embodiment, the filter is a filtration sock having sufficient volume to collect a sizable amount of solids. The sock can be single-use, or solids can be emptied elsewhere and the sock reused.

In some cases, the fourth stage can also include cleaning the membrane module 108. For example, the third and fourth valves 112C, 112D can be temporarily opened and the third and fourth pumps 110C, 110D can be temporarily operated to flow feedwater 114 through the membrane module 108 and into the reactor 104, thereby removing particulates that may have accumulated on the filter element 130. The feedwater 114 entering the reactor 104 from the membrane module 108 can flow out the exit port 118 and into the collection tank 144. However, in some cases, the second valve 112B can be closed during operation of the third and fourth pumps 110C, 110D to retain some of the backwashed fluid in the reactor 104. The retained fluid can then act as seed material for later treatment cycles (e.g., at other operation stages).

The operating stages described above can be used in various combinations in order to form various methods for operating the MARS system 100 in various modes, including a continuous mode (e.g., where feedwater is continually loaded into the reaction chamber and precipitates and permeate are continually removed from the system), a batch operational mode (e.g., where a volume of feedwater is introduced to the precipitation reactor and undergoes precipitation and filtration a single volume so that particulates and permeate are also removed as a single volume), or a hybrid mode, to recover nutrients from the feedwater 114. For example, in a first continuous mode, the MARS system 100 can be operated in accordance with just the first stage. In the first continuous mode, the exit port 118 can be at least partially open to allow for settled precipitates to be removed from the system, along with the effluent that can be removed at the membrane module 108. In a second continuous mode, the MARS system can be operated in accordance with the second stage to enhance precipitate formation in the reactor 104 and, thus, accumulation of particulates at the bottom of the reactor 104. By allowing for precipitation, more efficient removal of particulates can be achieved under some operating conditions. Subsequently, once a desired amount of solids have been accumulated, the MARS system 100 can be operated according to the first stage. In other cases, the MARS system 100 can also be operated in a batch mode, which can improve efficiency by increasing recirculation of the feedwater 114. For example, under a first batch mode, the MARS system 100 can be operated in accordance with the second stage, followed by the third stage and then the fourth stage.

Still, in some cases, the MARS system 100 can be operated in a hybrid batch and continuous mode. For example, the MARS system 100 can first be operated in accordance with the second stage to allow for precipitation and the accumulation of particulates in the reactor 104. Subsequently, the MARS system 100 can be operated in accordance with the first stage to permit some particulate and permeate recovery, for example, to better accommodate treatment of large volumes of feedwater but helping to reduce treatment time. Once a bulk of the feedwater has been treated, the MARS system 100 can be operating in accordance with the third step to remove excess effluent and then in accordance with the fourth stage to remove the settled particulates from the reactor 104.

A MARS system and methods of operation, as described above, can also be used as part of a larger treatment system where compactness, portability, ease of transport and assembly, modularity, efficiency, and long-term durability are desirable, for example, marine, military, emergency, household, parks and campgrounds, eco-tourism, and various remote off-grid applications. The systems and methods may be used for mobile or stationary applications.

In some cases, a MARS system can be used in conjunction with zeolite (e.g., a zeolite bed) or another waste management technology to achieve improved performance. Zeolite is mineral with a naturally high affinity for ammonium and is typically used as part of a larger waste treatment system to adsorb a store ammonium via ion exchange and capture. In some embodiments, the zeolite may be clinoptilolite, chabazite, erionite, mordenite, synthetic zeolite, or any combination thereof. Over time, the zeolite can become saturated with ammonium, thereby reducing efficiency and effectiveness of nutrient removal. Accordingly, given the MARS system 100 capability to effectively and quickly remove ammonium and other nutrients from a wastewater source, it may be possible to utilize the MARS system 100 as a pre-treatment to improve zeolite longevity or as a post-treatment to regenerate the zeolite once it has become saturated. The MARS system 100 can be provided as either a stationary or a mobile unit.

For example, as illustrated in FIG. 1F, and as briefly mentioned above, the MARS system 100 can be integrated as part of a larger wastewater treatment system 150. Specifically, the MARS system 100 can be positioned between an anerobic membrane bioreactor (AnMBR) 152 and a zeolite bed 154 to act as a post-treatment for the AnMBR 152 and a pre-treatment for the zeolite bed 154, thereby extending the life of the zeolite bed 154 by reducing the rate of saturation. For example, feedwater 114 can first enter the AnMBR 152, which can treat the organics and suspended solids within the with feedwater 114. In some embodiments, an AnMBR may be a septic tank. However, typical AnMBR's can have limited capability when it comes to treating and removing nutrients, as generally described in the Examples below, such as ammonium, nitrogen, and phosphates. Accordingly, effluent from the AnMBR 152 can typically be high in these components.

While the zeolite bed 154 is capable of capturing these nutrients, high levels of these nutrients in the effluent from the AnMBR 152 can cause the zeolite bed 154 to become saturated quickly, reducing system effectiveness and economic feasibility. Accordingly, to increase the lifespan of the zeolite bed 154, the MARS system 100 can be positioned between the AnMBR 152 and the zeolite bed 154 so that effluent from the AnMBR 152 is first received by the MARS system 100. Accordingly, in view of the discussion above, the effluent from the AnMBR 152 can serve as the feedwater source 140 to the MARS system 100, which can precipitate and remove at least a portion of the nutrients from the AnMBR effluent. Correspondingly, the permeate produced by the MARS system 100 can then be transported to the zeolite bed 154 for post-processing to remove any remaining nutrients that may be present in the permeate.

Despite the MARS system 100 removing much of the ammonium and other nutrients, the zeolite be 154 can still become saturated over time and must be regenerated to maintain adequate nutrient removal. Typically, regeneration of the zeolite bed 154 can be accomplished by running a regenerant solution through the zeolite bed 154 to remove captured ammonium via an ion exchange reaction. For example, in some cases, a regenerant solution can be a high concentration sodium chloride solution that can remove adsorbed ammonium from the zeolite bed 154. In other embodiments, solutions of calcium chloride, magnesium chloride, potassium chloride, sodium chloride, or any combination thereof may be used to regenerate the zeolite bed 154. However, upon exiting the zeolite bed 154, the regenerant can be highly saturated with the ammonium that must be treated.

Correspondingly, in some cases, the MARS system 100 can be repurposed to regenerate the zeolite bed 154. For example, as illustrated in FIG. 1G, the MARS system 100 and zeolite bed 154 can be disconnected from the rest of the wastewater treatment system 150, such that feedwater 114 no longer flows to the MARS system 100. Instead, a regenerant (e.g., a brine solution) from a regenerant tank 156 can be provided to flow through the zeolite bed 154 (e.g., via operation of one of more pumps, not shown) to removed absorbed ammonium or other nutrients from the zeolite. The effluent from the zeolite bed 154 (i.e., ammonium-containing regenerant) can then flow to the MARS system 100, which can be operated in accordance with the description above to extract the ammonium from the effluent. Subsequently, the permeate from the MARS system 100 can be returned to regenerant tank 156, where it can be stored until it is replaced, or re-used to regenerate the zeolite bed 154.

In some embodiments, a clean water source, namely a rinse 158, can be run through the zeolite bed 154 following regeneration with the MARS system 100 (e.g., as a rinse stage or cycle). The rinse 158 may be used to remove residual regenerant from the zeolite bed 154. In some embodiments, this may allow the effluent from the zeolite bed 154 to remain low in regenerant when in resumes normal operation. The rinse 158 can be returned to the regenerant tank 156 after flowing through the zeolite bed 154.

In some cases, a MARS system can also be implemented as a mobile unit that can be used to assist with nutrient removal in other types of conventional waste treatment systems. For example, FIG. 1H illustrates a mobile treatment unit 160 in which the MARS system 100 is mounted to a vehicle 162 so that it can be taken to various waste treatment locations (e.g., a vehicle mounted). As shown, the mobile treatment unit 160 can be configured to be used as an auxiliary waste treatment and removal system for a septic tank 166, or another type of stationary waste treatment system. In the illustrated embodiment, the MARS system 100 is shown being coupled a zeolite bed 154 that is coupled to the septic tank 166 for nutrient removal.

Accordingly, the MARS system 100 can be used to regenerate the zeolite bed 154, as generally described above, by removing accumulated ammonium and other nutrients. Specifically, regenerant can be flowed through the zeolite bed 154 to recover the zeolite and then rinse 158 can be run through the zeolite bed 154.

In some cases, the mobile treatment unit 160 can also be configured to empty the septic tank 166. For example, the mobile treatment unit 160 can further include a sludge tank 168 that is mounted to the vehicle 162. The sludge tank 168 can be coupled to the septic tank 166 so that sludge, liquids, and scum can be pumped into the sludge tank 168 for removal to an offsite location.

In other cases, the mobile treatment unit 160 as generally described above may further include the zeolite bed 154 as described herein (not shown) on the vehicle 162. Using this mobile treatment unit 160 may include first exposing the zeolite bed 154 to the wastewater produced elsewhere and using the MARS system 100 as described herein to regenerate the zeolite bed 154 should it become saturated. In another case, the MARS system 100 may receive wastewater, as described generally above, and the zeolite bed 154 may receive nutrient-depleted permeate from the MARS system 100, thereby delaying saturation of the zeolite bed 154.

### EXAMPLES

### Example 1: Material and Methods

### Synthetic Solution

The concept of membrane assisted recovery of solids (MARS) can provide a cost-effective solution to effectively treat waste streams containing high concentrations of ammonium (NH₄⁺). The studies conducted within this disclosure treated a simplified synthetic solution from an ion exchange material regeneration process. The main characteristics of this source of wastewater were high concentrations of NH₄⁺ and sodium chloride (NaCl). The initial concentration of NH₄⁺—N was set to 5 g/L to simulate the concentration found in the waste that was produced. Struvite precipitation theoretically requires a minimum of a 1:1:1 ratio between NH₄⁺—N, phosphate (P—P), and magnesium (Mg²⁺). In some cases, this theoretical ratio may not be sufficient to fully eradicate the ion of interest. For example, some models suggest that an appropriate P/N ratio can be 1.1, but subsequent experiments have suggested that a 1.3 ratio between Mg/P, resulting in a 1.4 ratio of Mg/N, can be more effective. The ratio between Mg/N can be higher to avoid overdosing with PO₄³⁻, which would require further treatment downstream. Therefore, in the experiment described below, the ratio was selected to be 1:1.1:1.4 for NH₄⁺:PO₄³⁻:MG²⁺.

N/P Feed is the naming convention assigned to the synthetic wastewater containing 5 g/L NH₄⁺. N/P Feed also contained 1:1.1 ratio of phosphate (PO₄³⁻) ions between NH₄⁺: PO₄³⁻. The solution was made through the addition of ammonium chloride (NH₄Cl) and disodium phosphate (HNa₂PO₄). Certain experiments would replace N/P Feed with a solution that would also include sodium chloride (NaCl), denoted as NaCl Feed. A dosing solution was created to introduce the third required ion, Mg²⁺, which would be referred to as Mg Dose. Mg Dose was created with magnesium sulfate (MgSO₄). In general, struvite precipitation prefers alkaline conditions, so a third dosing solution would be added containing sodium hydroxide (NaOH), referred to as pH Buffer. To reduce the amount of volume needed for the pH Buffer, the concentration used was 6 M NaOH. All chemicals were of analytical grade obtained from either Fisher or Sigma-Aldrich and were prepared with deionized water (DI).

To account for the dilution caused by mixing three solutions together, the concentration of each chemical was increased. Specifically, the volume for each solution was determined by the solubility limits of MgSO₄, thus also determining the increase in concentration. The concentrations for the stock solutions were 23.9, 69.7, and 300.9 g/L of NH₄Cl, HNaPO₄, and MgSO₄ respectively. Volumes for the two main solutions, Feed and Mg Dose, were chosen to equal 2,000 mL. A volume ratio of 0.80 and 0.20 was used to calculate the increase in concentration for each of the salts for the N/P Feed and Mg Dose. The increased concentrations and corresponding volume ratios can be seen in Table 1, where each solution is broken down by the salts used. Once the two solutions were mixed, the desired concentration of ions would be hypothetically established (i.e., 5 g/L of NH₄⁺—N). The appropriate volume used for pH Buffer was determined through a standard titration method. Depending on the final pH goal, volume for pH Buffer would range between 100-175 mL.

TABLE 1
Recipe for solutions used throughout this
disclosure unless otherwise specified.

| | | Stock | |
|---|---|---|---|
| Stock | | Concentration | Volume |
| Solution | Chemical | (g/L) | Ratio |
| N/P Feed | NH₄Cl | 23.9 | 0.80 |
| | HNa₂PO₄ | 69.7 | |
| Mg Dose | MgSO₄ | 300.9 | 0.20 |
| pH Buffer | NaOH | 240 | — |
| NaCl Feed | NaCl | 36 or 72 | 0.80 |

### Crystallization Reactor

### Completely Stirred Reactor (CSTR)

For the initial development of MARS, a 2-liter Erlenmeyer flask was used as the crystallization reactor, and it was operated as a CSTR. The total height of the flask was 28 cm, with the smallest width at the top being 7.6 cm and the largest width at the bottom being 17.8 cm. To achieve a completely mixed state through mechanical mixing, a magnetic stir bad and stir plate were used (Corning PC-351 Hot Plate Stirrer, US). Table 2 highlights conditions that were maintained for all experiments that used the flask as a reactor. Some experiments may also include the addition of NaCl, but it will be specified within the respective section.

TABLE 2
Conditions maintained for all CSTR experiments

| Molar Ratio | [1:1.1:1.4] for [NH₄⁺:PO₄³⁻:Mg²⁺] |
|---|---|
| Synthetic Sources | NH₄⁺ = Ammonia Chloride, NH₄Cl |
| of Ions | PO₄³⁻ = Disodium Phosphate, HNa₂PO₄ |
| | Mg²⁺ = Magnesium Sulfate, MgSO₄ |
| Initial MAP Ion | Initial [NH₄⁺—N] = 5,000 mg/L |
| Concentrations | Initial [PO₄³⁻— −12 g/L |
| | Initial [Mg²⁺] = 12 g/L |
| Temperature | Starting temperature = 24-25° C. |
| | Final temperature = 29-30° C. |
| pH Buffer | 6M NaOH |
| Mixing | Completely Stirred, 250 RPM |

### Fluidized Bed Reactor (FBR)

A prefabricated 2.5-liter glass column reactor was another crystallization reactor used to test the function of MARS. Unlike the Erlenmeyer flask, the column reactor was operated as a fluidized bed reactor. Fluidization was introduced through a port near the bottom of the reactor, powered by a peristaltic pump that was set to 1,700 mL/min. Depending on the stage MARS was being operated, the fluidizing pump would also act as the membrane feed pump. Concentrate flowrate exiting the membrane would then be used as the fluidizing force for the reactor.

### Hydraulic Retention Time (HRT)

The hydraulic residence time (HRT) for a reactor was calculated by Equation 3.1.

$$HRT = \frac{V}{Q} \qquad Equation 3.1$$

$$where :$$

$$HRT = hydraulic retention time , min$$

$$V = volume of reactor , mL$$

$$Q = flow rate through the reactor , \frac{mL}{min}$$

### Membrane Module

### Membrane Module Construction

A custom-built membrane module made out of polyvinyl chloride (PVC) was used to house polyvinylidene fluoride (PVDF) X-flow tubular ultrafiltration (UF) membranes (Pentair, Minneapolis, MN, USA) for all MARS experiments. A clear PVC pipe was used as the main body of the membrane module to allow for visual observations. The module had a feed, concentrate, and permeate port which were each accompanied by a sampling port and a pressure transducer (Cole-Parmer, EW-68075-32, Vernon Hills, IL, USA). Seven membrane tubes were placed inside the module, each having a nominal pore size of 0.03 μm, an inside diameter of 5.2 mm, and a length of 52 cm. In total, the working surface area of the membrane equaled 0.059 m². Three polypropylene spacers were fabricated to keep the membranes evenly distributed within the module, with a spacer being placed on both ends and one in the middle. Once all membranes were secured into place, they were potted in place using a two-part epoxy mix.

### Operation of Membrane

### Filtration

The orientation of the membrane module during filtration can be seen below in FIG. 1. The permeate port was placed near the bottom for the purposes of removing accumulated solids. The module's total working volume was approximately 320 mL, including the feed and permeate chambers.

The membrane feed pump was set to a flowrate of 1700 mL/min, which resulted in a crossflow velocity of 0.19 m/s calculated by Equation 3.2.

$${v}_{x} = \frac{{Q}_{p}}{{XA}_{t}} \qquad Equation 3.2$$

$$where :$$

$${v}_{x} = crossflow sectional velocity , \frac{m}{s}$$

$${Q}_{p} = membrane feed flow rate , \frac{{m}^{2}}{s}$$

$${XA}_{t} = total cross - sectional area of membranes , {m}^{2}$$

### Dewatering

MARS experiments conducted under batch mode tested the membrane's behavior when the system was dewatered. Dewatering was also evaluated and characterized using a concentration factor and a volume reduction factor. Calculations were conducted using Equations 3.3 and 3.4.

$$CF = \frac{{TSS}_{f}}{{TSS}_{o}} \qquad Equation 3.3$$

$$where :$$

$$CF = concentration factor , unitless$$

$${TSS}_{f} = final concentration TSS , \frac{g}{L}$$

$${TSS}_{o} = initial concentration TSS , \frac{g}{L}$$

$$VRF = \frac{{V}_{o}}{{V}_{f}} \qquad Equation 3.4$$

$$where :$$

$$VRF = volume reduction factor , unitless$$

$${V}_{o} = initial volume in reactor , mL$$

$${V}_{f} = final volume in reactor , mL$$

### Performance Parameters

### Flux and Transmembrane Pressure (TMP)

Two parameters were used to determine membrane performance: flux and transmembrane pressure (TMP). Experiments within this research were set to a pre-determined flux. Whether flux was continuous or intermittent depended on whether MARS was operated under batch or continuous mode. This operation style results in the TMP starting at a low value then increasing over time due to membrane fouling. Flux and TMP were calculated using Equations 3.5 and 3.6.

$$J = \frac{{Q}_{p}}{{A}_{m}} \qquad Equation 3.5$$

$$where :$$

$$J = flux , liters / {m}^{2} / hours , LMH$$

$${Q}_{p} = permeate flow rate , L / h$$

$${A}_{m} = total membrane area , {m}^{2}$$

$$TMP = ( \frac{{P}_{f} + {P}_{c}}{2} ) - {P}_{p} \qquad Equation 3.6$$

$$where :$$

$$TMP = transmembrane pressure , bar$$

$${P}_{f} = feed transducer pressure , bar$$

$${P}_{c} = concentrate transducer pressure , bar$$

$${P}_{p} = Permeate transducer pressure , bar$$

The final flux reduction was also calculated and reported. Calculations were conducted following Equation 3.7.

$$FR ( \% ) = 1 - \frac{{J}_{f}}{{J}_{o}} \qquad Equation 3.7$$

$$where :$$

$$FR ( \% ) = flux reduction , \%$$

$${J}_{f} = final flux , liters / {m}^{2} / hours , LMH$$

$${J}_{o} = initial flux , liters / {m}^{2} / hours , LMH$$

### Specific Flux and Membrane Resistance

Specific flux and membrane resistance were parameters that were used to assess membrane fouling and recovery post cleaning. Both chemical and physical cleaning methods were used to restore the membrane within a 20% deviation of the industry standard of 1000 LMH/bar specific flux. Specific flux and membrane resistance were calculated following equations 3.8, and 3.9. Temperature corrections for dynamic viscosity were calculated using Equations 3.8, 3.9, and 3.10.

$${J}_{s} = \frac{J}{TMP} \qquad Equation 3.8$$

$$where :$$

$${J}_{s} = specific flux , liters / {m}^{2} / hours / bar , LMH / bar$$

$$J = flux , liters / {m}^{2} / hours , LMH$$

$$TMP = transmembrane pressure , bar$$

$${R}_{t} = \frac{TMP}{{μ}_{T} \cdot J} \cdot 3.6 \times {10}^{9} \qquad Equation 3.9$$

$$where :$$

$${R}_{t} = total resistance , \frac{1}{m}$$

$$J = flux , liters / {m}^{2} / hours , LMH$$

$$TMP = transmembrane pressure , kPa$$

$${μ}_{T} = temperature adjusted dynamic viscosity of water , Pa \cdot s$$

$${μ}_{T} = ( 1.784 - ( 0.0575 \times T ) - ( {10}^{- 5} \times {T}^{3} ) ) \times 0.001 \qquad Equation 3.1$$

$$where :$$

$${μ}_{T} = viscosity of water at temperature T , Pa \cdot s$$

$$T = water temperature , ° C .$$

### Water Quality Parameters

Various parameters were used to analyze the water quality of either the supernatant of settled crystals or the effluent being produced from MARS experiments conducted. These tests include ammonia (NH₃—N), reactive phosphorus (PO₄³⁻), magnesium (Mg²⁺), total suspended solids (TSS), turbidity, conductivity, pH, and temperature. Samples were collected with polypropylene syringes and stored in 15 mL polypropylene tubing. All samples except for turbidity and TSS were processed within a day after the experiment. Turbidity and TSS were both processed immediately after the experiment had concluded.

### Ammonia Nitrogen (NH₃—N)

Ammonia as nitrogen (NH₃—N) was tracked throughout experiments for the purposes of a detailed report on the removal of nitrogen. Nitrogen was measured using the Hach High Range Test 'N Tube™ Method 10031 (0.4-50 mg NH₃—N/L), also known as the salicylate method (Hach, Loveland, CO, USA). Single channel micropipettes were used to dilute samples through trial and error until appropriate ratios were determined. For the stock solutions of N/P feed, an appropriate serial dilution was determined to be a ratio of 50 followed by a ratio of 2 for the final 100 μL sample volume. Samples taken after the three solutions were mixed only needed a single dilution, but the dilution factor varied depending on the experimental method. After all dilutions, a 100 μL diluted sample was pipetted into its corresponding Hach vial. An additional vial would be used as the blank, which was created by pipetting 100 μL of deionized water (DI) into a vial. All vials had a powder pillow of ammonia salicylate added, followed by a powder pillow of cyanurate. Once both reactive agents were added, they were each inverted several times to mix and dissolve the powder contents. Vials were the allowed to react for 20 minutes before being wiped clean and measured using a Hach DR/4000U spectrophotometer.

Reactive Phosphorus (PO₄³⁻—P)

Orthophosphate as phosphorus (PO₄³⁻—P) was also measured. Phosphate was measured using the Reactive Phosphorus (ortho-phosphate) high range Test 'N Tube™ Method 3000 (1.0-100 mg/L PO₄³⁻), also known as the molybdovanadate method (Hach, Loveland, CO, USA). Similar to ammonia, dilution for samples were determined through trial and error. It was concluded that N/P feed needed a serial dilution of a ratio of 200 followed by a ratio of 5 for the required 5.0 mL volume in each vial. Samples taken after the three solutions were mixed only needed a single dilution, but the dilution factor varied depending on the experimental method. After all dilutions were made, the final 5.0 mL volume of sample required was pipetted into the digestive vial, and an additional blank vial was created using 5.0 mL of DI water. All vials were inverted several times to mix and were then allowed to react for 7 minutes. Vials were wiped clean and measured using a Hach DR/4000U spectrophotometer.

### Magnesium (Mg²⁺)

Magnesium was measured using Magnesium TNTplus® Method 849 (0.5-50 mg/L Mg²⁺), also known as the metalphthalein method (Hach, Loveland, CO, USA). The metalphthalein colorimetric method used to measure total magnesium is split into two different procedures depending on the concentration range that is being measured, Method I (0.5-10 mg/L Mg²⁺) and Method II (10-50 mg/L Mg²⁺). All vials started with metalphthalein in solid form. A buffer solution, Buffer A was added to dissolve the solid and is allowed to react for 2 minutes. The volume of Buffer A was dependent on the range of the magnesium concentration of the sample, with Method I requiring 3.0 mL and Method II requiring 3.5 mL of Buffer A. After two minutes of reaction time, the vial was wiped clean and placed in the DR1900 spectrophotometer to gather the first blank reading. Method I used 2.0 mL and Method II used 0.5 mL of sample. Stock Mg dosing solution required serial dilution and was analyzed using Method II. The first ratio for Mg dose serial dilution was 100 followed by a ratio of 20 for a final volume of 0.5 mL. After the corresponding samples volume was added, it is inverted to promote mixing and then allowed to react for 1 minute. The vial was then wiped clean and placed in the spectrophotometer for a final magnesium reading. Table 3 summarizes the two methods for Mg²⁺.

TABLE 3
Summary of Magnesium procedure depending
on concentration range.

| | | Volume of | Volume of |
|---|---|---|---|
| Method (849) | Concentration Range | Buffer A | Sample |
| Method I | 0.5-10 mg/L Mg²⁺ | 3.0 mL | 2.0 mL |
| Method II | 10-50 mg/L Mg²⁺ | 3.5 mL | 0.5 mL |

### Turbidity

Turbidity was read shortly after the last sample was taken for an experiment. High concentration samples were diluted before being measured by the turbidimeter. Turbidity for suspended solids was measured using a HACH 2100Q portable Turbidimeter (Hach, Loveland, CO, USA). Each sample was mixed thoroughly as to suspend all particles, and then allowed to settle. Immediately after settling, a sample would be slowly inverted to re-suspend the solids without causing bubbles to form and avoid skewing the results. Once the particles were re-suspended, the sample would be read at least three times. An average and standard deviation were calculated for each sample taken.

### Total Suspended Solids (TSS)

TSS was analyzed using a known volume sample following Standard Methods 2540B 2540E (Eaton et al., 2005). The volume used varied depending on the sample size that was collected, typically ranging between 0.5-2 mL. Tin cups held 0.45 μm filters (Omicron nylon filter), which were weighed prior to sample filtration. Each sample tube was stirred using a test tube shaker, resuspending particles that might have already settled. A micropipette was used to collect exact volumes and place them through a vacuum pump that assisted in the filtration process. Sample was pipetted slowly to avoid getting crystals on anything other than the filter since DI was not used for rinsing purposes. The filter plus the solids were placed in an oven (Fisher ISOTEMP®100 Series Model116G) for at least an hour at a temperature of 105° C. Afterward the sample would be placed in a desiccator for 10 minutes until cooled and would then then be weighed. TSS was calculated according to Equation 3.11.

$$TSS = \frac{( {M}_{1} - {M}_{2} )}{{V}_{1}} \qquad Equation 3.11$$

$$where :$$

$${M}_{1} = total weight of tin cup , sample , and filter after 105 ° C . , g$$

$${M}_{2} = weight of tin cup and filter , g$$

$${V}_{1} = volume of sample , mL pH$$

pH was measured using an ion selective probe. Calibration was done with a 3-point curve at the start of each day to assure accuracy. Before and after the probe would be placed in any solution, it would be rinsed thoroughly with DI water and then gently dried with kimwipes. The pH of each stock solution would be measured and recorded prior to each experiment. During an experiment, the pH probe would be left submerged in solution and the pH would be monitored. After the experiment, the probe would be thoroughly cleaned to ensure there were no remaining solids. Samples would be processed for pH readings within a day after the experiment was conducted. When not in use, the probe would be stored in a pH probe storage solution until it would be used again.

### Conductivity

An Oakton CON 6+ handheld conductivity meter and probe (OAKTON Instruments, IL, USA) were used to collect conductivity readings from both stock solutions and experimental samples. A three-point calibration was used to calibrate the probe and meter at least once a week. Each sample was diluted by a factor of 15 equaling a total volume of 15 mL to achieve a proper reading. After each sample was measured, the probe would be cleaned with DI and dried with kimwipes.

### Temperature

Temperature was recorded at the start of each experiment and throughout different samples. A temperature probe was used to measure stock solutions and samples taken for all experiments. Immediately once the sample was taken, temperature would be measured to capture an accurate reading.

### Solids Analysis

Selected samples were sent to the Nanotechnology Research and Education Center (NREC) at the University of South Florida for analysis. Prior to sending solid to be processed, they were either oven dried at 105° C. for 24 hours, or they were allowed to air dry for two weeks. The method that was used is specified within each experimental result. The tools used to analyze the samples were X-ray diffraction (XRD), scanning electron microscopy (SEM), and X-ray fluorescence (XRF). Samples processed by XRD and XRF were grounded into fine powders. The XRD (Bruker D2 Phaser, UK) was used as a technique to determine the crystallographic structure of the solids created. It works by irradiating a material with incident X-rays and then measuring the scattering angles and intensities leaving the material. Identification of the crystalline phases was done using X′Per' Highscore software version 3.0. The SEM analysis was conducted using a Hitachi SU-70. Magnification selected was based on the size of the crystals being observed. Elemental analysis was estimated using XRF (Bruker S2 Puma, UK).

### Automated Data Logging and Analysis

All automated data logging was done with a HOBO U30 data logger (Onset Computer Corporation, MA, USA). Logging time intervals were dependent on the experiment being conducted, but it typically ranged between 1 second and 1 minute. Each experiment will specify their logging time interval when applicable.

### Pressure

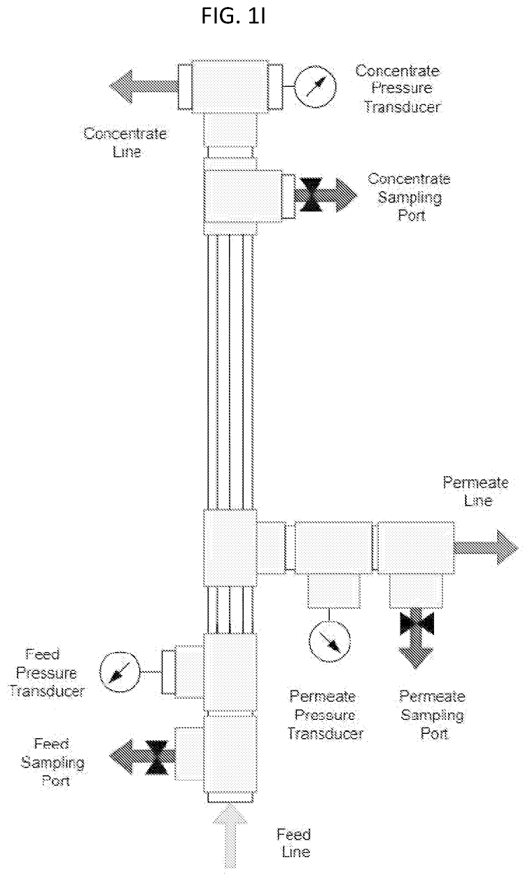

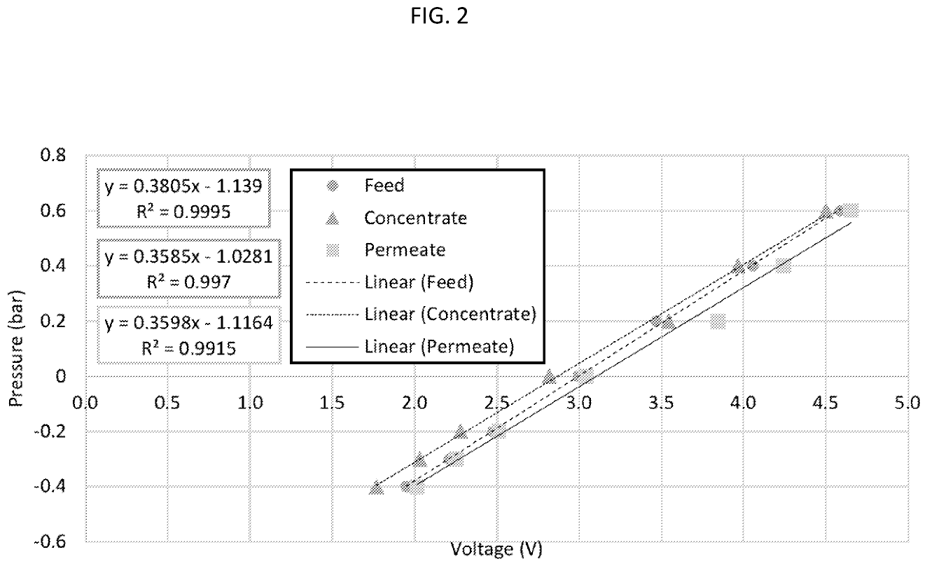

To track the pressure being experienced by the membrane, inline pressure transducers (Cole-Parmer, IL, USA) were placed near the feed, concentrate, and permeate ports. All three transducers (Compound Transmitter, 0.5 to 5.5 V Output) were calibrated to convert the voltage recorded to a pressure in the units of bars prior to adding them to the membrane module. Each transducer was calibrated using a 7-point calibration curve which was created using a closed segment of PVC tubing connected to a pressure gauge and a syringe. The calibration can be seen in FIG. 2. The correlation was used to calculate the pressures found throughout the membrane as well as the total membrane pressure (TMP). All data was recorded using a HOBO U30 automated data logging system (Onset Computer Corporation, MA, USA).

### Example 2

In some implementations, MARS can serve as a supplementary technology that can remove and recover NH₄⁺ through the pairing of a MAP crystallization reactor and a tubular ultrafiltration (UF) membrane module. Precipitation of MAP theoretically requires a 1:1:1 ratio between three ions: ammonium (NH₄⁺), phosphate (PO₄³⁻), and magnesium (Mg²⁺). Previous research has almost unanimously concluded that better removal is achieved with slightly increased ratios. Based on a culmination of other studies the molar ratio selected for all experiments was determined to be 1:1.1:1.4 for NH₄⁺:PO₄³⁻:Mg²⁺. Chemicals selected for this research were ammonium chloride (NH₄Cl), disodium phosphate (HNa₂PO₄), and magnesium sulfate (MgSO₄). A more detailed description behind the selection of the molar ratio, the chemicals selected, and their initial concentrations can be found in Example 1, above.

Solution pH is another parameter that impacts the removal of NH₄⁺ and the purity of the crystal formed. In general, pH can play a more significant role when NH₄⁺ concentrations are low, but it is still a matter worth investigating since it can also affect co-precipitation of other salts that may limit NH₄⁺ removal.

The last key factor that might affect the chemistry of MAP precipitation is the high presence of NaCl within the regenerant solution. For example, the presence of Na⁺ could, in some cases, reduce NH₄⁺ removal due to their similar charge, where one can stand in the way of the other. The degree to which Na⁺ affects the precipitation of MAP under high NH₄⁺ conditions may vary. Therefore, different concentrations of Na⁺ were tested to determine the feasibility of MARS as a tool for the treatment of zeolite regeneration wastewater. Experiments also tested the effect of varying pH and NaCl concentrations on the residual NH₄⁺ concentration and total suspended solids (TSS) produced. Further analysis on some the solids produced was conducted using X-ray powder diffraction (XRD), and a scanning electron microscope (SEM) to identify MAP formation.

The pairing of a MAP crystallization reactor and a tubular polyvinylidene fluoride (PVDF) UF membrane is the first of its kind. The flat-sheet MF and NF combination would not be appropriate for decentralized contexts due to the capital cost and required energy associated with sustaining their operations. Flat-sheet membranes are less prone to fouling and relatively easy to control but are more expensive than tubular membrane modules which can utilize backwashing to mitigate fouling. At a lower operating pressure and lower initial cost, tubular UF membranes could serve as an appropriate technology to separate and recover MAP after precipitation in low-resourced communities. To demonstrate the use of a tubular UF membrane to separate MAP, a multi-day study was conducted on a recycle batch process that incorporates both processes. TMP was continuously tracked and monitored as a representation of fouling. TMP and TSS will be used to monitor membrane fouling.

### Experimental Procedures

MARS seeks to provide a solution to NH₄⁺ management in decentralized contexts using a MAP crystallization reactor paired with a UF membrane. Two aspects of MARS will be investigated, the first will be the MAP chemistry in the crystallization reactor and the second the UF membrane's ability to filter MAP over a long period of time. All experiments conducted within this section followed the initial starting conditions summarized in Example 1: Completely Stirred Reactor (CSTR). Each experiment started with a 5,000 mg/L NH₄⁺—N concentration and operated at a MAP ratio of 1:1.1:1.4 (NH₄⁺:PO₄³⁻:Mg²⁺). Some trials replaced the N/P Feed synthetic solution with NaCl Feed, which added varying concentrations sodium chloride (NaCl) salts in addition to the original N and P solution.

### Preliminary MAP Trials

Bench-scale testing was done in a 2-liter flask to provide greater insight into MAP precipitation under varying pH and sodium chloride (NaCl) conditions. pH can be an important factor for MAP precipitation, as it can promote the crystallization of other analogous precipitates that may inhibit NH₄⁺ removal. For example, regenerant solution pH between 10.2 and 12.2 is outside the pH 7-10 range that favors MAP precipitation.

Three tests, (pH 7, pH 9, and pH 10) were be conducted to determine the effect of pH on MAP precipitation using N/P Feed as synthetic wastewater, containing only 5,000 mg/L NH₄⁺—N. The best performing pH was then selected to test the effect of varying NaCl concentrations (30 g/L NaCl and 60 g/L NaCl), which will more closely mimic the wastewater produced in zeolite regeneration. The addition of NaCl can, in some cases, inhibit NH removal. A summary of the pH and NaCl trials can be seen in Table 4.

TABLE 4
Parameters that change between the preliminary batch trials.

| Experiments | pH 7 | | pH 9 | | pH 10 | | NaCl-30 | | NaCl-60 | |
|---|---|---|---|---|---|---|---|---|---|---|
| Feed | N/P Feed | | N/P Feed | | N/P Feed | | NaCl Feed | | NaCl Feed | |
| pH | 7 | | 9 | | 10 | | 9 | | 9 | |
| [NaCl] | 0 | g/L | 0 | g/L | 0 | g/L | 30 | g/L | 60 | g/L |
| Reaction | 30 | min | 30 | min | 30 | min | 10 | min | 10 | min |
| Time | | | | | | | | | | |
| Settling | 0 | min | 0 | min | 0 | min | 20 | min | 20 | min |
| Time | | | | | | | | | | |

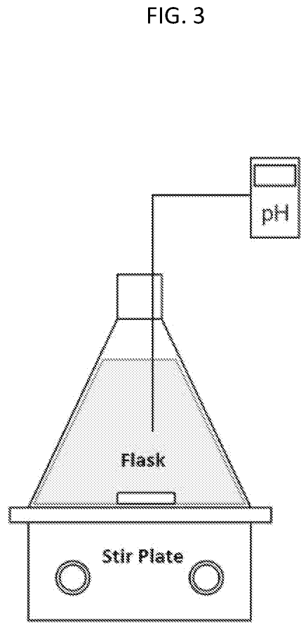

Flask trials were performed by adding 1,600 mL of either N/P Feed or NaCl Feed, depending on whether it was a pH trial or an NaCl trial, to the 2-liter reactor. Mixing induced by a stir plate was set to 250 RPM, creating a completely stirred reactor (CSTR). The dosing order was selected to be Mg Dosing followed by pH Buffer, to increase the favorability of NH₄⁺ in the form of MAP precipitation. Solution pH was monitored using an in-line pH probe. A schematic of the CSTR set-up can be seen in FIG. 3 alongside a photo of the set-up. The pH trials were mixed for a total of 30 minutes, with various samples taken from within the flask. The NaCl trials were mixed for 10 minutes and then allowed to settle for 20 minutes to determine if additional NH₄⁺ removal was achieved during its settling stage. Samples collected during the settling stage were collected 1 cm below the water level, approximately 11 cm from the top of the reactor. All samples were processed for dissolved NH₄⁺ concentrations. Samples taken only during a mixing stage were processed for total suspended solids (TSS). To confirm MAP formation, solids from the pH trials were analyzed using X-ray diffraction (XRD). Additionally, solid samples from pH 9 and NaCl-60 were analyzed under a scanning electron microscope (SEM) to try to note differences in appearance. Solids were decanted once the experiment ended, and they were placed in an over for 24 hours at 105° C.

### MARS Longevity

For decentralized purposes, a UF tubular membrane was selected to be paired with a MAP crystallization reactor. Although more prone to fouling, UF membranes can incorporate backwashing to extend their performance life. Since this was just the initial development of MARS, backwashing was not incorporated into its operation. Instead, crossflow UF filtration was tested over a multi-day experiment in batch recirculation to determine whether UF membranes were equipped for MAP separation.

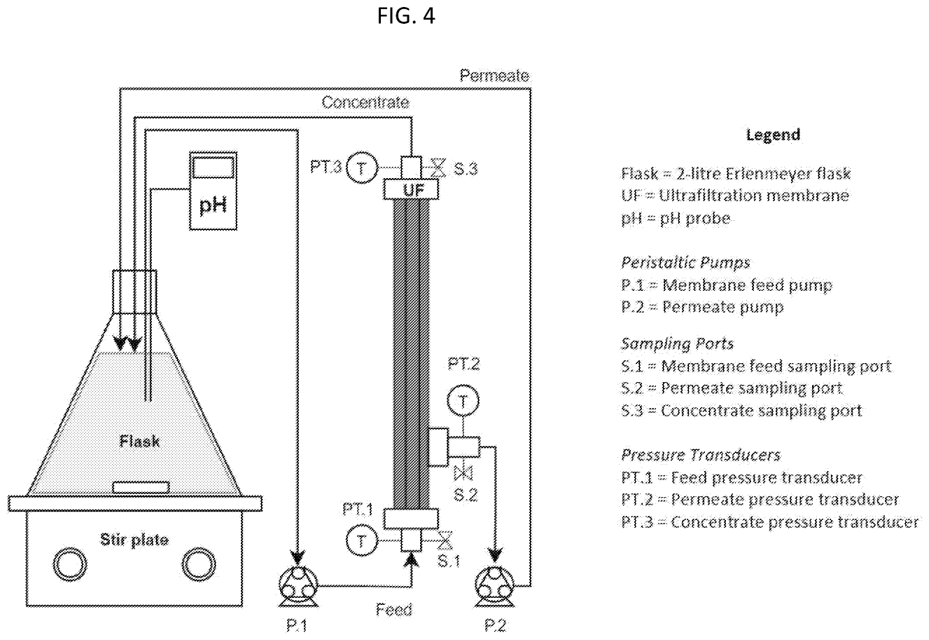

A thorough description of the custom-built membrane module can be found in Example 1. Three pressure transducers were located on the feed, concentrate, and permeate ports and served to track the internal pressured experienced by the membrane. MAP precipitation was conducted under similar conditions described above. The feed in this experiment contained no NaCl and the initial pH was set to 9 with 6 M NaOH. Masterflex™ tubing connected the flask and the UF membrane, bringing both the permeate and the concentrate back to the reactor. A detailed schematic of MARS can be seen in FIG. 4. Once the volume of 1,600 mL M/P Feed was added to the flask, the feed pump was operated at 1,700 mL/min creating a crossflow velocity of 0.19 m/s. Permeate was collected after both Mg Dosing (400 mL) and pH Buffer (175 mL) were added. The permeate pump was operated at 99 mL/min, creating a membrane flux of 100 LMH. Table 5 summarizes membrane specific operational parameters for the membrane longevity study. Transmembrane pressure (TMP) was tracked with a HOBO U30 data logger (Onset Computer Corporation, MA, USA) at 1-minute intervals. TMP was used to monitor the health of the membrane over the multi-day study. Total suspended solids (TSS) samples from the membrane feed port were obtained during the first hour and a half, to gauge the solids loading experience by the membrane over time.

TABLE 5
Operational parameters specific to the batch MARS longevity trial.

| | PVDF Tubular | |
|---|---|---|
| Membrane Type | Ultrafiltration (UF) | |
| Feed Flowrate, Q_{f} | 1,700 | mL/min |
| Permeate Flowrate, Qₚ | 99 | mL/min |
| Crossflow Velocity (CV) | 0.19 | m/s |
| Flux | 100 | LMH |

| | |
|---|---|
| pH | 9 |

### Results and Discussion

### Water Quality

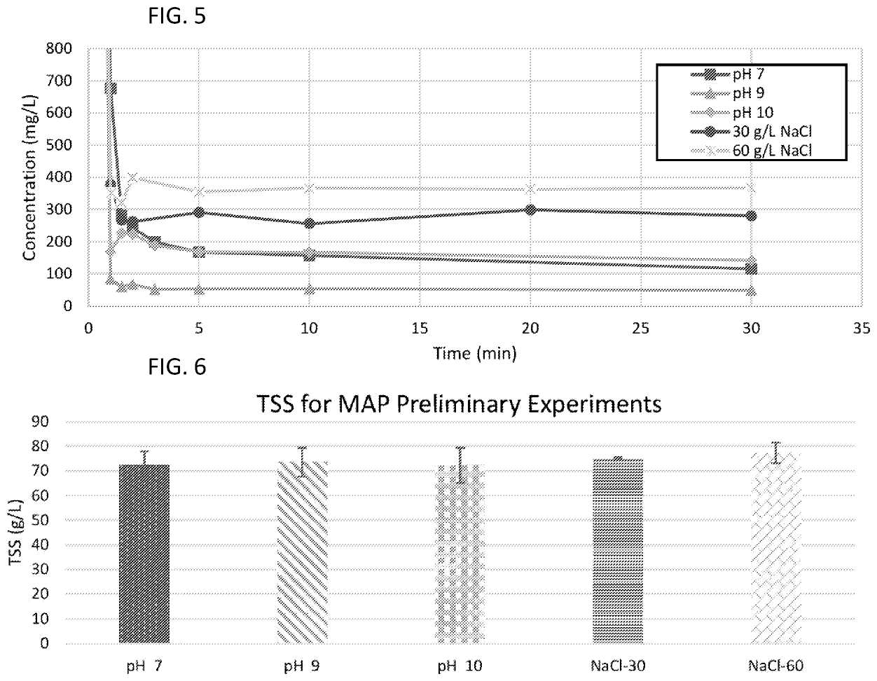

MAP precipitation under appropriate conditions such as molar concentration, pH, and mixing intensity, can be fine-tuned to achieve a desired NH₄⁺ removal. Other factors, like the presence of foreign ions, can lead to a stunted removal due to overcrowding or co-precipitation of other salts. Treatment of a highly concentrated solution, such as zeolite regenerant wastewater, may not be restricted by typical chemistry conditions due to the favorability of precipitation. The starting concentration of a 2-litre synthetic zeolite regenerant wastewater was 5,000 mg/L NH₄⁺—N. A molar ratio of 1:1.1:1.4 for NH₄⁺:PO₄³⁻:Mg²⁺ was selected. The effect of pH and high presence of NaCl were tested to determine if the two parameters would inhibit NH₄⁺ removal. Results for all 5 experiments can be seen in FIG. 5.

Initial concentrations were not displayed in FIG. 5 for ease of data readability, but all experiments started with 5,000 mg/L of NH₄⁺—N at time zero. The first experimental sample was taken at 1-minute, since that was the time required to mix in the Mg Dosing and pH Buffer solution. All experiments followed similar kinetics, were equilibrium was reached almost immediately. This is expected given the conditions under which MAP stoichiometry. Results from the pH studies appear to agree with a statement made by others, where they claimed that a wider pH margin can achieve precipitation of MAP when starting concentrations are above 1,000 mg/L NH₄⁺—N. Table 6 includes a summary of all final percent removals achieved by each experiment. The best removal achieved was by pH 9, resulting in an average residual concentration of 50 mg/L NH₄⁺—N and a removal of 99±0.1%. Overall, the removal attained from all three pH experiments were above 97%, whereas the inclusion of NaCl reduced removal down to 94.3%. This indicated that the presence of Na⁺ ions has a bigger effect on NH removal than pH conditions. Although not equal removals, the difference was not considered significant enough to disqualify MAP precipitation as treatment technique.

TABLE 6
Summary of the final NH₄⁺—N percent removal.

| Experiments | Final [NH₄⁺] percent removal |
|---|---|
| pH 7 | 97.8 ± 0.1% |
| pH 9 | 99.0 ± 0.1% |
| pH 10 | 97.1 ± 1.2% |
| NaCl-30 | 95.0 ± 0.1% |
| NaCl-60 | 94.3 ± 0.1% |

### Solids Produced

The solids produced from these experiments are expected to be an analog of MAP. Precipitation was observed immediately upon adding Mg Dosing to the reactor Feed (either N/P or NaCl). A white and opaque crystalline slurry was formed, visually remaining the same once the pH Buffer was quickly added. FIG. 6 shows both (a) the state of the initial stock solution and (b) the white slurry that is formed immediately upon mixing together all three solutions.

Production of crystals above the size of 0.45 μm were quantified by taking a sample at the end of the mixing period and processing it for TSS. Samples for pH trials were collect after 30 minutes of mixing and samples for NaCl trials after 10 minutes. On average the concentration produced stayed between the ranges of 70-80 g/L TSS. This was a difficult value to compare to other literature, as the starting conditions of NH₄⁺ are very different from previous work. It did raise concerns over the UF membranes' ability to filter such high concentration of particulates, since most UF applications in wastewater deal with an average mixed liquor suspended solid of 15 g/L TSS. Although there was an inherent difference between biological and inorganic fouling, it was undetermined whether a UF module could sustain long-term operation at 70-80 g/L TSS.

Liquid from the flask was decanted and the remaining solids were collect in ceramic containers. To expedite the drying process, solids were place in the oven at 105° C. for 24 hours. The crystals produced formed a soft white powder.

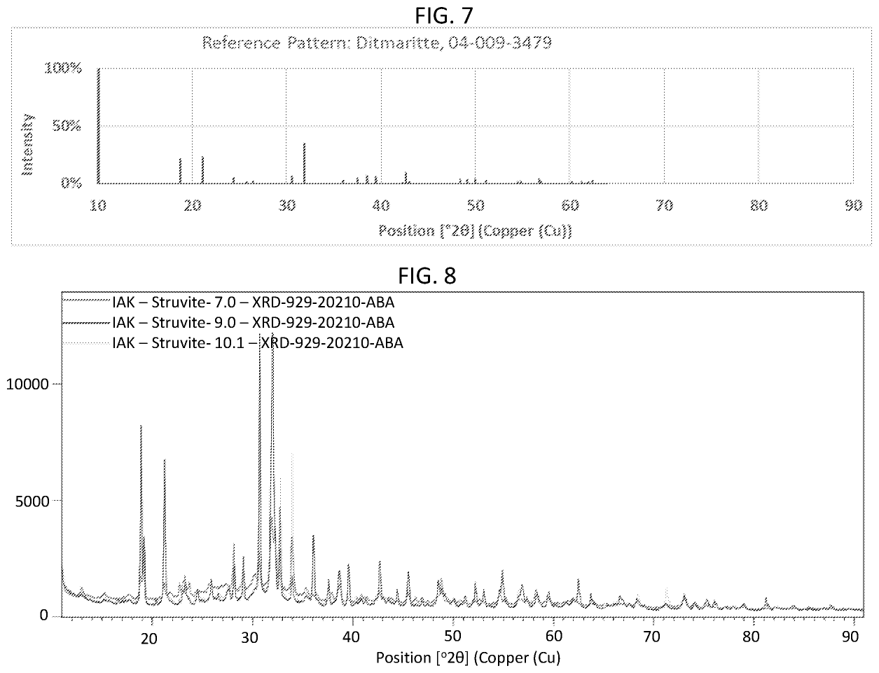

MAP identification for the pH trials was done using XRD. The XRD traces generated from powdered samples produced a satisfactoy match to the reference pattern of dittmarite (04-009-3479). Dittmarite (MgNH₄PO₄·H₂O) is a MAP analog that has one water molecule, whereas the standard MAP analog, struvite (MgNH₄PO₄·6H₂O), has six. A vertical line plot representing the database peaks for dittmarite is showns in FIG. 7 alongside a culmination of the three pH tests in part (b). The formation of dittmarite was not unexpected, as the solids were placed in an over for 24 hours at 105° C. to expedite the drying process. If struvite is placed under boiling conditions, the extra water molecules will evaportate and leave behind MAP in the form of dittmarite. A benefit of dittmarite is that it includes a higher percent by weight composition of each ion when compared to struvite.

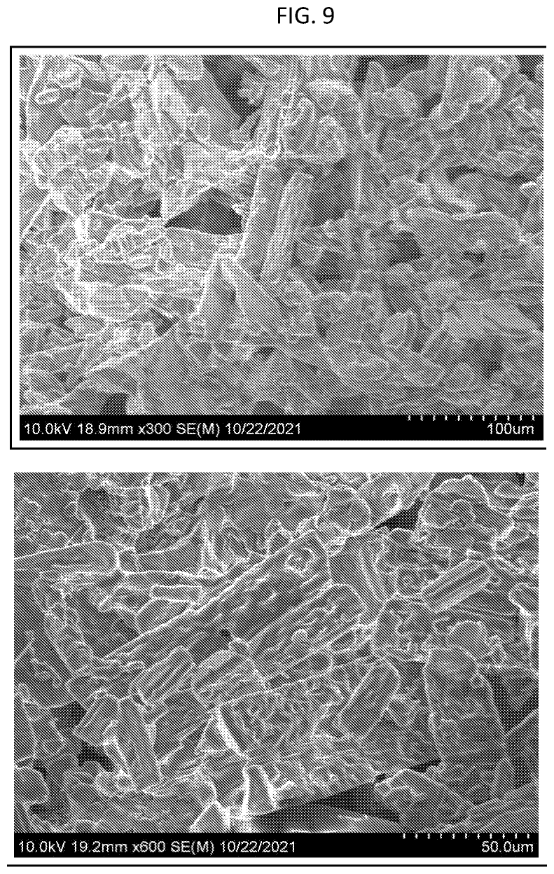

Scanning electron microscopy (SEM) was done on two selected samples, pH 9 and NaCl-60 (FIG. 9). Both samples showed little to no difference between the captured images. In general, MAP precipitation can take many forms; anywhere from irregular crystal shapes, to cube-like crystals, to rod-like irregular crystals. Precipitates from this study seem to combine both a presence of rod-like crystals and irregular crystals, where irregular describes snow particles that can cover the base shape of a crystal. The coating was assumed to be smaller MAP particles that did not have a chance to grow, or which may have possibly broken due to mixing intensity of 250 RPM.

### Membrane Performance

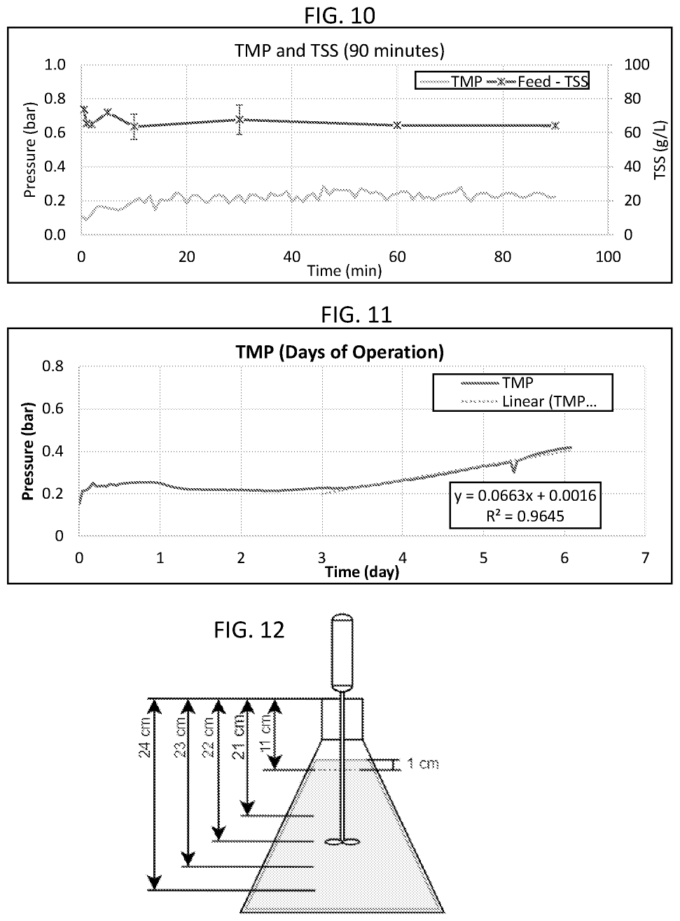

The membrane crossflow longevity study lasted a total of six days before it was stopped due to tubing failure. Although appropriate tubing and pump heads were paired, damage sustained on the plastic over a long period of time caused a leak. Once the leak was noticed the experiment was brought to an end. Data collected within the initial 90 minutes included both the TMP and the TSS being fed to the membrane, which can be seen in FIG. 10. TSS concentration filtered by the membrane remained relatively constant at an average of 65 g/L, resulting in a stable TMP near 0.20 bar. Small fluctuations in TMP are assumed to be a result of the peristaltic pumps which over time become muted. This can be seen in FIG. 11, where the time frame is six days. During the multi-day trial, the TMP stabilized at 0.20 bar, until it began to show a linear increase on the third day. It was possible that crystal sizes became larger over time, as suggested in the literature. The final rate of fouling that was captured between day three and day six was 0.07 bar/day.

As previously discussed, failure to treat point sources for their high NH₄⁺ concentrations could lead to devastating effects on the local ecosystem. When dealing with high eutrophic solutions, MAP precipitation has been proven to be a reliable tool under various circumstances. With the right chemistry, NH₄⁺ can be precipitated out in the form of a crystal that can act as a slow-release fertilizer for agricultural applications. Although the presence of NaCl can reduce NH₄⁺ removal, MAP was still deemed as an appropriate technology for zeolite regeneration wastewater treatment. At the highest NaCl concentration of 60 g/L, the removal for NH₄⁺ was 94.3±0.1% for a starting concentration of 5,000 mg/L NH₄⁺—N. With the addition of a long-standing MAP filtration experiment, MARS can be seen as a feasible solution to decentralized NH₄⁺ management.

### Example 3

The next steps involve pairing the two technologies, the flask crystallization reactor operated as a completely stirred reactor (CSTR) and the UF membrane, and testing their ability to remove and recover NH₄⁺ under batch mode operation. All aspects will serve to gain a deeper understanding of possible advantages and limitations of this new technology.

Separation of solids and liquid in other MAP precipitation technology is primarily achieved through sedimentation, regardless of whether it was a small- or large-scale operation. This places a greater emphasis on the size of the crystals produced since it has a direct correlation to their settleability. For situations that may require faster separation, sedimentation may not be the ideal process to recover low turbidity effluent. Accordingly, the addition of seeding material can be used to create larger crystals with improved settling. To determine the settleability of the MAP crystals, formed under the synthetic regeneration solution containing only 5,000 mg/L NH₄⁺—N at a 1:1.1:1.4 molar ratio (NH₄⁺:PO₄³⁻:Mg²⁺), a turbidity settling profile will be created. The created profile will then be compared to turbidity measurements from MARS experiments to quantify the benefit of membrane assisted separation.

Correspondingly, induction time, which describes the time it takes for ions to form into solids, may vary depending on the specific application. Additionally, precipitation equilibrium can be important as the pores of a UF membrane (0.03 μm) may not be small enough to prevent ions from passing through to the permeate. Thus, different reaction times prior to filtration will be tested for MARS operation to determine optimum performance in ion concentration removal and turbidity post filtration. After the allocated reaction time, the effluent from the membrane can be recycled back to the reactor for an extended period of time to track the membranes performance. Membrane health can be monitored by tracking the transmembrane pressure (TMP) and checking the total suspended solids (TSS) being fed to it in batch mode. MAP membrane separation previously done with flat-sheet microfiltration membranes (MF) saw an increase in fouling when solid concentrations increased within the reactor. Therefore, an additional MARS operation was studied where effluent is collected instead of recycled. Collecting the effluent and dewatering the reactor will concentrate the solids, increasing the loading to the membrane. As previously mentioned, TMP was used to assess the health of the membrane, in addition to membrane flux. This will serve as a greater insight into the capabilities of MARS recovering treated effluent.

### Experimental Procedure

Parameters such as molar ratios, synthetic sources of ions, and mixing were kept the same between all experiments. Temperature was not regulated, as it remained below the critical value of 55° C. which causes dissolution. Preliminary studies demonstrated than an appropriate pH falls within the range of 9-10. Molar ratio of 1:1.1:1.4 for NH₄⁺:PO₄³⁻:Mg²⁺ was used for all experiments. Experiments conducted within this Example followed the recipe for N/P Feed, Mg Dose, and pH Buffer described in table 1. A comprehensive summary of starting conditions for CSTR chemistry can be found in Table 2. A total 5 experiments were conducted, table 7 summarizes all experiments, stages, and time distributions.

TABLE 7
Summary of all experiments in Example 3.

Stage Time Distribution (min)

| Experiments | RXN | FR | DWR | Settle |
|---|---|---|---|---|
| Control | 10 | 0 | 0 | 80 |
| (10 min RXN) | | | | |
| MARS | 0 | 90 | 0 | 0 |
| (0 min RXN) | | | | |
| MARS | 5 | 85 | 0 | 0 |
| (5 min RXN) | | | | |
| MARS | 10 | 80 | 0 | 0 |
| (10 min RXN) | | | | |
| MARS | 10 | 5 | 15 | 0 |
| (DWR) | | | | |

RXN = Reaction stage,
FR = Filtrate recycle stage,
DWR = Dewatering stage

### Control (CSTR)

A flask was used as a crystallization reactor and was operated as a CSTR to precipitate MAP under various chemistry parameters. The control was divided into two distinct stages: reaction (10 minutes) and settling (80 minutes). Reaction (RXN) and settling stages were tested for dissolved ion concentrations (NH₄⁺, PO₄³⁻, and Mg²⁺) and turbidity. Both pH and temperature were monitored to stay within their specified ranges. An initial volume of 1600 mL of N/P feed solution was added to the reactor with the stir bar already in place. Mixing was set to 250 RPM before both the Mg Dosing and pH Buffer solutions were added, continuing at that speed for the duration of the reaction stage. The addition order consisted of 400 mL of Mg Dosing followed by pH Buffer required to reach a pH between 9-10, marking the beginning of the RXN stage. FIG. 12 shows a schematic of the control, a photo of the experimental set-up, and a second schematic highlighting different sampling locations.

Samples were taken from designated locations within the reactor which can be seen in FIG. 12. Location values were 11, 21, 22, 23, and 24 cm from the top of the flask. The location of 11 cm was selected to be 1 cm below the water level to avoid any colloidal crystals floating at the top during sedimentation. RXN stage had five samples taken at 0-, 0.5-, 1-, 5-, and 10-minutes, all of which were pulled from the 11 cm location. After 10 minutes of mixing within the RXN stage, the stir plate was turned off and crystals were allowed to settle. During the settling stage, samples taken at 20-, 30-, 60- and 90-minutes were pulled from all previously denoted locations to create a settling profile. Two sample sizes were pulled, one of 15 mL to measure ion concentrations and turbidity, and the other of 3 mL to measure TSS.

### MARS(CSTR+UF)

This version of MARS paired a flask crystallization reactor operated as a CSTR with a UF membrane. MARS was tested in four variations to research its effect on permeate characteristics, and membrane filtration performance. Three distinct stages (reaction, filtrate recycling, and dewatering) at varying time distributions were developed to assess the impact on parameters such as ion concentrations, turbidity, total suspended solids (TSS), transmembrane pressure (TMP), volume recovered, and flux.

Reaction (RXN): This stage used the same experimental configuration and operation as what was previously described. The RXN stage did not include the membrane loop in order to allow for chemical equilibrium to be reached before filtration is started. All samples within this stage were collected from the crystallization reactor. Sampling location during the RXN stage was 11 cm from the top of the reactor, approximately 1 cm below the water level. Mixing was started before Mg Dosing and pH Buffer were added to the reactor and continued into the following stages. RXN stage as soon as Mg Dosing was added, so the next sample was taken as quickly as possible. Experiments tested reaction times of 1-, 5-, and 10-minutes in combination with the filtrate recycling stage for a total of 90 minutes.

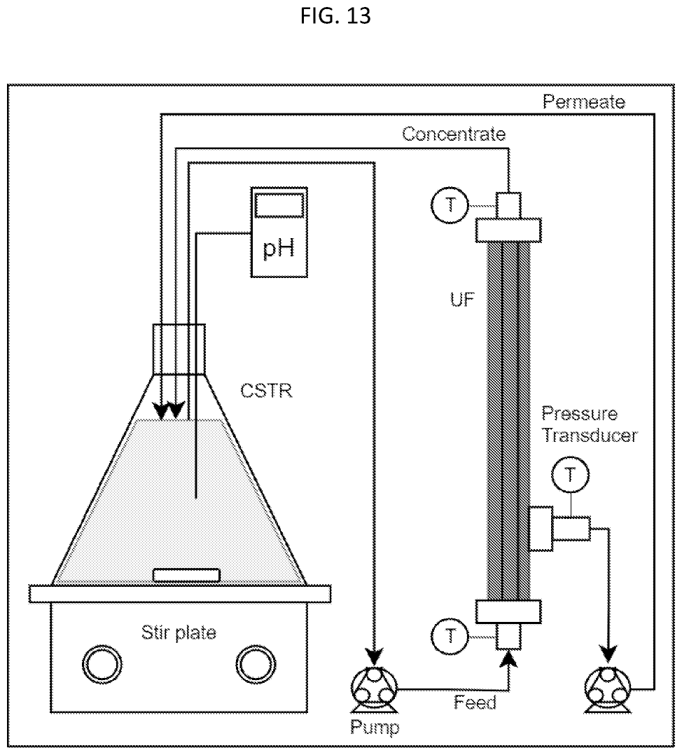

Filtrate Recycling (FR): This stage included the operation of UF in addition to the CSTR. Concentrate and permeate lines were recirculated back from the UF into the reactor for a recycle batch operation. A membrane feed pump was used to pull the solution from the CSTR at a flow rate of 1700 mL/min, resulting in a membrane crossflow velocity of 0.19 m/s. Permeate was pulled by another pump set to 99 mL/min flow rate to achieve 100 LMH flux. Transducers located at the feed, permeate, and concentrate ports were used to continuously monitor the TMP of the membrane using a HOBO U30 data logger (Onset Computer Corporation, MA, USA). FIG. 13 shows a schematic of MARS in FR mode. Experiments testing reaction time were followed by filtrate recycling until the experiment ended.

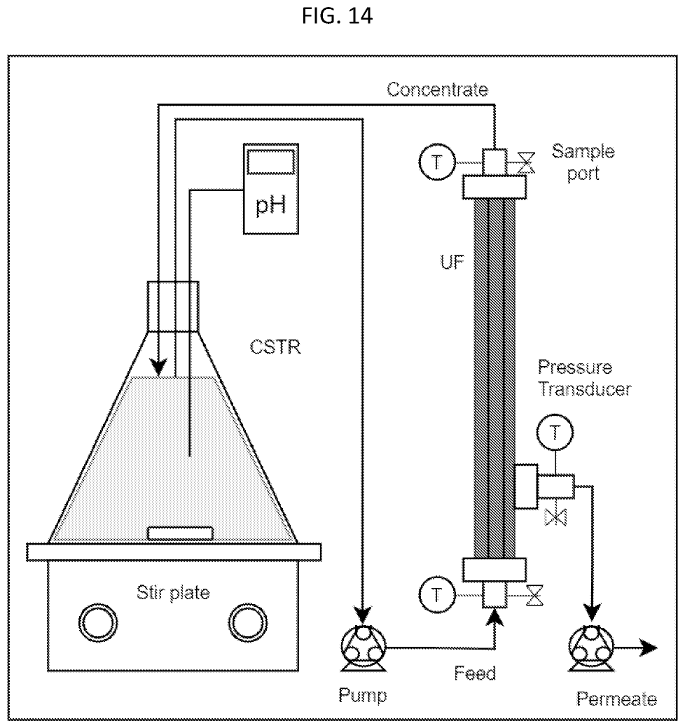

Dewatering (DWR); This stage included both the CSTR and the UF. Instead of recycling the concentrate and permeate back to the reactor, the dewatering stage collected the permeate in a separate container. Pumps maintained the same flowrates that were previously mentioned, 1700 mL/min and 99 mL/min for the feed and permeate pump respectively. Similar to filtrate recycling, transducers monitored the TMP of the membrane. Sampling for dewatering was pulled exclusively from the UF module, from either the permeate or the feed port. Permeate was collected into a graduated cylinder to record the cumulated volume over time. Permeate flow rate was measured to calculate the flux across the membrane. Collection continued until the water level reached dropped 26 cm from the top of the reactor, corresponding to a volume reduction factor (VRF) of approximately 3. FIG. 14 shows a schematic of MARS in the DWR stage.

Experiments investigating the effects of reaction time were conducted for 90 minutes, with 0-, 5-, and 10-minutes in reaction stage and 90-, 85-, and 80-minutes in recycling respectively. For the trial operated entirely under recirculation (0-min reaction, 90-min recirculation), the membrane loop (feed and permeate pump) and the stir plate were turned on once the N/P feed was placed in the CR. Immediately after, both Mg dosing and pH buffer were added to the solution marking the beginning of the recirculation phase for this trial. No samples were taken from the CSTR and instead were only pulled from the UF membrane. Experiments that included an initial reaction time began the FR immediately after the RXN stage ended.

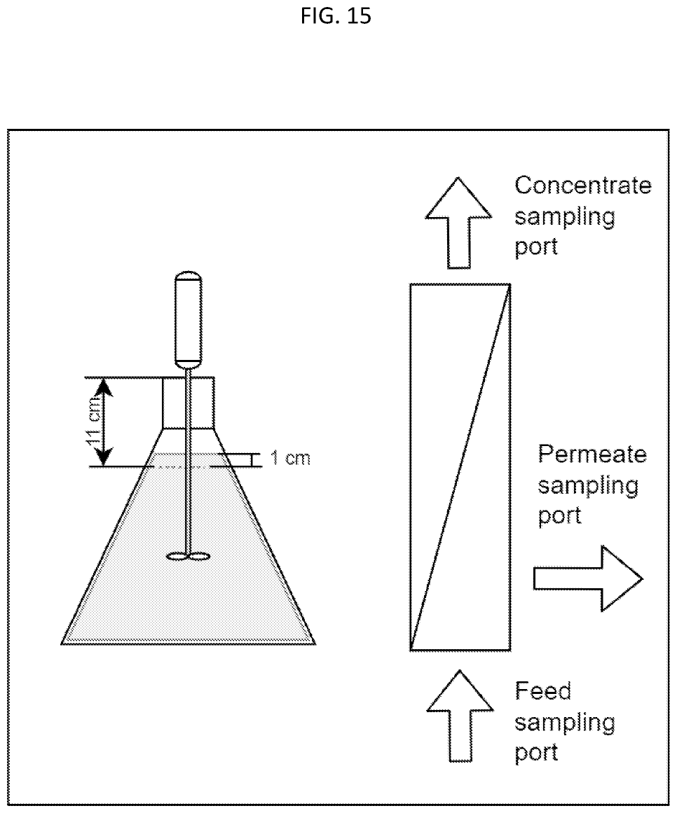

Samples taken from all stages were tested for ion concentrations (NH₄⁺, PO₄³⁻, and Mg²⁺), turbidity and TSS. Sample location varied depending on the stage as well as the parameter being tested. FIG. 15 denotes a simple schematic of MARS illustrating the sampling locations for the CSTR and the UF membrane. Table 8 summarizes the location from which a sample was taken based on the stage and the test being performed.

TABLE 8
Breakdown of sample locations. Based on the stage the sample
was taken and the test being performed on the sample.

| | | Stage | | | | |
|---|---|---|---|---|---|---|
| | | | FR | | DWR | |
| | | RXN | UF | UF | UF | UF |
| Sample Location | | Reactor | Perm | Conc | Perm | Conc |
| Sample | NH₄⁺ | ✓ | ✓ | | ✓ | |
| Test | PO₄³⁻ | ✓ | ✓ | | ✓ | |
| | Mg²⁺ | ✓ | ✓ | | ✓ | |
| | Turbidity | ✓ | | ✓ | | ✓ |
| | TSS | ✓ | ✓ | | ✓ | |

### Membrane Regeneration

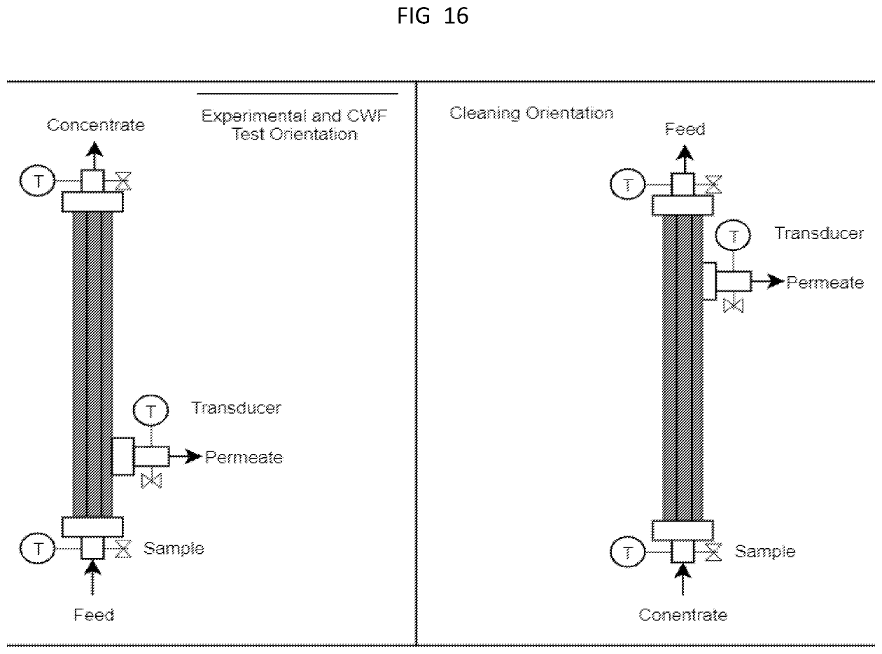

Before and after each experiment was conducted, a clean water flux (CWF) test was used to determine the health of the membrane. Temperature and pressure data was collected to calculate the membrane resistance and specific flux. For the membrane to be considered restored, it should have a specific flux that of no more than 20% reduced from its manufacture specified value of 1000 LMH-bar. Achieving this level of filterability required either physical or chemical cleaning depending on the degree of fouling. Cleaning procedures were conducted with the membrane module being reversed so that the permeate port was near the top instead of near the bottom. Orientation was changed for the purpose of achieving backwashing of the entire permeate chamber during the cleaning process. CWF tests reverted the membrane back to its original position. FIG. 16 shows the two placements of the module depending on whether it was being cleaned or used for an experiment or a CWF test. Data collected from these studies would serve to quantify the effectiveness of membrane cleaning from MAP fouling.

### Clean Water Flux Test (CWF)

Deionized water (DI) was used for CWF tests. After each experiment, the UF membrane was rinsed with DI for 5-10 minutes removing non-fixed crystals. Once the concentrate was clear, the CWF test would be performed in a recycle batch operation to assess the condition of the membrane. This test would be repeated twice to gain an average of the specific flux at three different instances: before an experiment was conducted, after cleaning had been performed, and after an experiment ended. The feed pump was set to 1000 mL/min maintaining a crossflow of 0.11 m/s. The concentrate line was slightly closed using 4.5 mm maximum tubing clamp to increase the pressure within the module and cause permeate to be produced. Concentrate tubing was clamped to the same degree for each test. A permeate pump was not used, instead permeate flowed out of the system freely. CWF test was conducted for a total of 10 minutes, with permeate flowrate being measured at 0-, 5-, and 10-minutes to obtain an average. Pressures were continuously monitored by transducers and recorded by that HOBO data logger. Temperature was recorded immediately after each time a flowrate measurement was taken, obtaining an average temperature value for the 10-minute procedure.

### Physical Cleaning

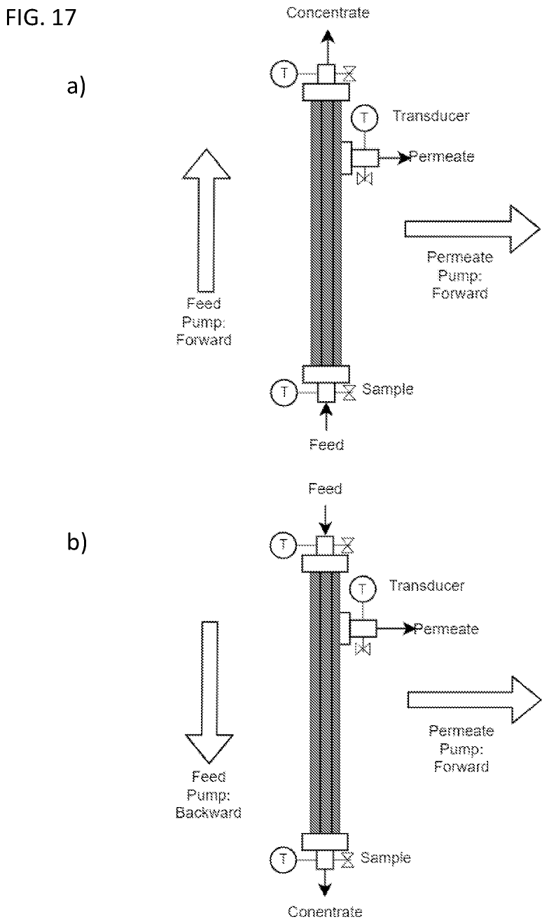

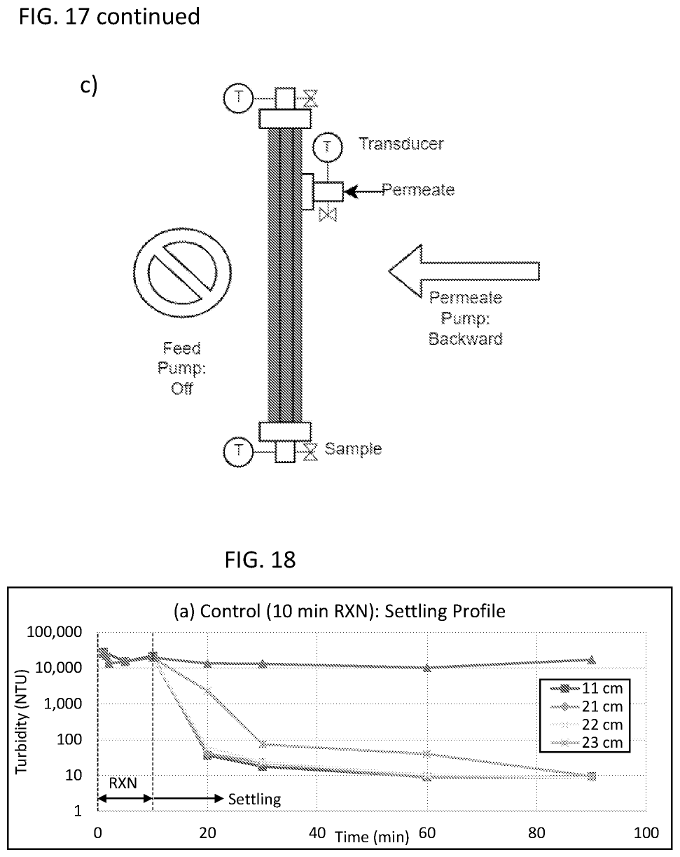

Once a CWF test determined that the specific flux surpassed a 20% reduction from the industry standard, a 50-minute physical cleaning would be conducted. Feed and permeate pumps were both used during this process, with the feed flow rate being 1700 mL/min and the permeate being 99 mL/min. DI water was used for physical cleaning, with the system operating under recycle batch operation. Before cleaning could occur, the module was reversed so that the permeate port would be at the top of the reactor allowing for improved backwashing. Feed and permeate flowrate directions were alternated to increase turbulence and dislodge any semi-fixed crystals in or around membrane pores. Forward direction for the feed pump describes DI traveling from the bottom of the module out from the top of the module, backward direction represents the opposite. Forward direction for the permeate pump describes DI being pulled from the permeate chamber and it being released into the container used for recycling DI. Backward direction for the permeate pump, otherwise known as backwashing, describes fresh DI being pulled from a separate container and into the permeate chamber, increasing the pressure and causing volume to pass through to the feed/concentrate chamber. FIG. 17 illustrates pump directions and flows based on forward or backward operations.

Physical cleaning was performed for 50 minutes. For the first 10 minutes of cleaning, feed and permeate pumps were run in the forward direction. The next 10-minute interval reversed the flow rate of the feed pump, keeping the permeate pump in the forward direction. Once that interval ended, the feed pump was turned off to allow for backwashing. The permeate pump was reversed, backwashing the membrane for 5 minutes. Afterward, the feed pump was turned back on and operated backwards and the permeate was switched to forward direction for a 10-minute interval. Backwashing was performed once again, turning off the feed pump for 5-minutes. The last cycle lasted for 10 minutes with both the permeate and feed pump flowrates going in the forward direction.

### Membrane Regeneration

Chemical cleaning was conducted using 1% citric acid instead of pure DI. It followed the same 50-minute procedure that was previously described under physical cleaning. The main difference was that at the end of the chemical cleaning cycle, the membrane was drained and rinsed with DI for 20 minutes. A clean water flux test result would determine how many cleaning procedures would be conducted. Table 9 provides a short summary of the general pump directions for both physical and chemical cleaning.

TABLE 9
Feed and permeate pump directions for both physical and
chemical cleaning with their respective allotted times.

| Time Duration | Feed Pump | Permeate Pump |
|---|---|---|
| (min) | (1700 mL/min) | (99 mL/min) |
| 10 | Forward | Forward |
| 10 | Backward | Forward |
| 5 | Off | Backward |
| 10 | Backward | Forward |
| 5 | Off | Backward |
| 10 | Forward | Forward |

### Results and Discussion

### Water Quality

The settling profile created from the control experiment, seen in FIG. 18 highlights the need for membrane assisted separation. Multiple factors can affect the settleability of MAP, parameters such as pH, molar concentrations, mixing intensity, seeding, and temperature can all impact the size and morphology of the crystals being produced. Under the specified conditions selected for MARS experiments, turbidity results of the control reached an equilibrium of approximately 9 NTU after 50 minutes of settling for distances of 11-, 21-, and 22 cm away from the top of the reactor. Typically, precipitation of fine MAP crystals (10 to 100 μm) is not desired due to the difficulty of recovering them from solution through sedimentation.

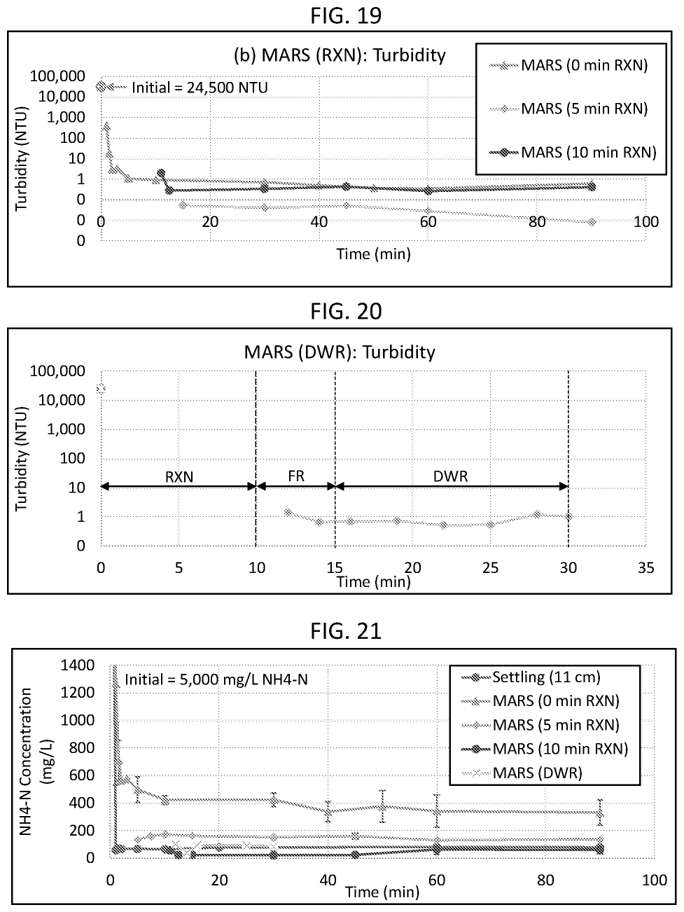

Using sedimentation as a separation method prevents the continuous production of solids and recovery of low turbidity effluent. MARS experiments sought to eliminate the dependance on crystal size optimization, and instead utilize membrane assisted recovery for faster results. Turbidity was used to compare effluent quality of the control and various MARS (RXN) trials, which can be seen in FIG. 19. Turbidity of the control sampled 11 cm from the top of the reactor (1 cm below the air-to-water interphase) is shown to serve as a baseline of performance. All MARS (RXN) experiments were operated under a combination of varying reaction and filtrate recycling times. Results showed that regardless of reaction time, the UF membrane needed an acclimation period before producing effluent below 1 NTU turbidity. Similar to dynamic membrane operations for bioreactors (DMBR), MARS for MAP separation requires a period in which initial effluent is recycled back to the reactor. MARS (RXN) experiments collectively showed a need for minimum 2.5 minutes of effluent recycling before collection should begin.

Results from the first three experiments led to MARS (DWR) being operated with 10 minutes of reaction time and 5 minutes of filtrate recycling before collecting permeate and concentrating solids within the reactor. Results seen in FIG. 20 shows turbidity of this trial across all three stages: reaction, filtrate recycling, and dewatering. Turbidity during the reaction time is taken from the CSTR, since this phase does not include membrane separation. The second phase, filtrate recycling, significantly reduces the turbidity of the solution but does not collect permeate. Instead, it recycles what is produced back into the reactor to allow for a membrane stabilization period. Turbidity during the dewatering phase starts below 1 NTU and remains below 1 NTU until 27-minutes, 3-minutes shy of the last data point of 30-minutes. It is possible that the increase in solids loading due to the removal of volume caused the membrane to be overloaded, and possible breakthrough occurred. This trial showcased the effectiveness of membrane separation for volume recovery.

A molar ratio of 1:1.1:1.4 for NH:PO₄³⁻:Mg²⁺ was selected to remain consistent with previous work conducted in Example 2. Ion concentrations for all experiments were reported in FIG. 21. Initial concentrations for all studies started at 5,000 mg/L NH₄⁺—N, 12,162 mg/L PO₄³⁻—P, and 12,146 mg/L Mg²⁺. FIG. 21 shows that equilibrium for NH₄⁺ was reached by 1-minute for all experiments except MARS (0 min RXN). MARS (0 min RXN) had a lagging period which was not present in any other trial, highlighting the need for a reaction period prior to filtration.

It is possible that further NH₄⁺ removal could be achieved given that POR₄³⁻ is currently acting as the limiting reactant. Additionally, residual Mg²⁺ concentrations in the magnitude currently found in MARS (5 min RXN), MARS (10 min RXN), and MARS (DWR), could restrict the effluent's ability for reuse. Increasing the PO₄³⁻ molar ratio and decreasing the Mg²⁺ molar ratio could improve both situations.

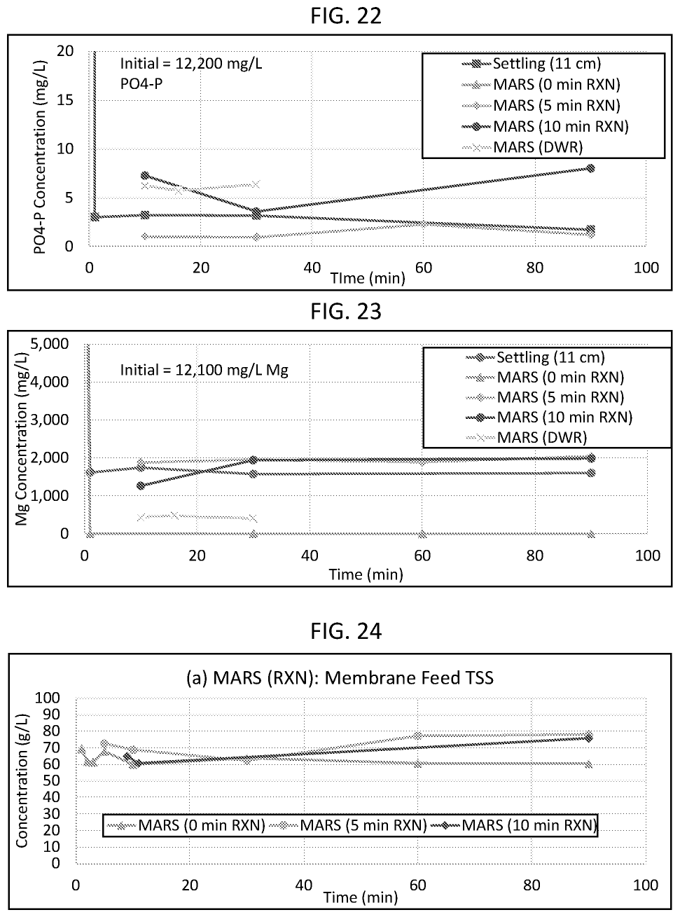

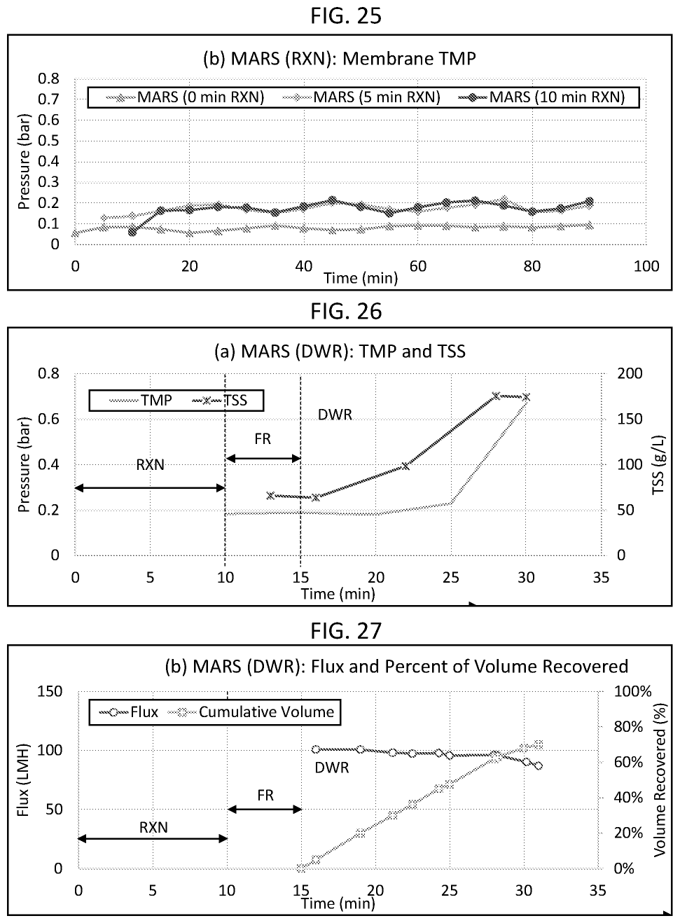

FIGS. 22-25 show the results from magnesium and phosphate residual ions. Table 10 summarizes all final percent removals for each ion and experiment. Most experiments showed that both NH₄⁺ and PO₄³⁻ were effectively removed, with PO₄³⁻ acting as the limiting ion. An experiment that showed different results was MARS (0 min RXN), where Mg²⁺ acted as the limiting reactant. It is possible that this could have been a result of an inaccurate initial concentration of the Mg Dosing solution.

In general, a careful balance of Mg²⁺ addition is desirable. This study showed that NH₄⁺ removal increased as Mg²⁺ addition was increased, but it came at the cost of larger Mg²⁺ residual. Determining an appropriate molar ratio would need to be done on a per case basis since waste streams can drastically differ. Further optimization of the molar ratio and for the specific composition of the regenerant waste solution can be done to avoid high residual concentration of ions.

TABLE 10
Summary of final percent removal for all five MARS experiments.

| | Final % | Final % | Final % |
|---|---|---|---|
| | Removal | Removal | Removal |
| Experiments | [NH₄⁺—N] | [PO₄³⁻—P] | [Mg²⁺] |
| Control | 98 ± 0.4% | 100 ± 0.0% | 85 ± 0.5% |
| MARS (0 min RXN) | 93 ± 1.9% | 89 ± 1.0% | 100 ± 0.1% |
| MARS (5 min RXN) | 97 ± 0.0% | 100 ± 0.0% | 82 ± 0.6% |
| MARS (10 min RXN) | 99 ± 0.3% | 100 ± 0.0% | 83 ± 0.4% |
| MARS (DWR) | 98 ± 0.1% | 100 ± 0.0% | 96 ± 0.0% |

### Membrane Performance

MARS (RXN) experiments had relatively stable membrane TMP and solids production for the 90-minute operational time. The system was operated at 100 LMH flux and a crossflow velocity of 0.19 m/s. FIG. 24 shows the total suspended solids collected from either the reactor or the feed port depending on the stage at which the sample was taken. Solid concentrations instantaneously started around 60 g/L once all three reagents were mixed for the control and MARS (RXN) experiments alike. There was an overall increase in solids, with the final concentration ranging between 70-80 g/L TSS. MARS (0 min RXN) produced less MAP by the end of the experiment, 60 g/L TSS compared to an average of 77 g/L TSS between the other two MARS (RXN) tests. Mg²⁺ limitation, as previously discussed, is likely the cause of the lower yield. Data regarding ion concentrations showed that equilibrium was reached within the first minute of reaction for the experiments that were not Mg²⁺ limited, therefore it can be concluded that the increase in solids is a result of crystal growth and not of additional precipitation. Results obtained show an increase in reaction time leads to an increase in crystal growth.

TMP remained below 0.25 bar for all three iterations of MARS (RXN). MARS (5 min RXN) and MARS (10 min RXN) followed a similar pattern, where TMP fluctuated between an approximate range of 0.15 to 0.25 bar. MARS (0 min RXN) had a lower TMP due to a malfunction in the feed transducer. Instead of taking the average pressure between the feed and the concentrate, only the concentrate pressure was used to calculate the TMP. Elongate fluctuations in TMP can be explained by the peristaltic pumps oscillation since it follows a semi-consistent pattern. Over longer periods of time, such as the 6-day preliminary study conducted in the previous Example, this fluctuation becomes less apparent. This is due to averaging being done over a longer timeframe which results in a figure with less oscillation. MARS developed in this Example has the capability of achieving higher quality effluent over previously studied methods, since UF has a smaller pore size than MF, at a much lower TMP, which can improve NH₄⁺ management through MAP precipitation and recovery in a decentralized context.

For the final MARS iteration, MARS (DWR), a dewatering stage was included to analyze its effects on membrane performance and implications of a continuous mode. A reaction time of 10 minutes and a recycling time of 5 minutes were selected from previous experiments to optimize ion concentration removal and turbidity present in the effluent. Dewatering was performed until water level in the CSTR dropped to a location of 26 cm from the top of the reactor, marking an approximate volume reduction factor (VRF) of 3 (initial volume over final volume). A notable drop in permeate flowrate, from the original 99 mL/min to 86.4 mL/min, brought the experiment to a halt. It resulted in a VRF that is comparable with other high functioning dewatering membrane systems such as forward osmosis, achieving VRF's between 3-151 for algae dewatering. Although a direct comparison may not be appropriate considering that algae dewatering faces biological membrane fouling, whereas MARS faces inorganic scaling fouling. All types of fouling will result in decreased filterability, but the difference lies in the way in which it occurs. Biological fouling would create a thin biofilm on the membrane, whereas scaling and inorganic fouling collect on the membrane or get lodged in its pores.

At the start of the dewatering experiment, TMP remained within a range of 0.10 to 0.30 bar. FIG. 26 illustrates both TMP pressure and membrane feed TSS for MARS (DWR). TSS samples between 0 to 10 minutes were obtained directly from the CSTR and show comparable values to both the control and MARS (10 min RXN). A slight increase in solids was observed once again when the membrane loop was turned on and operated for 5 minutes under filtrate recycling. An exponential change in TMP signified that fouling occurred and it is likely that the increase in solids loading was responsible. The final value of TMP was 0.80 bar before the system was turned off. By the end of the experiment, the initial TSS concentration of 60 g/L was increased by a concentration factor of 2.7, equaling to approximately 175 g/L TSS. It is worth noting that concentration factor is independent of the recovery rate of the solids in the system. Concentration factor simply reports the growth ratio between the initial and final concentration of solids, recovery rate then depends on the harvesting method selected. It is possible to achieve 100% recovery, but it is often not necessary since there are benefits to having seeding material remain in the reactor for crystallization purposes.

The percent of recovered volume is plotted alongside membrane flux in FIG. 27. A trend can be noted, as the volume increases the flux begins to slowly decrease. Highlighting the strain that the membrane is placed under as the solids begin to increase due to volume collection. A total of 70% (1,400 mL) of the original volume (2,175 mL) was collected over the course of 16 minutes of dewatering. Flux was maintained at nearly 100 LMH for a significant part of the dewatering process. Once dewatering reached 68% of permeate recovery, flux decreased from 96.7 LMH to 90.3 LMH, marking the beginning of significant fouling. Thus, 90.3 LMH is considered to be the threshold flux, having occurred 15 minutes into the dewatering stage. In contrast to critical flux, the boundary between no fouling and fouling, a threshold flux describes the transition point between fouling and considerable fouling. The system was operated for an additional minute, ending with 16 minutes of dewatering. This resulted in a 13% flux reduction from the original 100 LMH value. At the final volume recovered of 1,400 mL, flux was recorded to be 87.1 LMH.

### Membrane Regeneration

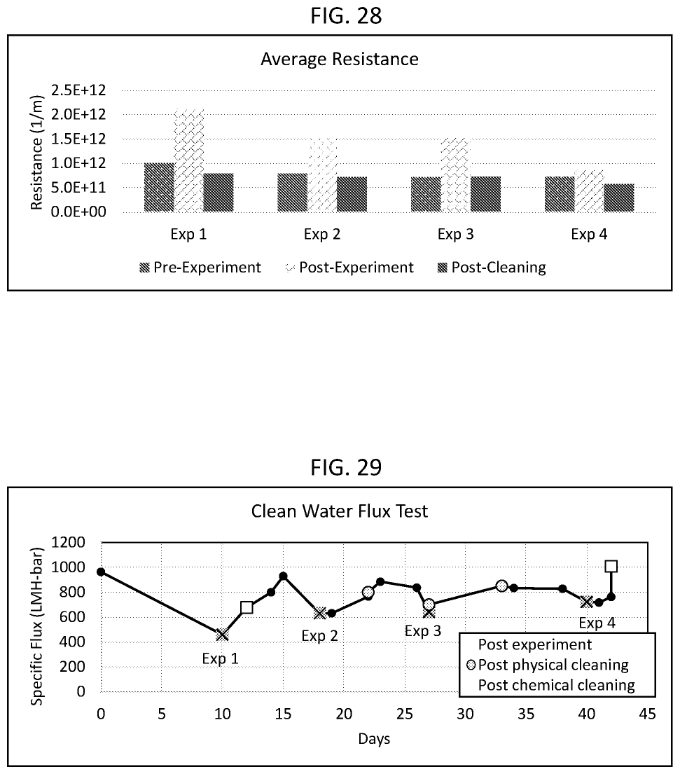

Over time, it is possible that a membrane module may decrease in yield and efficiency once the membrane filters becomes fouled. Pressure and crossflow velocity are parameters that may prevent solid deposits from building on and fouling the membrane. Membrane resistance was calculated by dividing TMP by the product of the viscosity of water and flux, where all parameters were adjusted for temperature dependance. Specific flux, which was calculated by dividing the flux over the transmembrane pressure, was used to determine if appropriate restoration was conducted. Results from these calculations can be seen in FIG. 28.

In other embodiments, membrane resistance can be determined in other ways. For example, membrane resistance can be determined using calculations related to the intrinsic membrane resistance, cake layer resistance, and fouling resistance.

In the case of MARS analysis, average resistance was calculated for pre-experiment, post-experiment, and post-cleaning conditions. Results from the resistance data can confirm that experiments increase overall membrane resistance, and a combination of physical and chemical cleaning was reduce it back to an improved state. In addition to resistance, the specific flux was also recorded and reported in FIG. 29. Industry standard maintains that a new membrane has a specific flux of 1000 LMH-bar. Before and after each trial, a clean water flux test was used to determine the health of the membrane and whether it was regenerated. The membrane would be considered regenerated if its specific flux had less than a 20% reduction from the industry standard. Findings from these various cleaning strategies can confirm that a tubular UF membrane can indeed be regenerated and used for multiple operations. These results can add confidence that the pairing of a crystallization reactor and UF membrane could work sustainably for a community that does not have access to centralized wastewater treatment.

### Conclusion

Results of these batch studies illustrate a path forward for low impact MAP separation technology that could be applied for decentralized wastewater treatment. MARS technology, the pairing of a crystallization reactor and a tubular ultrafiltration membrane module, achieved drastic 98% removal of NH₄⁺ and a 75.6% recovery of low turbidity effluent at the point it experienced fouling. Ions were recovered in the form of a solid and were effectively separated from the bulk liquid at a low operating pressure of less than 0.25 bar at an average flux of 100 LMH. Once liquid was removed from the system during a dewatering trial, a threshold flux of 90 LMH was reached when TSS concentration increased over 150 mg/L. Key takeaways are listed below:
Settling profile of a control MAP precipitation experiment highlighted the need for membrane assisted separation (MARS).
MARS will need to provide sufficient reaction time prior to filtration to best avoid crystallization on the permeate side.
High quality permeate can be recovered through MARS, but solids accumulation within reactor will need to be monitored to avoid rapid fouling.
Tubular UF membranes are a valid and sustainable option for decentralized wastewater treatment, as they can be regenerated once fouled.

Once fully functional, MARS could help alleviate communities that are troubled with nutrient management in a decentralized context with an efficient, compact, and sustainable solution.

### Example 4

In some cases, crystallization reactors can be advantageously paired with settling tanks to separate and collect solids via sedimentation. This process can take a long time depending on the amount of fines (below 100 μm) produced. Thus, significant focus may be had on creating larger crystals, a process that then requires longer mixing time and sometimes the addition of seeding material.

To test and develop a continuous MARS system, a total of three studies were conducted. The studies included variations in feed solution composition and hydraulic loading. Two feed sources were tested, the first will be referred to as “N/P Feed” and the second as “NaCl Feed”. Both solutions include the same concentrations of ammonium chloride (NH₄Cl) and disodium phosphate (HNa₂PO₄) expressed in Example 1: Synthetic Solutions, with the only difference being the inclusion of 60 g/L of NaCl in the NaCl feed. The addition of NaCl was done to better simulate the ion exchange (IE) material regenerant solution. Their work highlighted the need for treatment of a large volume of wastewater produced from maintenance on their decentralized wastewater treatment system (DWTS), the NEWgenerator™ This waste stream was selected for the initial development of MARS since it is fairly simple, unlike urine and landfill leachate. To precipitate MAP solids from the synthetic source, two additional solutions were used: Mg dosing and pH Buffer. Mg Dosing was made using magnesium sulfate (MgSO₄) and pH Buffer was made using sodium hydroxide (NaOH). Both solutions compositions are described in Example 1.

The first MARS trial utilized N/P Feed and operated under a hydraulic loading of 99 mL/min, and was considered a high loading experiment (HL). The second trial used the same loading rate of 99 mL/min but instead used NaCl Feed. The third trial tested the MARS continuous system under 25 mL/min hydraulic loading utilizing N/P Feed as the main source, and it was considered the low loading (LL) trial. Continuous mode was achieved through continuous feed into the reactor, but in order to maintain a water level between 2.25 and 2.50 L within the reactor the permeate pump had to be intermittently turned off. This resulted in an intermittent flux for the membrane operation.

All trials were be analyzed for permeate water quality, membrane performance, and solids recovered. Permeate water quality analysis would include the tracking of residual ions found in the permeate, as well as turbidity, conductivity, pH, and temperature. Membrane performance would be evaluated by the transmembrane pressure (TMP) experienced by the module and the permeate flux. The two parameters were be analyzed in the context of total suspended solids (TSS) that is fed to the membrane and the cumulative volume collected. Lastly, the harvesting of solids was also be reported as it is important for accumulation of solids to remain minimal to avoid overloading the membrane. Solids collected from the LL trial was be examined under X-ray diffraction (XRD), scanning electron microscopy (SEM), and X-ray fluorescence (XRF) spectroscopy to confirm the production of MAP. All aspects of analysis will serve to better understand the benefits and limitations of the current design of MARS operated continuously. Accordingly, MARS could serve as a solution to various sources that are highly concentrated with nutrients.

### MARS Configuration

MARS operated in continuous mode underwent some changes from the first iteration presented in Example 3 which studied MARS operated in batch mode. Instead of pairing a flask with the UF membrane module, continuous mode replaced the flask with a glass column. The UF membrane module used for continuous MARS was the same one used in previous MARS experiments, a detailed description of which can be found in Example 1. Plastic tubing connecting the UF membrane and the FBR reactor were designed to allow for different operational strategies. Peristaltic pumps were used to create flow, and ball valves and tubing clamps were used to direct it. Sampling ports were included throughout the build for multiple data collection points. Data on the pressure experienced by the UF membrane was recorded using three pressure transducers located at the influent, permeate, and concentrate of the membrane module. Both pressure and temperature data were logged using a HOBO data logger. A pH controller (MC122 Pro pH Controller, Milwaukee Instruments, NC, USA) was used to monitor and adjust the pH within the reactor.

### Column Reactor (FBR)

A three-piece glass column reactor was assembled and operated as a fluidized bed reactor (FBR). The three pieces were prefabricated, with two of the pieces including ports that protruded outward. In total, the working volume of the reactor was 2.50. Vertically placed, the reactor had the longest piece at the top, and the shortest piece at the bottom. The longest piece housed the fluidized zone as well as the disengagement zone. Fluidization zone describes the section in which solids are suspended by the up flow of either gas or liquid. Disengagement zone occurs above the fluidization zone, and it describes the section where solids and liquid are separated by gravity. Accumulation of solids occurred at the bottom of the reactor, where heavier particles settle at the base. The last port of the reactor was located at the very bottom, and it served as the harvesting point for solids. The middle piece of the glass reactor acted as connection between the other two pieces and offered extra storage for accumulated solids.

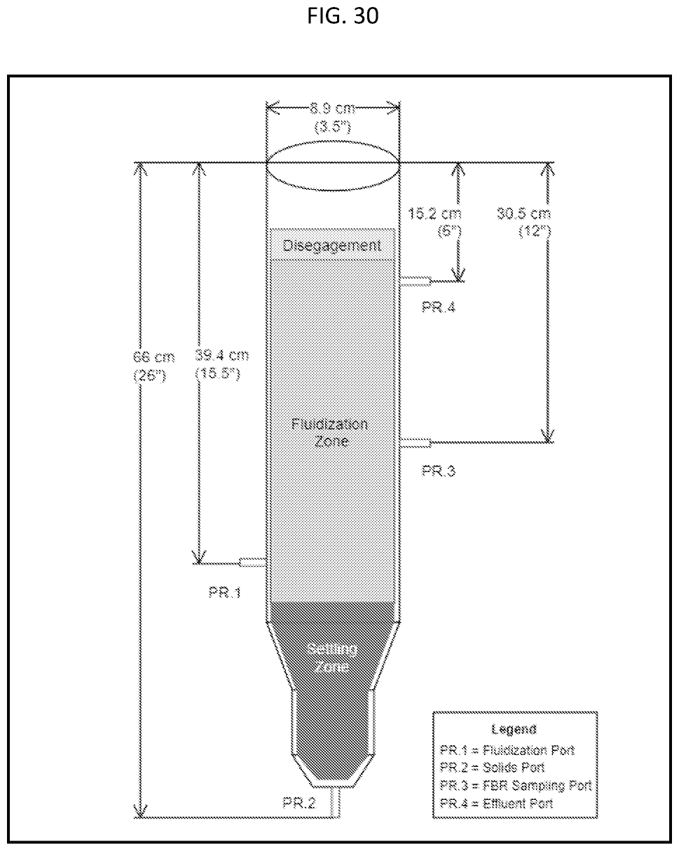

Each reactor port was used for a specific task. A schematic of the FBR shown in FIG. 30 highlights the different zones within the FBR and the location and naming convention for each port: fluidization port, sampling port, effluent port, and solids port. Fluidization port (PR.1) was the point of entry for either liquid or air into the reactor to mix and fluidize precipitates. FBR Sampling port (PR.3) was used to collect samples of the fluidized zone within the reactor. Collecting a representative sample from the sampling port would require at least two pumps of air via a syringe to dislodge any settled solids. Effluent port (PR.4) served as the fluids exit point near the top of the reactor. The solids port (PR.2), located at the bottom of the reactor, was used for solids removal. Each port, other than the sampling port (PR.3), was connected through tubing to the overall MARS system.

### Influent and Effluent Lines

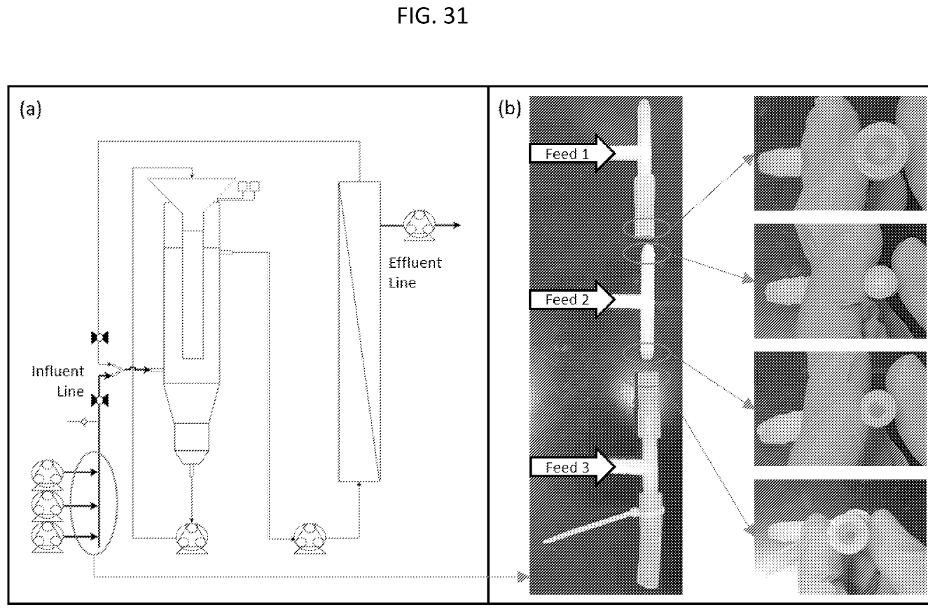

Continuous mode required influent and effluent lines to be included for a flow-through MARS system. Influent lines were originally designed to merge three flows together and enter the reactor through a single inlet. The three streams were individually pumped out of their respective containers and combined into a single tubing, entering the reactor through the fluidization port (PR.1), as shown in FIG. 31 In some cases, it can be advantageous to have influent lines combine their respective flows close to the inlet of the reactor, as may reduce the possibility of crystallization occurring within the merged tubing.

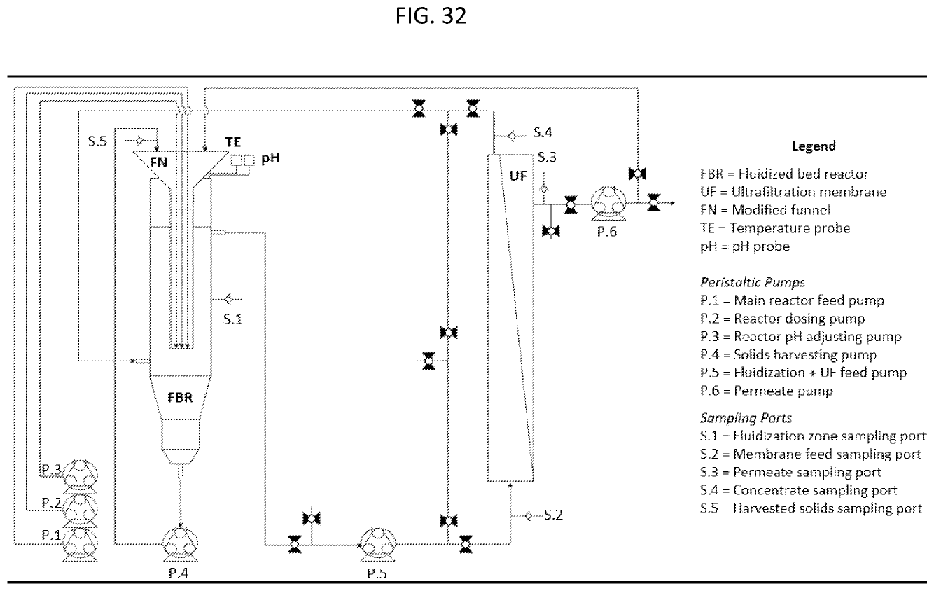

In other embodiments, as shown in FIG. 32, to prevent precipitation from occurring prior to the reactor, the three feeds were instead introduced at the top of the FBR, were the lines were placed inside a custom-built extended funnel that would release the feeds near the fluidization port (PR.1).

Effluent of MARS did not experience any design changes and was always collected from the permeate line of the UF membrane module. FIG. 32 shows a schematic of continuous MARS, demonstrating the final influent and effluent lines. five peristaltic pumps controlled the feeding and removal of solution into and out of MARS. Three out of the five served as feed pumps for solutions required to precipitate MAP. The remaining two served as removal pumps, where one was used for membrane permeation and the other for solids harvesting. A sixth pump was also used in the MARS scheme, with its purpose being fluidization of the FBR. The five sampling ports are also highlighted in FIG. 32, as well as the pH and temperature probe used to monitor and collect data.

Continuous operation was achieved from a continuous loading standpoint. Continuous permeation was not sought in this experiment during continuous operation due to competing pump flows, which could result in volume changes within the reactor. To maintain a water level between 2.50 to 2.25 L within the FBR, the permeate pump was turned on and off accordingly. For these studies, the water level control was conducted by hand. However, in other embodiments, continuous permeation is possible.

### Process Loops

The operation of the FBR and the UF membrane module was done through multiple constructed loops. Connections made between the two technologies allowed for different strategies to be performed. As mentioned before, peristaltic pumps were used to supply flow rates and ball valves and tubing clamps to control the direction of the flow. A total of four connection loops were developed for this version of MARS, each of which are described below:
Mixing Loop (MXL)—Established previously, an initial reaction period without filtration creates favorable results for NH removal and MAP precipitation. The mixing loop was developed to introduce flow directly to the reactor, bypassing the membrane module. Volume taken from the effluent port at the top of the reactor is then pumped into the fluidization port to generate mixing by the membrane feed pump (P.5). MXL was only operated as a batch.
Filtrate Recycling Loop (FRL)—Acclimation of the membrane at the start of filtration created the need for a FRL. Using the membrane feed pump (P.5) and the membrane permeate pump (p.6), both the concentrate and permeate are recirculated back to the FBR. Fluidization of the reactor and feeding of the UF module are achieved through the membrane feed pump (P.5). Volume from the top of reactor is pulled by the membrane feed pump (P.5) and fed into the entry point of the membrane. Concentrate of the membrane is then returned to the fluidization port of the reactor to induce mixing. Permeate is simultaneously being produced and recycled back into the reactor. FRL was only operated as a batch.
Harvesting Solids Loop (HSL)—To prevent solid accumulation due to continuous feeding, a HSL loop was developed. The loop begins at the bottom of the reactor and ends at the top. A peristaltic pump is used at a designated flow rate to steadily remove accumulating solids. Solids are discharged at the top where a 200 μm felt filter bag is placed on the custom-built extended funnel. The slurry is slowly trickled into the filter bag, where gravity separates the solids from the remaining liquid. Liquid is then reintroduced to the FBR via the extended funnel which discharges near the fluidization port (PR.1). The filter may require periodic replacement depending on the amount of solids precipitated and the flow rate at which the solids pump (P.4) was operated.
Membrane Cleaning Loop (MCL)—Procedures such as membrane cleaning and clean water flux (CWF) tests created the need for a loop that bypassed the FBR. The MCL would not utilize the FBR in any capacity, and instead would use an external flask as its source of either deionized (DI) water or cleaning reagent. The effluent port (PR.4) from the FBR would be closed, and a separate line would be opened to allow for the pulling of solution by the membrane feed pump (P.5). The fluidization port (PR. 1) can also be closed, and the concentrate from the membrane would instead be routed to the external flask. The permeate pump (P.6) may or may not be in use depending on the procedure being conducted. Cleaning may require the operation of P.6, but if a CWF test was conducted the pump could be bypassed, for example, by a tubing clamp.

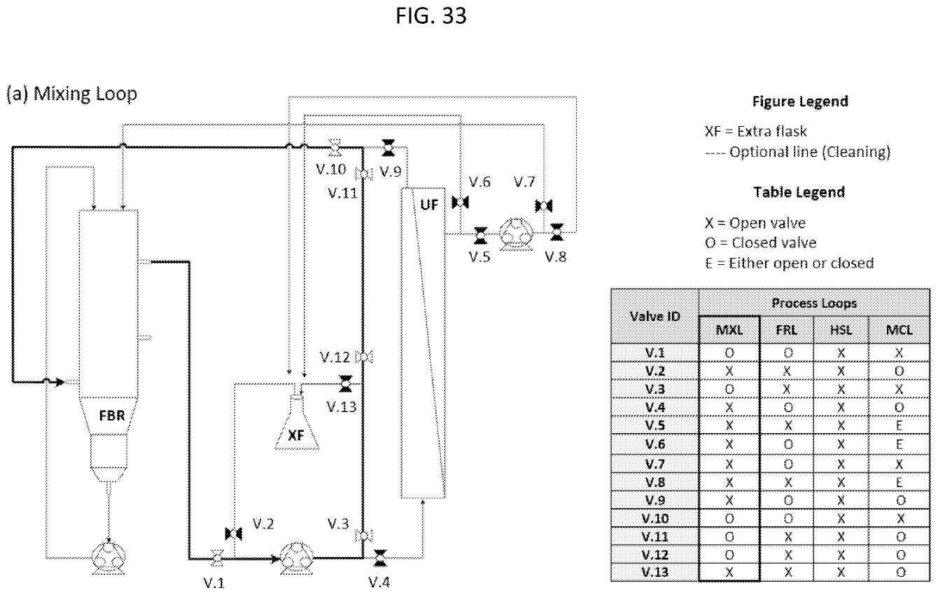

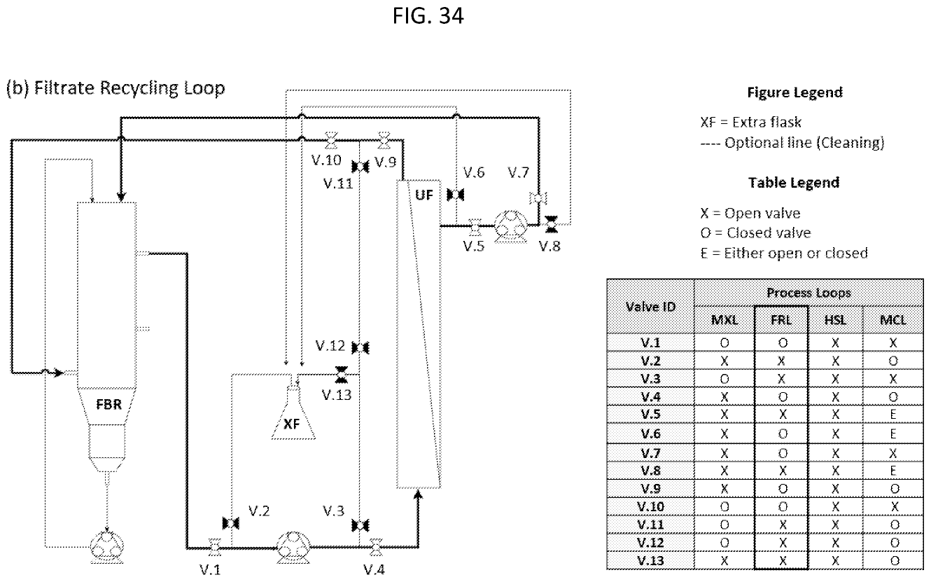

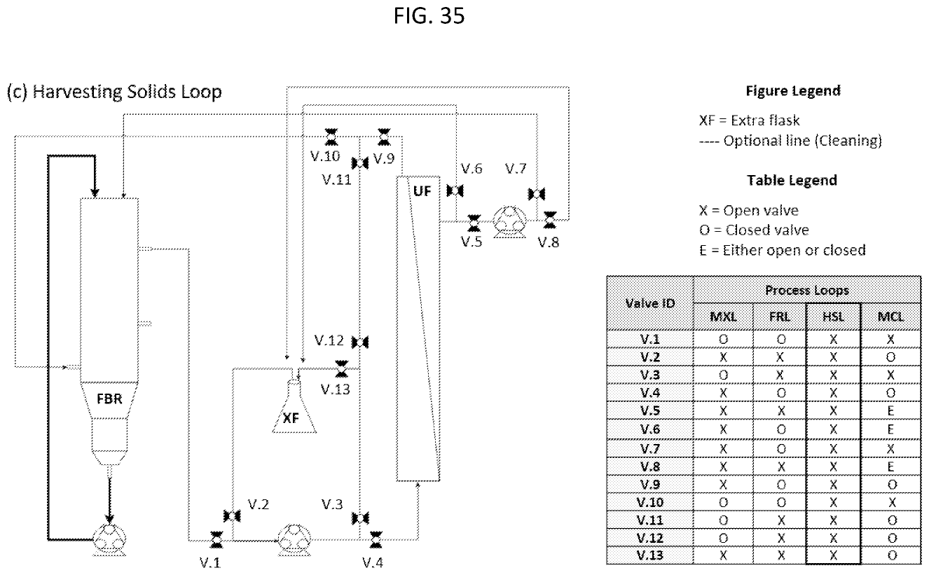

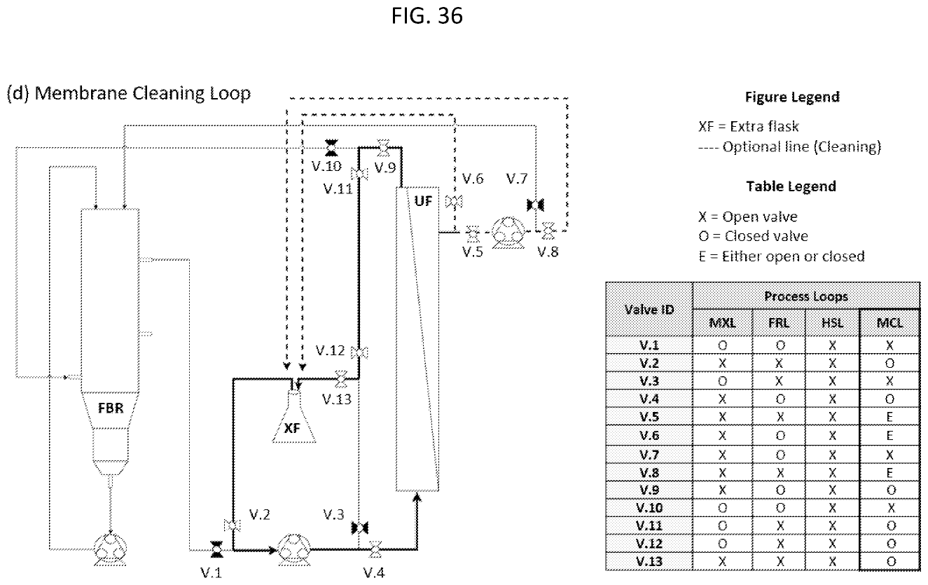

Connection loops were operated under different stages depending on the task needing to be completed. Some loops, such as the HSL, had the capability of operating at the same time as other loops since it did not share a peristaltic pump. FIG. 33-34 highlights two operational loops, (a) mixing and (b) filtrate and recycling. FIG. 35-36 shows two additional loops, (a) harvesting and (b) membrane cleaning. A table accompanies each drawing, serving to inform whether a valve/clamp is either open or closed during the loops operation.

### Experimental Procedure

Continuous feed MAP precipitation experiments were conducted using an FBR, a UF membrane module, multiple peristaltic pumps, a pH controller, and an extended funnel to collect solids in a felt filter. All studies followed a similar operating procedure. The main difference in each trial was either the initial feed solution or the hydraulic loading rate during the continuous stage. The naming convention are as follows: MARS high loading (HL), MARS high loading with NaCl (HL-NaCl), and MARS low loading (LL). Each trail was sampled, permeate was collected, and membrane data was recorded. The set point for pH within the reactor was set to 8.5, with the target goal being a pH of 9. Temperature data was recorded throughout, but not adjusted since it remained below the specified 55° C. that affects MAP solubility. Table 11 summarizes the differences between each test performed. All tests conducted MAP precipitation under a molar ratio of 1:1.1:1.4 for NH₄⁺:PO₄³⁻:Mg²⁺. Specifications on the solutions that were used, and their starting concentrations can be found in Example 1.

TABLE 11
Summary of changes between each experiment.

| | Experiments | | | | | |
|---|---|---|---|---|---|---|
| Experimental | MARS | | MARS | | MARS | |
| Conditions | (HL) | | (HL - NaCl) | | (LL) | |
| NaCl Concentration | 0 | g/L | 60 | g/L | 0 | g/L |
| Hydraulic Loading | 99-91 | mL/min | 99-91 | mL/min | 25-23 | mL/min |
| Intermittent Flux | 100 | LMH | 100 | LMH | 25 | LMH |
| HRT | 25-27 | min | 25-27 | min | 100-109 | min |
| Feed Pump, Q_{P.1} | 73 | mL/min | 73 | mL/min | 18 | mL/min |
| Dosing Pump, Q_{P.2} | 18 | mL/min | 18 | mL/min | 5 | mL/min |
| pH Pump, Q_{P.3} | 8 | mL/min | 8 | mL/min | 2 | mL/min |

It is worth noting that the hydraulic loading and the hydraulic retention time (HRT) are both listed as a range instead of a set value. This is due to the pH controller turning on and off the pH pump depending on the pH within the reactor. This resulted in a varied dosing that would oscillate between the minimum and maximum values shown in Table 11 for loading and HRT. To account for the changes in volume, the permeate pump would need to be turned off as well to allow for the influent to fill the reactor between 2.25 and 2.5 L. Thus, resulting in an intermittent flux. The water level would be assessed visually and the permeate pump would be turned off and on manually.

MARS in continuous mode was operated for the purposes of high NH₄⁺ removal and high production and recovery of MAP solids under three different stages: reaction (RXN), filtrate recycle (FR), and continuous (CTS). The first two stages, RXN and FR, were operated under a prescribed amount of time. Both are a part of the start-up protocol for MARS, so that it can treat wastewater continuously. CTS stage was conducted until fouling occurred, or until it was no longer feasible to continue the experiment. The HOBO data logger was turned on before each experiment to track and record pressure and temperature data. All stages were sampled and tested for ion concentration, turbidity, pH, conductivity, temperature, and membrane feed TSS. The main focus of each trail was to examine the performance of MARS in the continuous stage. Permeate flow rate was recorded during the FR and CTS stages to track the intermittent flux of the experiment. The flux along with the pressure data collected were used to monitor and assess the health of the membrane. Each of the operating stages are described in detail below:

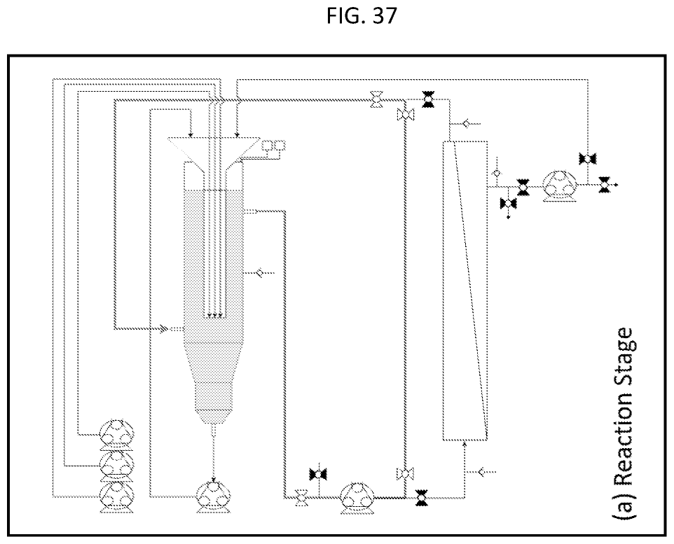

Reaction (RXN) Stage: The intention of this stage was to allow for ions to react and reach equilibrium before the membrane is used to filter solids. A volume of 1766 mL of the synthetic solution containing NH₄⁺, either N/P Feed or NaCl Feed, was added to the reactor. Using the MXL, mixing was induced by the membrane feed pump (P.5) pumping air into the reactor at a flowrate of 1700 mL/min. The other two solutions were then added in the order of Mg Dosing (441 mL) followed by pH Buffer (193 mL). The total volume of the initial batch start-up process was 2.40 L of combined solutions. Three samples were taken during this stage, at times 0-, 5-, 9-minutes. Time 0 was taken after a pH Buffer was added to the reactor and the stage continued for 10 minutes. Samples within this stage were processed for ion concentrations, turbidity, pH, conductivity, and TSS. FIG. 37 illustrates the RXN stage.

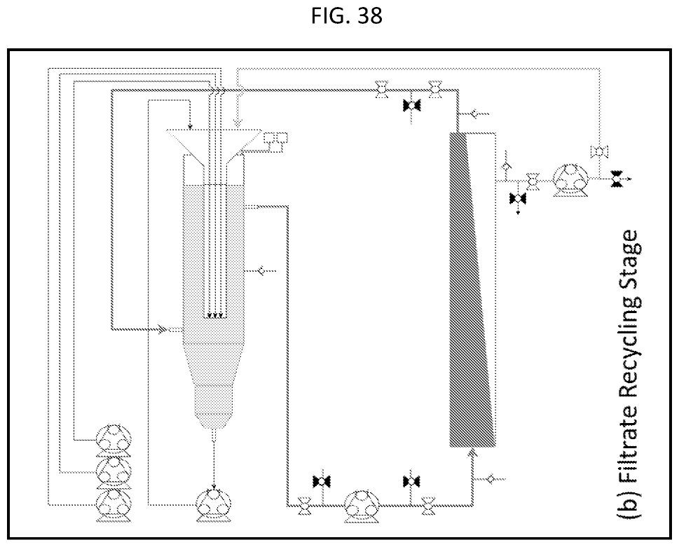

Filtrate Recycle (FR) Stage: An acclimation of the membrane was allowed to happen for a 5-minute time span during the FR stage. Transitioning into the FR stage required the halting of the MXL to adjust valves accordingly and then begin the next stage. Once operating under the FRL, the concentrate and permeate of the UF membrane were pumped back into the FBR. Four samples were taken during this stage, two of them from the permeate sampling port of the membrane and the other two from the feed sampling port of the membrane. Permeate samples were processed for ion concentrations, turbidity, pH, and conductivity. Samples taken from the membrane feed port were processed for TSS. Times in which the samples were taken were at the 11-, and 14-minute mark. FR was also acting as a batch mode operation in preparation for continuous treatment. FIG. 38 illustrates the FR stage.

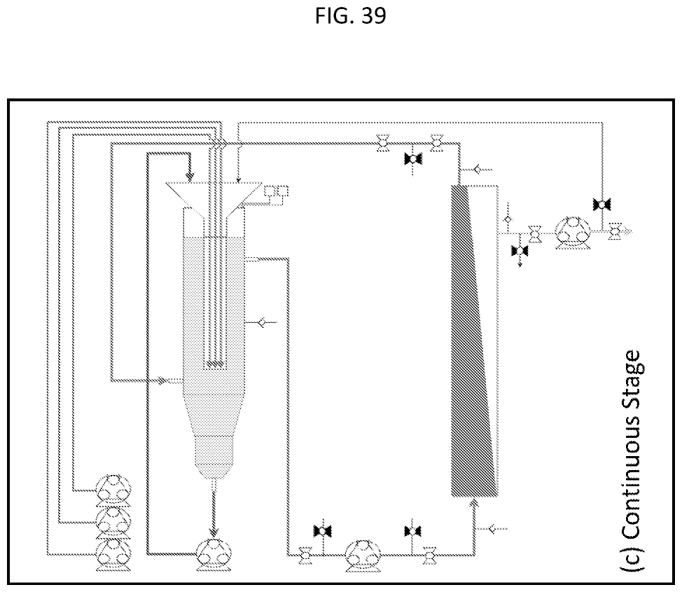

Continuous (CTS) Stage: Exiting the start-up phase of the experiment, influent and effluent lines become introduced in the CTS stage. This stage allows for flow-through treatment of wastewater without the limitations of periodic start-ups and clean-ups present in conventional batch operations. Feed pumps were turned on and hydraulic loading of the reactor began. Depending on the trail, the loading rate could have been set to 99 mL/min or 25 mL/min. Simultaneously, the HSL was also started to begin harvesting solids from the FRB. To collect the solids, a 200 μm felt filter was placed on top of the extended funnel to allow for the liquid from the slurry to return to the reactor. Filters had to be replaced once they reached maximum capacity. Continuous feeding was supplied until a noticeable drop in permeate flow rate was observed, which would then prompt the end for the experimental trial. Permeation was performed intermittently to sustain a water level between 2.25 to 2.50 L within the reactor. Permeate was collected in a graduated cylinder to record the amount of treated effluent being produced. Samples were taken from three different locations during the CTS stage: membrane permeate, membrane feed, and the solids harvesting line. FIG. 39 illustrates the CTS stage.

All three MARS experiments followed a similar strategy which consisted of 10 minutes in the RXN stage, 5 minutes in the FR stage, and an unregulated time in the CTS stage. Tests such as turbidity and TSS were analyzed immediately after the experiments ended. Everything else was processed within a days' time. Table 12 summarizes the time distribution spent in each stage for all MARS experiments.

TABLE 12
Summary of time distribution across
MARS continuous experiments.

| | Stage Time Distribution, min (hr) | | |
|---|---|---|---|
| Experiments | RXN | FR | CTS |
| MARS (HL) | 10 (0.17) | 5 (0.08) | 240 (4) |
| MARS (HL - NaCl) | 10 (0.17) | 5 (0.08) | 210 (3.5) |
| MARS (LL) | 10 (0.17) | 5 (0.08) | 600 (10) |

### Results and Discussion

### Permeate Water Quality

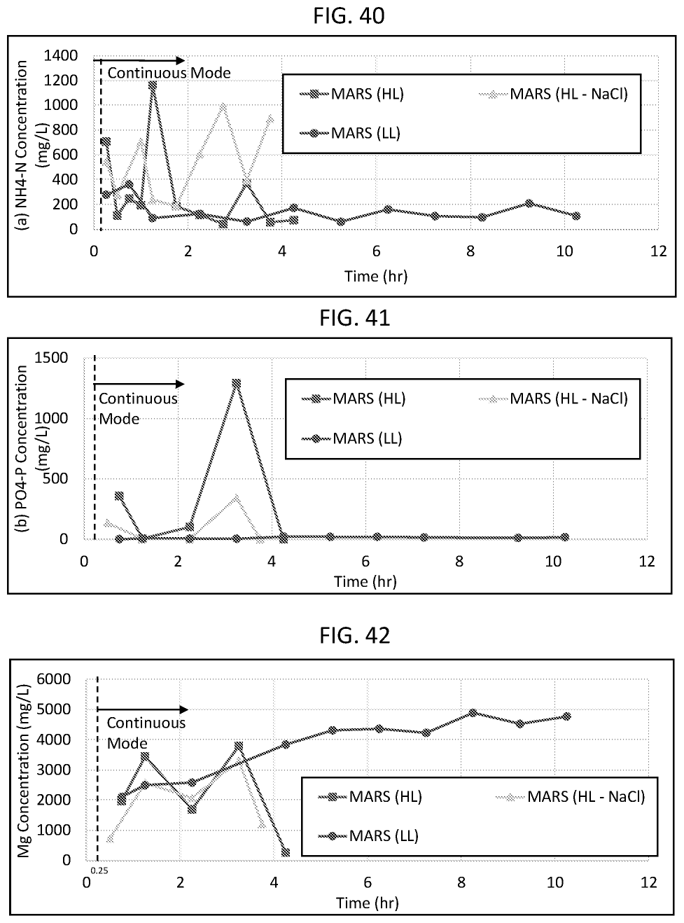

Plots of residual ion concentrations can be seen in FIG. 40-41 for NH₄⁺ and PO₄³⁻. Residual ion concentration for Mg²⁺ can be seen in FIG. 42. The starting concentration for each ion was 5,000 mg/L NH₄⁺—N, 12,160 mg/L PO₄—P, and 12,140 mg/L Mg²⁺, following a molar ratio of 1:1.1:1.4 (NH₄⁺: PO₄⁺: Mg²⁺). All experiments began at high concentrations and quickly dropped during the 15-minute (0.25 hour) start-up period, which contained both the RXN and FR stage. Since the focus was to analyze results during the CTS stage, the start-up phase data was not included in the plots. The comparison of residual ion concentrations is made between the three experiments, MARS (HL), MARS (HL-NaCl), and MARS (LL). It is notable that results from HL experiments, both MARS (HL) and MARS (HL-NaCl), have drastic changes in all three ions over time. Whereas the LL experiment, MARS (LL), is mostly stable throughout the 10 hours of continuous operation. This can indicate that there is a loading rate threshold which will result in more consistent removal and performance. Only two loading rates were tested within this study, leaving room for further optimization of the technology.

A distinction can be seen between the HL test that contained no NaCl versus the HL test that contained 60 g/L of NaCl. Nitrogen (N) removal appears to have been inhibited by the presence of sodium (Na⁺) ions. Concentrations of NH₄⁺, for MARS (HL-NaCl), fluctuate drastically and on average remains higher than the other two experiments. MARS (HL) also has high NH residual, with a max concentration of 1162 mg/L NH₄⁺—N after one hour of operating under the CTS stage. Aside from that peak, concentrations remain below 400 mg/L NH₄⁺—N, whereas the NaCl trial has an average residual concentration of 538 mg/L NH₄⁺—N. This trend indicates that major ions such as Na⁺ can inhibit induction time of MAP precipitation at certain concentrations. For example, in some cases, inhibition can occur at concentrations over 3 g/L of NaCl, which may be below the concentration present in the synthetic ion exchange material regenerant solution.

It is possible that, under further optimized conditions, such as reactor design, pH stabilization, and an adjusted molar ratio, could reduce the effects of Na⁺ so that an appropriate recovery can still be achieved. In some cases, a measurement of success could be the ISO 30500 non-sewered sanitation systems reuse guidelines, which require a 70% and 80% removal of total nitrogen and total phosphorus. A summary of the average percent removal per each experiment and ion can be seen in Table 13. On average, NH₄⁺ and PO₄³ are above an 80% removal.

TABLE 13
Summary of ion percent removal during the CTS stage.

| | MARS | MARS | MARS |
|---|---|---|---|
| Experiment | (HL) | (HL-NaCl) | (LL) |
| Total time in CTS | 4 hr | 3.5 hr | 10 hr |
| Stage | | | |
| Avegare Percent | 94 ± 7% | 89 ± 6% | 97 ± 2% |
| Removal of NH₄⁺—N | | | |
| Avegare Percent | 96 ± 7% | 99 ± 2% | 100 ± 0.1% |
| Removal of PO₄³⁻—P | | | |
| Avegare Percent | 81 ± 12% | 83 ± 9% | 69 ± 7% |
| Removal of Mg²⁺ | | | |

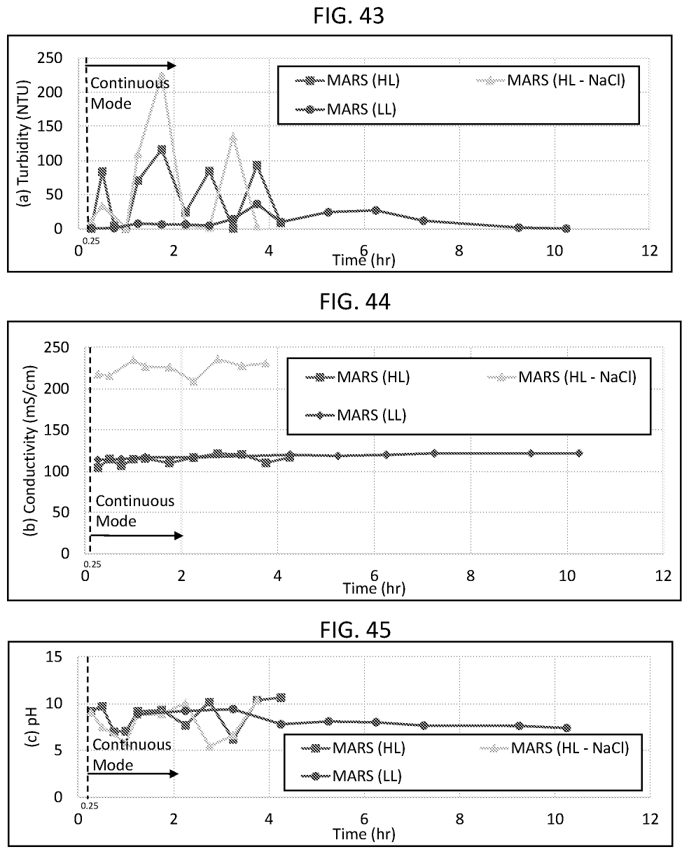

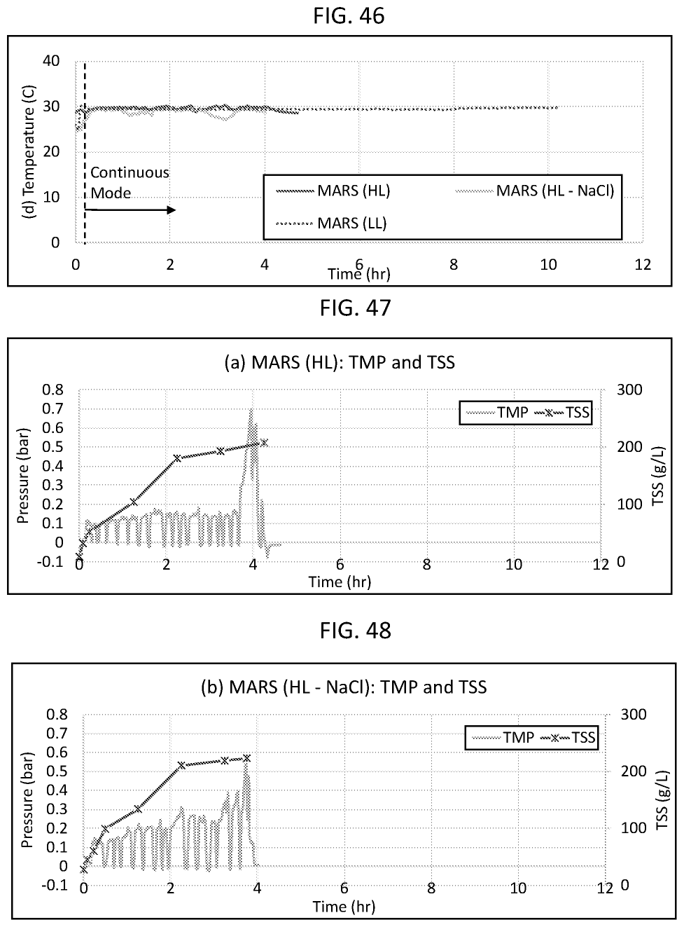

Other parameters of the permeate were also measured and reported such as, turbidity, conductivity, pH, and temperature. FIG. 43-46 contains all of the remaining data collected for the water quality of the permeate produced during the CTS stage.

Turbidity of the effluent was a noteworthy parameter, as one of the objectives of MARS is to separate solids and recover reusable permeate. MARS (HL-NaCL) seemed to underperform compared to MARS (HL), although both had erratic results. Within both of their operations, neither HL experiment was able to maintain stable effluent turbidity. LL performed more consistently, but still saw an increase in turbidity as it approached four hours of CTS operation. The drop in turbidity at the end of MARS (LL) occurred when solids within the reactor were visibly covering the effluent port (PR.4) of the FBR. This, alongside the ion concentration data, indicates ions are passing through the membrane and precipitation during the CTS stage. To overcome this result, a new reactor design would need to take place. Ideally, the new design would either be larger in size, or it would include baffles to ensure the hydraulic retention time of the influent and avoid any possible short circuiting. Ions passing through the membrane without enough time to react would explain the precipitation that is seen on the permeate side. Notably, turbidity values during batch experiments were consistently near or below 1 NTU. For the majority of continuous operation for all three trials, turbidity values remained above 9 NTU. It wasn't until accumulated solids formed a wall on the effluent port that permeate turbidity dropped below 1 NTU for MARS (LL).

Conductivity for both HL and LL experiments that contained no NaCl remained near 120 mS/cm throughout the length of their respective experimental times. Conductivity was high due to the large concentration of salts that were required to simulate the regenerant wastewater of a zeolite bed. The pH recorded from each sample is another indication that improper mixing is occurring within the FBR. MARS (LL) appeared to have steadier and more consistent results for pH when compared to MARS (HL) and MARS (HL-NaCl). Preliminary studies in Example 2 suggested that pH may not always be a major contributor to NH₄⁺ removal at high enough concentrations. Temperature for all three experiments started at room temperature (25° C.) and then immediately rose due to MAP formation being an exothermic reaction.

### Membrane Performance

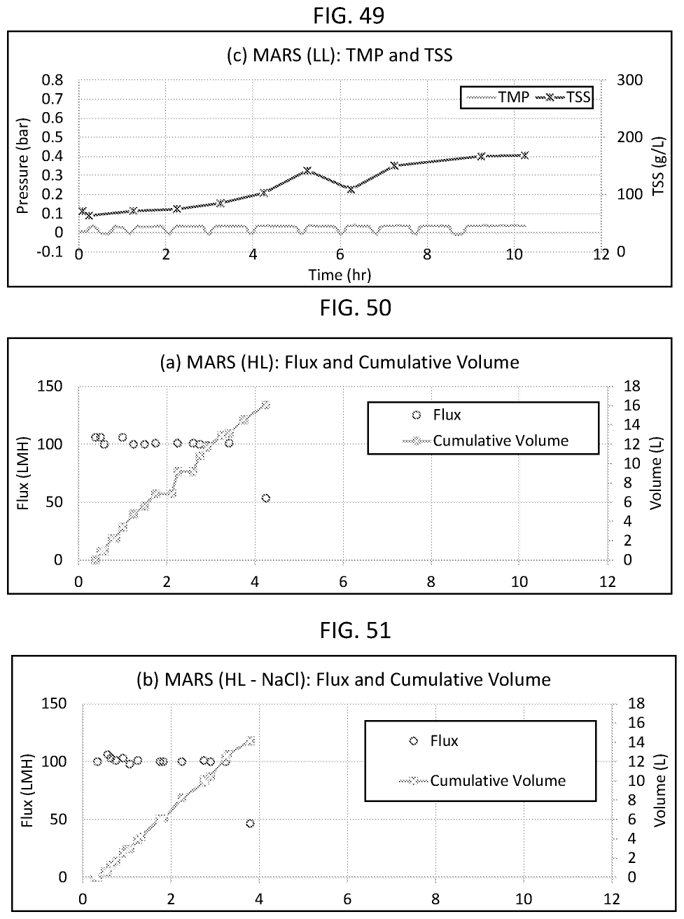

Graphs in FIGS. 47-49 illustrate the difference between HL and LL of the MARS continuous system. Recurring drops in TMP that can be observed as a reflection of intermittent permeation done to maintain a water level between 2.25 to 2.50 L within the FBR. Frequency at which the permeate pump (P.6) was shut off was dependent on the hydraulic loading of the experiment. On average, HL experiments stopped permeation approximately four times per hour where LL required it once per hour. The first two plots, part (a) and part (b), show the point of failure for both MARS (HL) and MARS (HL-NaCl) being at 4 and 3.5 hours respectively. TMP for MARS (HL) remained below 0.20 bar for nearly 3 hours and 40 minutes, before it rapidly increased to its maximum value of 0.70 bar. MARS (HL-NaCl) had a slight increase in TMP throughout its 3 hours of operation, starting at a near value of 0.1 TMP and ending near 0.4 TMP before quickly rising to its failure point of 0.57 bar. Alternatively, LL resulted in a consistent TMP of 0.04 bar for the experimental time of 10 hours.

Failure for both HL experiments is suggested to have been cause by the increase in solids fed to the membrane. As concentrations approached over 200 g/L of TSS, both HL experiments reached their respective points of failure. Solids in all trials were being harvested during the CTS stage, but there is a clear distinction between the efficiency of removal and accumulation prevention between HL and LL. Intermitted TMP for MARS (LL) remains steady as TSS fed to the membrane slowly increased. For comparison, membrane bioreactors (MBR) can be operated for days using PVDF UF membranes while experiencing 15 g/L of mixed liquor suspended solids (MLSS) at a lower operating flux. Although not a direct comparison, it highlights the achievement of MARS (LL) operating at concentrations over 50 g/L TSS without fouling. The results from this data indicate that solids management plays a major role in fouling and failure prevention.

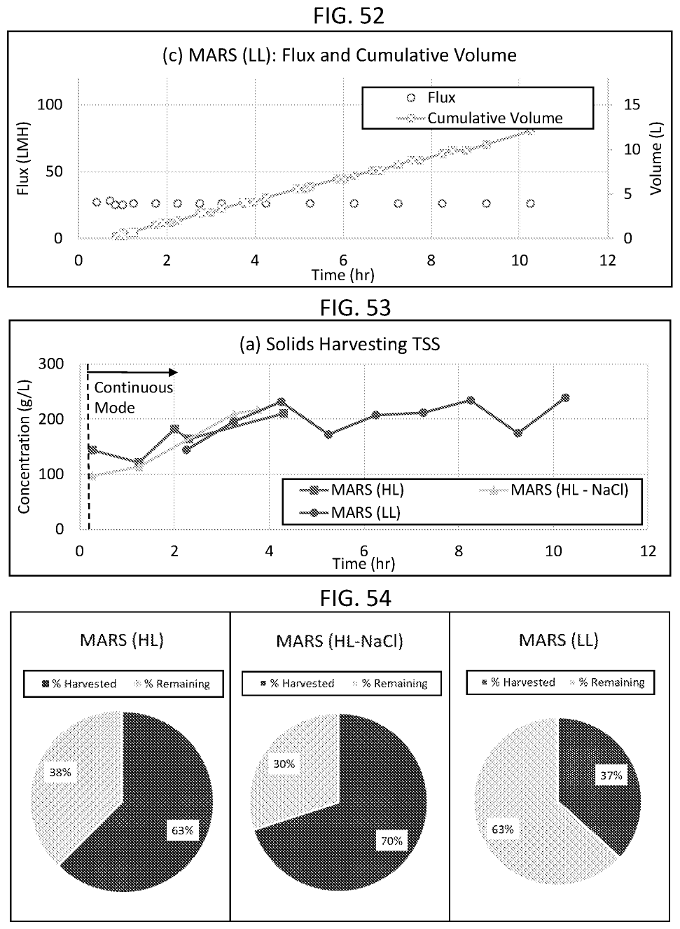

Flux for each trial was selected beforehand, where HL experiments were set to a 100 LMH flux and LL was set to 25 LMH. The value of 100 LMH was chosen as a high value flux based on work previously conducted by MBRs and other crystal separated membrane studies that used microfiltration (MF) and nanofiltration (NF). A quarter reduction in loading was selected to analyze the difference in membrane performance. Once CTS stage began, permeate was collected and measured from MARS. FIGS. 50-52 demonstrate the intermittent flux and cumulative volume collected for each experiment. Flux remained consistent for the majority of all three experiments. MARS (LL) experienced no change in flux during the 10 hours operation, indicating it did not reach failure inducing fouling. Whereas MARS (HL) and MARS (HL-NaCl) both experienced a radical drop in their respective flux of 47% and 54% which resulted in the conclusion of the experiments. On average, volume was collected at a rate of 4.0 L/hr for both HL tests and at 1.2 L/hr for LL. The total treated volume collected for each test was 16.1, 14.1, and 12.1 L for MARS (HL), MARS (HL-NaCl), and MARS (LL).

### Solids Recovered

Solids harvesting can help to maintain the performance of the membrane. Results from earlier data highlighted that as solids increased within the FBR, the faster failure inducing fouling would occur. Solid harvesting was done with felt filters at the top of the reactor which would recover solids from liquid via gravity. TSS concentrations of the HSL were recorded and presented in FIG. 53. All three trials reached a TSS of above 200 g/L accumulated at the bottom of the FBR. MARS (LL) was able to sustain its concentration over a 10-hour period with no indication of imminent reduction in flux or increase in TMP. Thus, highlighting the benefits of operating MARS at a lower hydraulic loading.

The dry mass of solids produced and recovered through the HSL are also reported in FIG. 54. Each experiment produced a total of 1.6, 1.9, and 1.1 kg of solids for MARS (HL), MARS (HL-NaCl), and MARS (LL) respectively. Less solids were recovered during operation of MARS (LL) due to the unchanged flowrate of 5 mL/min for the solids pump. The other two trials varied their flow between 5 to 17 mL/min due to the rapid (and visible) accumulation within the FBR. This change in harvesting explains why solids harvesting TSS for all three experiments are similar even though MARS (LL) had a lower hydraulic loading. Since less solids were recovered, more solids were left behind in the reactor resulting in a comparable TSS to that of MARS (HL) and MARS (HL-NaCl).

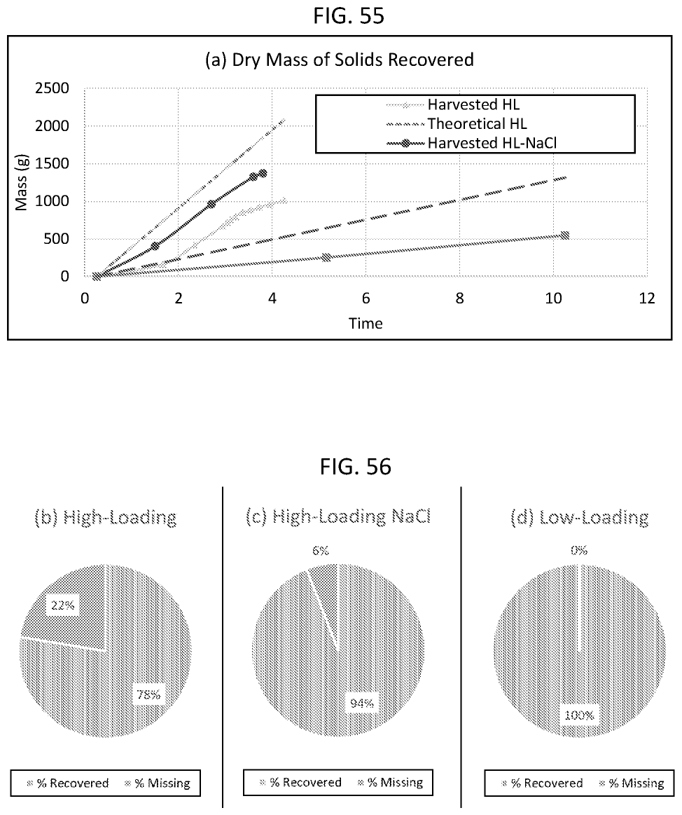

A mass balance of the solids was performed to determine whether the amount of solids produced were to be expected from the theoretical model. To calculate the theoretical value of solids produced, it was assumed that the 0.357 mol/L of NH₄⁺—N was fully converted to struvite (NH₄MgPO₄·6H₂O). Struvite has a molar mass of 245.41 g/mol, which was used to produce an estimated mass concentration of struvite based on the initial molar concentration of NH₄⁺. Both HL and HL-NaCl were operated with a flow rate of 99 mL/min, where LL was operated at 25 mL/min. Those values were converted to L/hr, which were equal to 5.94 and 1.5 L/hr respectively. A theoretical calculation was performed for each trial, using the estimated mass concentration of struvite and the flowrate that was converted to L/hr. The theoretical cumulative mass can be seen in FIG. 55, where all three trials are plotted. In addition to the theoretical series, the actual harvested solids were also plotted over time. The mass included in the harvested series are the solids that were collected from the harvesting loop. A difference can be seen between what was harvested and the theoretical value of the solids produced. When including the mass amount of the solids collected from the reactor after the trial was over, that gap was significantly reduced. FIG. 56 showcases the solid pie charts for each trial, showing the percent missing between the overall collected solids and their theoretical values.

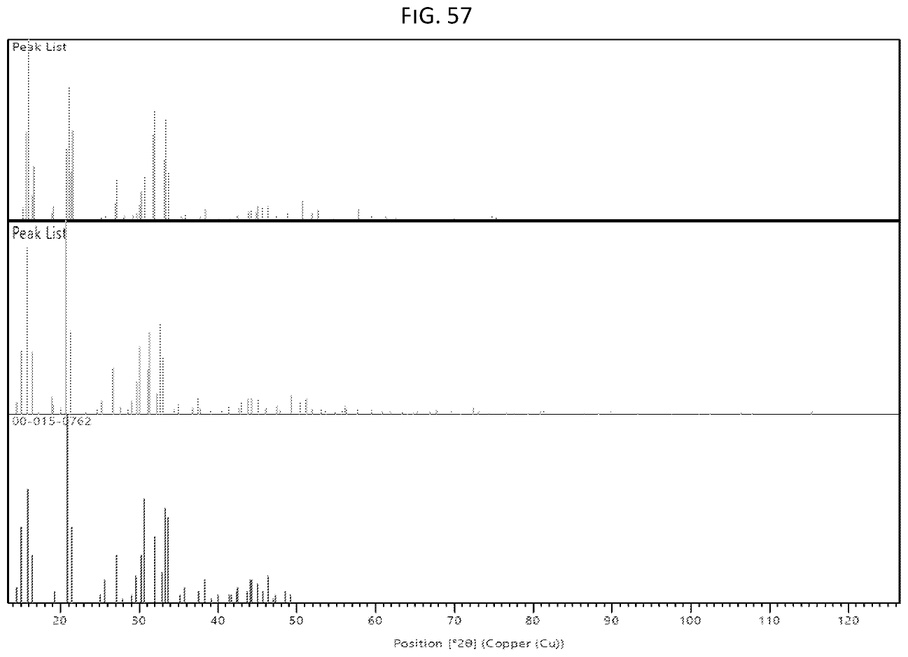

Solid samples from the MARS (LL) experiment were collected at two different production locations: the solids recovery line and the permeate. Samples were supplied to the Nanotechnology Research and Education Center at the University of South Florida for further analysis and MAP identification. As mentioned before, precipitation in the permeate was observed for all continuous experiments. There would be periods where the permeate would be clear and others where turbidity was visible. The initial identification step was processing both samples through X-ray diffraction (XRD) (Bruker D2 Phaser, UK). Line plots created from Panalytical Highscore software for the XRD can be seen in FIG. 57 where part (a) and (b) has the line graphs for both samples and part (c) has the reference line graph that matched them the most. Through automated peak matching, Panalytical Highscore recognized struvite (MgNH₄PO₄·6H₂O) as the harvested precipitate. Although intensities do not match, peak locations can be used to indicate strong correlations.

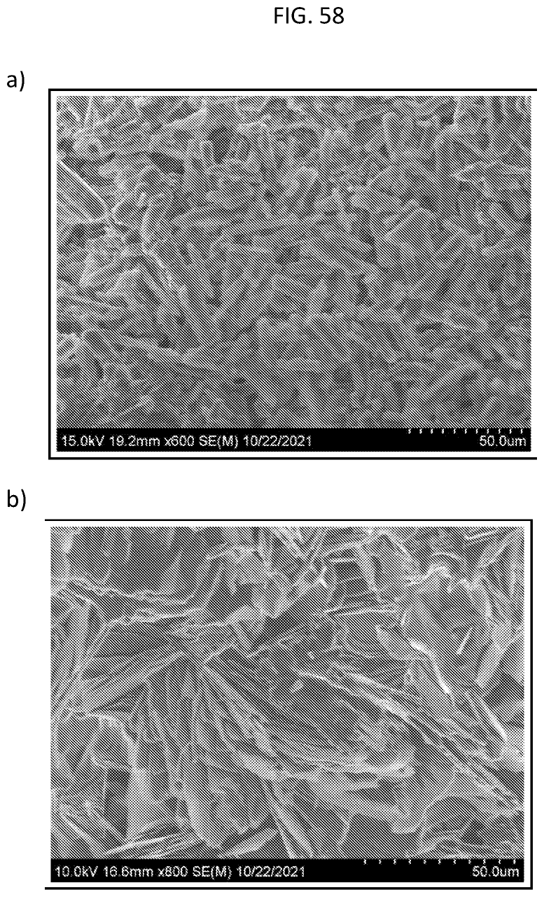

Scanning electron microscopy (SEM) (Hitachi SU-70, Japan) was used to observe the deposits. FIG. 58 shows magnified images of MARS (LL) samples collected from (a) the solids harvesting loop and (b) the permeate. The rod-like crystal shape shown in part (a) is consistent with various other studies that have identified struvite as the main crystal phase. Sizes within the sample appear to remain below 50 μm, fitting within the fines category described by others. Although small in nature, these crystals would be prevented from passing through to the permeate side due to their size alone. Therefore, the presence of precipitants in the permeate are likely due to the passing of ions. The SEM image of MAR (LL) permeate shows flat-sheet crystals that are not on par with the general morphology of struvite and other MAP analogues. It is possible that the membrane caused a change in the overall shape of the crystal, thus resulting in an uncharacteristic appearance.

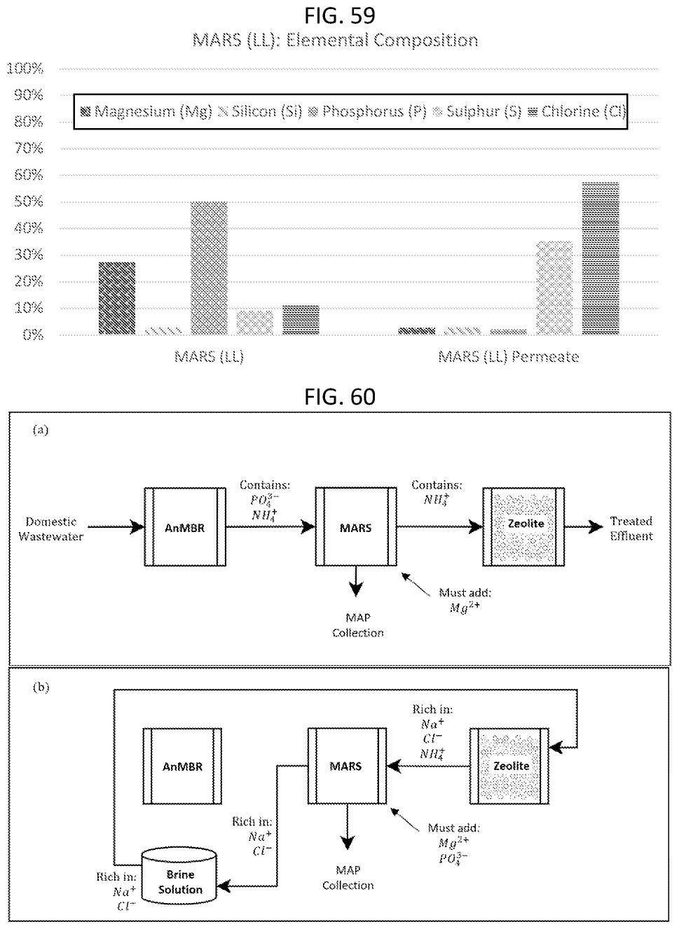

Additional insight into the characteristics of the deposits was done through X-ray fluorescence (XRF) (Bruker S2 Puma, UK) spectroscopy. Although not as commonly used, XRF is gaining traction as a reputable tool for elemental analysis. The results shown in FIG. 59 shows the elemental breakdown of MARS (LL) and MARS (LL) permeate. The XRF was not calibrated to read for Nitrogen (N) which is why it is not included. MARS (LL) collected from the solids harvesting loop had similar percent values for both Mg and P in comparison to other struvite reports. An unexpected result was the reduced presence of both elements in the MARS (LL) permeate sample. These results would suggest that the deposit found in the permeate is likely not a MAP analog, and instead a compound that contains either Cl or S. This directly contradicts the findings made through the XRD analysis. All three technologies concluded that MARS (LL) produced MAP in its solids harvesting loop, but only one identified MAP as the crystal phase for MARS (LL) permeate.

### Conclusion

Further improvements can be made to the MARS continuous design, but current results are promising for a proof of concept. The three experiments conducted explored the effects of NaCl and loading rates on the overall performance of MARS. Based on literature, it was expected that excess Na⁺ would inhibit the ability for NH₄⁺ to form a precipitate. Comparison of residual ion concentrations between MARS (HL) and MARS (HL-NaCl) implied that NH₄⁺ was not as readily removed, agreeing with what was previously reported. MARS (HL-NaCl) still accomplished an average of 89±6% removal of NH₄⁺ starting from a concentration of 5 g/L NH₄⁺—N. The best removal was achieved by MARS (LL), with a percent reduction of 97±2%. Water quality results for both HL experiments can be described as unstable, whereas MARS (LL) performed more consistently. This is likely due to improper reactor design which increased the amount of ions passing through to the permeate side causing delayed precipitation in the collected volume. Solids accumulation within the reactor seemed to be the root cause of rapid flux reduction in both HL studies. The major points for this Example are summarized below:
Development for this technology should focus on optimizing chemistry and reactor design to decrease the amount of MAP ions passing and precipitating on the permeate side.
The presence of high concentration Na⁺ ions can reduce NH₄⁺ removal.
A high loading rate decreases the overall performance of MARS.
Solids harvesting is a crucial task that can prevent rapid fouling of the UF membrane.

As mentioned before, MARS could fill the need of high concentration NH₄⁺ management in a decentralized context. Its ability to be small and compact can open many doors for future applications in both developing and developed countries.

### Example 5

Zeolite adsorption can be used as a method of NH₄⁺ removal applied in decentralized wastewater treatment systems (DWTS). As is generally the case with ion exchange materials, zeolite may cease to remove pollutant ions efficiently once it becomes saturated. Replacement or regeneration of the material is then needed in order to revert back to the original quality of treatment. It has been reported that some zeolite studies have accomplished 10-20 regeneration cycles, with little loss to regeneration efficiency, making it an attractive option for a sustainable design. The main cause of concern with regeneration, is the required volume and salinity of the regenerant solution. Concern for the treatment of secondary waste produced from regeneration has been a topic of discussion by others, where approximately 600-litres of 60 g/L NaCl and 5,000 mg/L NH₄—N were produced as a result of a single regeneration. The call to action made by other's work sparked the idea for MARS, the coupling of a magnesium ammonium phosphate (MAP) crystallization reactor with an ultrafiltration (UF) membrane.

MAP precipitation is a simple, yet effective, method for nutrient treatment. Instead of the process being delayed or slowed by sedimentation, hollow tube UF membranes can be employed to expedite the separation between liquid and solids. MARS can have a small foot-print and requires low operating energy so that it can seamlessly be used as or in conjunction to a DWTS technology. Its small size allows for two options: stationary build or mobile build. Unlike centralized systems, MARS would not require large amounts of land nor significant man-power to treat a wide range of NH₄⁺ concentrations. Due to its manageable size, MARS integrated with zeolite, an integration that will be denoted as Z-MARS, could take many forms. Z-MARS is a hybridization that could be arranged in different ways for the purposes of nutrient management. This Example will explore a few different variations that give validity to MARS as a technology, as its integration with zeolite could revolutionize the way nutrients are recovered. Two specific Z-MARS applications for DWTS will be discussed and expanded upon: anaerobic biodigester (AnMBR) and septic tanks. Table 14 summarizes the two Z-MARS applications under which permanent and transient MARS will be employed.

TABLE 14
Summary of conceptual Z-MARS applications.

| Z-MARS Application | AnMBR | Septic Tank |
|---|---|---|
| Stationary | ✓ | |
| Mobile | ✓ | ✓ |

### Stationary MARS for Z-MARS Applications

MARS, specifically for the purposes of nutrient removal and recovery, could be applied to a vast list of wastewater sources. Although the work previously conducted within this thesis has focused on high ammonium (NH) concentrations, MARS is not limited to only that. Precipitation of MAP can always be fine-tuned to the chemistry present within a polluted solution. This allows MARS the capability of being used as a nutrient management tool for both phosphorus (P) and nitrogen (N), not restricted to just high concentrations of NH₄⁺. Thus, giving MARS the ability to alternate between P-Recovery and N-Recovery through the adjustment of reagent addition. FIG. 60 shows how MARS can be used to recover P and N through a stationary installment in a DWTS. Putting MARS between an AnMBR and a zeolite bed allows for two functions to be achieved within the Z-MARS integration: life extension and regeneration. The two operational modes and their functions are described in more detail below:

Z-MARS Life Extension Mode: An anaerobic membrane bioreactor (AnMBR) is used to treat the organics and suspended solids present within wastewater. Unfortunately, its capabilities are limited when it comes to treating and removing nutrients. Therefore, effluent from an AnMBR contains ammonium (NH₄⁺) and phosphate (PO₄³⁻) ions that may be reduced before discharge. In some case, a treatment system can utilize a zeolite bed to remove NH₄⁺ from solution after it has passed through an AnMBR. To extend the life of the zeolite bed and mitigate saturation, MARS could be installed between the two systems. This idea is demonstrated in part (a) of FIG. 60 and FIG. 1F.

As previously mentioned, MAP chemistry can be adjusted depending on the composition of the wastewater being treated. Instead of dosing the system to remove NH₄⁺ in domestic wastewater, MARS can be used to remove and recover PO₄³⁻. Benefits of using MARS for P-recovery is that less MAP reagents will need to be added since NH₄⁺ is already naturally present at a higher ratio. Therefore, only a magnesium source will need to be supplied to reach a minimum 1:1:1 molar ratio between NH₄⁺:PO₄³⁻:Mg²⁺. By precipitating out a certain percentage of the NH₄⁺ present in the AnMBR effluent, the N-loading originally experienced by the zeolite bed will be reduced. This will allow for a longer zeolite bed life that will require less frequent regeneration. Additionally, the continuous recovery of P from AnMBR effluent would be serving as an extra benefit by to this Z-MARS integration and operational mode.

Z-MARS Regeneration Mode: As zeolite begins to show signs of saturation, influent domestic wastewater will need to be temporarily paused to allow for regeneration. A highly concentrated brine solution will be utilized for fast and efficient regeneration, which will be recovered at the end for future reuse. Sodium chloride (NaCl) could be used as the salt of choice since it is relatively inexpensive and can be found worldwide. The previous flow of operations shown in FIG. 60 part (a) will be reversed, where the influent will now be the brine solution and it will be fed to the zeolite bed first. As regeneration takes place, the brine solution will become rich in NH₄⁺ ions. As the flow proceeds from the zeolite bed to stationary MARS, the brine solution rich in NH₄⁺ will be processed for removal and recovery of N. A schematic of this concept can be seen in FIG. 60 part (b). Precipitation of MAP will require the supplemental addition of magnesium (Mg²⁺) and PO₄³⁻ in large enough quantities to reach the minimum 1:1:1 molar ratio. Effluent leaving MARS should result in low residual MAP ions, mostly containing Na⁺ and Cl⁻ ions. This will be recycled back to the original brine solution container for further regeneration cycles. MARS will essentially act as a N-sink so that the brine solution can maintain its ion exchange power and thus expedite the regeneration process. Additionally, this method will also simultaneously treat the secondary wastewater that is usually produced from chemical regeneration. The NH₄⁺ removed from the secondary waste will be recovered in the form of a slow-release fertilizer which can be used for agricultural purposes.

### Mobile MARS for Z-MARS Applications

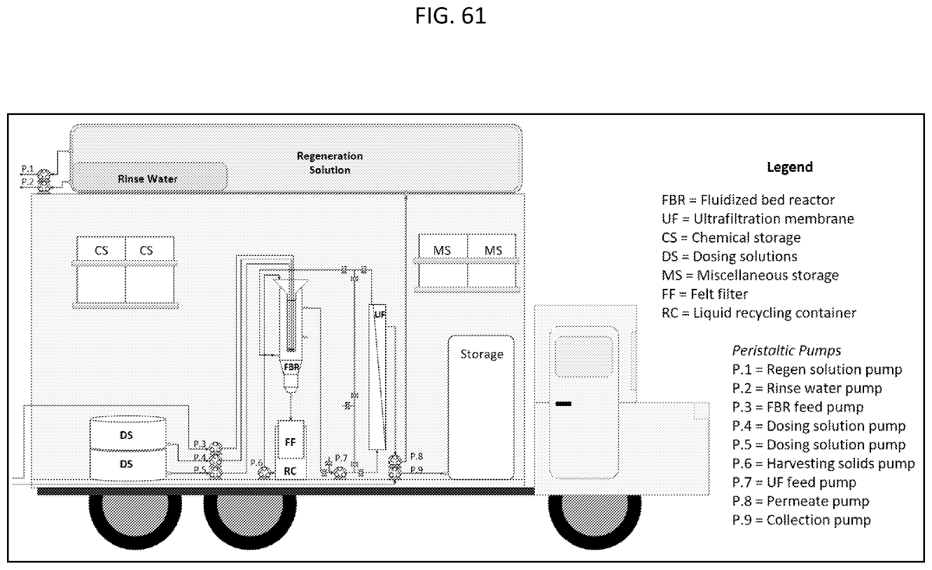

Transient MARS would offer the benefit of being utilized on a per-need basis for multiple locations. The inherent small-scale design of MARS lends itself to a portability that could be achieved with a vehicle. Mounting MARS inside a vehicle could radically change the way in which nutrient management is handled in communities that do not have access to centralized wastewater treatment. For example, the pairing of zeolite and MARS can be integrated with either an AnMBR or a septic tank to treat their eutrophic effluents, as Z-MARS is able to remove and recover resources such as NH₄⁺ and PO₄³⁻. With the commercialization of systems like the NEWgenerator™, the need for zeolite regeneration of DWTS may become more prevalent in the near future. Another opportunity for Z-MARS integration comes from the most predominantly used DWTS, the septic tank. FIG. 61 demonstrates the first iteration of a vehicle mounted MARS, where each key component is labeled and denoted in the legend.

The operation of the vehicle mounted MARS would follow similar strategies previously developed. The main modifications made from what was developed in the lab-scale version, is the solids harvesting method. The placement of the felt filter may no longer be at the top of the crystallization reactor, and instead it could be placed at the bottom. A slow-trickle could be released from the bottom of the reactor, which would separate the solids by gravity. As the leftover volume begins to increase in the recycling container, it can be pumped back into MARS for further treatment. The truck itself can be equipped with extra chemicals and solutions. For the purposes of Z-MARS, the truck could need to carry the regenerant solution as well as a pure water in case the location does not have access. The regenerant solution would have the capabilities of being reused, but the rinse water may need to be periodically refilled depending on the quantity that is used. A relevant application for mobile MARS would be the DWTS previously mentioned, the NEWgenerator™. As a treatment system that already incorporates an AnMBR and a zeolite bed within a mini-shipping container, it may not have enough space to accommodate even a compact technology such as MARS. Therefore, this transient solution to the treatment of the secondary waste produced from zeolite regeneration may be worth employing.

An additional application that is in need for nutrient management is one of the oldest and most often used DWTS, the septic tank. Septic tanks are common in both developed and developing countries alike. They are a simple technology that can address the main pathogenic concerns associated with wastewater treatment. They act primarily as settling tanks that contain anaerobic conditions which facilitates the reduction of organics and suspended solids. In the United States, approximately 25% of the population has a septic tank installed in their home. Although effective at containing organic pollutants, septic tanks are largely ineffective at reducing nutrient concentrations. Septic tanks are reported to be the second largest source of groundwater N contamination, with N in its effluent being in the form of NH₄⁺. This presents a great opportunity for Z-MARS technology to be incorporated.

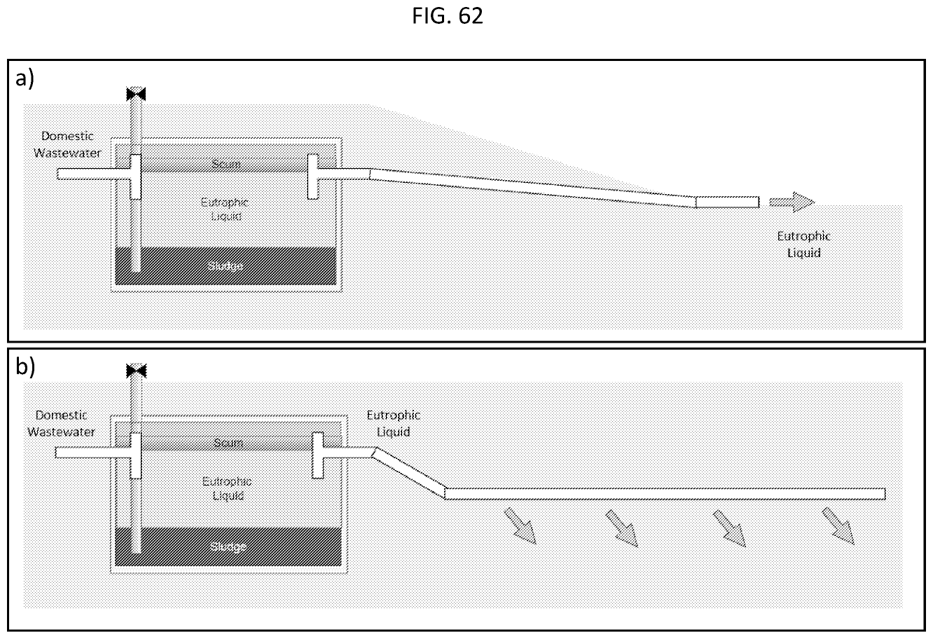

An installation of a septic tank is shown in FIG. 62 part (a), where it can be seen that the eutrophic effluent is being discharged to the surface. This design does not attempt any form on nutrient management and could cause severe impacts to the surrounding ecosystems. A septic tank alone does not address nutrient removal unless there is a subsequent drainage field that allows for proper percolation into the subsurface. FIG. 62 part (b) shows a tank followed by a subsurface drain that releases the effluent into this soil. Drain fields allow for biotic and abiotic process to take place and further treat the wastewater. Problems arise for when the appropriate soil is not abundant or if the water table is too high. If clay soil is present, then the proper percolation will not occur. A high-water table results in insufficient nutrient attenuation rates increasing the risk of groundwater pollution.

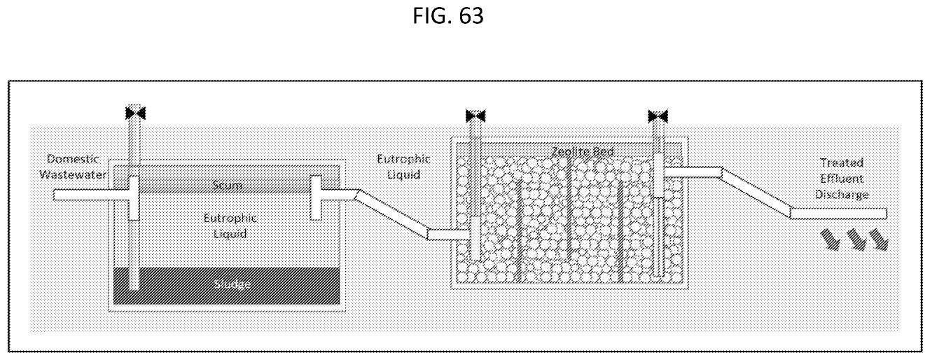

FIG. 63 displays an example of a conventional septic tank in series with an underground zeolite bed. Zeolite could act as a passive, yet effective, treatment method to remove NH₄⁺ from the effluent before it is discharged. Calculations would need to be made to determine the frequency at which the bed would need to be regenerated, which is when mobile MARS could be employed for the task. To ensure the appropriate time for regeneration, an NH₄⁺ sensor could be added to the zeolite bed effluent which could track its concentration. Upon passing a concentration threshold, the sensor could notify the homeowner that the bed is in need for a regeneration.

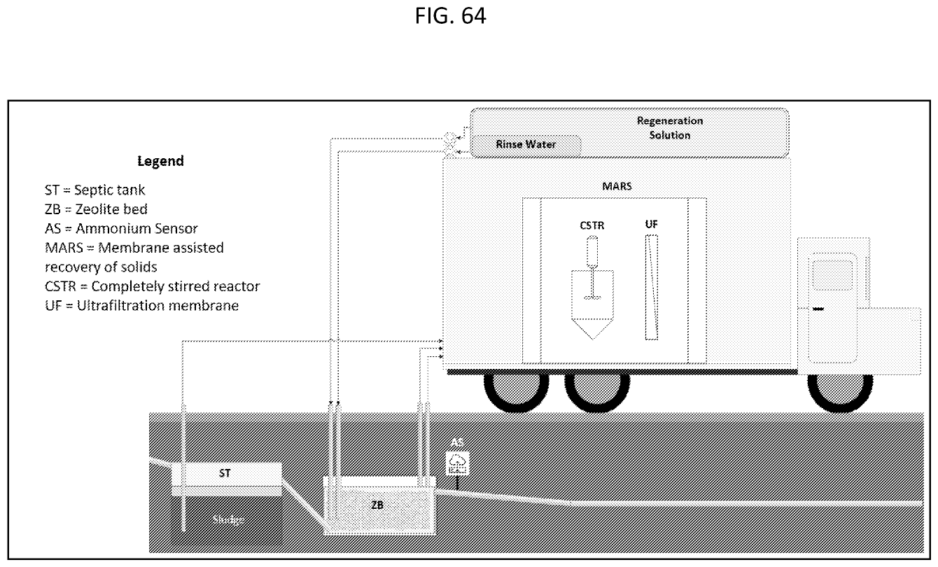

FIG. 64 and FIG. 1H shows the final Z-MARS integration, where mobile MARS is used to regenerant the underground zeolite bed. The truck could be designed to do a complete septic tank maintenance, which would also include sludge collection. Sludge could be pumped into a carrying container and dropped off for further processing at a separate location. MAP produced from MARS could also be further processed for commercial agricultural application. It could also be used on a small scale, as is, without the need of further processing. This technology could very well help address the global problem of groundwater contamination via unregulated septic tank discharge. Since it may not be feasible to create centralized treatment plants for all communities, engineers must continue to improvise and develop technologies that can address these serious problems.

### Conclusion

The need for nutrient management in a decentralized context is highly urgent as populations continue to grow and more pollution is being generated. In general, known DTWS technologies struggle with the treatment of ammonium and phosphate. Although most MARS content to this point has addressed N-recovery, it is still a viable solution to P-recovery as well. MARS offers the ability to remove pollutants, recover nutrients, and recover permeate. The applications explored in this Example are only the tip of the iceberg of situations that could benefit from a fast, efficient, and small scaled nutrient management.
MARS paired with zeolite (Z-MARS) could improve zeolite's sustainability in a decentralized context.
MARS could be capable of serving as either an N-recovery or P-recovery technology, depending on adjustments made to the chemistry for MAP precipitation.
MARS was designed to have a small foot-print, so that it can be either stationary or mobile.
Z-MARS integrated with a septic tank could offer a solution to one of the leading sources of groundwater pollution.

Additionally, MARS could also be applied outside the scope of Z-MARS. Other wastewaters produced in communities that don't have the means for centralized treatment may pose a threat to the health of their members and their environment if not treated properly.

### Example 6

### Magnesium Ammonium Phosphate (MAP)

Magnesium ammonium phosphate (MAP) is a solid that can readily form in domestic wastewater since its constituents are found naturally in solution. The three ions required for its formation are ammonium (NH₄⁺), phosphate (PO₄³⁻), and magnesium (Mg²⁺). The solids that form, which are likely struvite (MgNH₄PO₄·6H₂O), have been of significant concern in wastewater treatment plants. MAP is often perceived as a nuisance that affects the overall efficiency of a treatment process since it can cause major maintenance problems as it accumulates within the system. Different strategies have been attempted to mitigate scaling, such as addition of chemical inhibitors, preventative action by chemical dosing of iron salts, and dilution of crystals with water effluents. However, using the MARS system described above, MAP could serve as a solution instead of a hindrance. The benefit of this technology is that high pollutant concentrations can be treated with the addition of more phosphorus and magnesium sources, almost all of which can be recovered in the form of a slow-release fertilizer.

The growing population size is increasing the demand for NH given its crucial role in food security as a fertilizer product. NH₄⁺ fertilizer is most often obtained through a process called Haber Bosch, which is requires a lot of energy and is significantly expensive. This is something small scale communities may not be able to afford or sustain. Correspondingly, the controlled precipitation of MAP, as provided by MARS, offers a simpler, less energy intensive, and more sustainable approach that could help communities avoid the contamination of the local bodies of water and also provide a new source of agricultural fertilizer. MAP also incorporates phosphorus, which is also another vital element for agriculture that is on a rapid course towards global depletion. Although the treatment of high concentrations of NH₄⁺ requires supplemental PO₄³⁻, it is still a net positive since the finished product recovers both nutrients from solution.

### MAP Chemistry

MAP is a crystalline orthophosphate mineral that contains ammonium (NH₄⁺), orthophosphate (PO₄³⁻), and magnesium (Mg²⁺). A chemical reaction among NH₄⁺, PO₄³⁻, and Mg²⁺, in a saturated solution, results in the formation of struvite (ammonium magnesium phosphate, MAP). It is possible to form similar minerals following a general formula, AMPO₄·6H₂O, where A can be ammonium (NH₄⁺), potassium (K⁺) and M can be magnesium (Mg²⁺), cobalt (Co²⁺), or nickel (Ni²⁺). MAP in the form of struvite is often described with the balanced chemical equation demonstrated by Equation 2.2.

Mg²⁺+NH₄⁺+PO₄³⁻+6H₂O↔MgNH₄PO₄·6H₂O Equation 2.2

According to the theoretical Equation 2.3, the formation of MgNH₄PO₄·6H₂O requires equimolar concentrations of free NH₄⁺, PO₄³⁻, and Mg²⁺. The precipitant formed is a white powder that can occasionally be yellow, brownish, or light grey in color depending on the crystallization media. Table 15 provides a general summary of physicochemical properties of struvite.

TABLE 15
General physiochemical characteristics of struvite.

| Characteristics | Nature of Struvite |
|---|---|
| Chemical Name | Magnesium ammonium phosphate hexahydrate |
| Formula | MgNH₄PO₄•6H₂O |
| Molecular Weight | 245.43 g/mol |
| Size | 15 μm-3 mm |
| Composition | Oxygen 65.20%, Magnesium 10.73%, Phosphorus |
| | 12.54%, Nitrogen 5.71%, Hydrogen 1.64% |
| Color | White, yellowish white, brownish white |
| Specific | 1.705 g/cm³ |
| Gravity/Density | |
| Hardness | 1.5-2 (Mohs scale) |
| Structure | Orthorhombic |
| | Presence of regular PO₄³⁻ octahedral, distorted |
| | Mg(H₂O)₆²⁺ octahedral, and NH₄⁺ groups |
| Type of Bonds | Hydrogen bond |
| Solubility Constant | 10^{-13.26} |
| Solubility | Low in water: 0.018 g/100 mL at 25° C. in water |
| | High in acids: |
| | 0.033 g/100 mL at 25° C. in 0.001N HCl |
| | 0.178 g/100 mL at 25° C. in 0.01N HCl |

The decomposition of struvite can result in the formation of new phases, which are linked to the concentration of free ions within the original solution. Magnesium phosphates such as newberyite (MgHPO₄·3H₂O) and bobierrite (Mg₃(PO₄)₂) could be formed as MAP decomposes. Struvite may also be transformed into dittmarite through thermal decomposition, which has been reported to occur in air at a temperature of 103° C. and in water at temperatures as low as 60° C.

### Crystallization

Crystallization is a complex chemical process that leads to the precipitation of crystals. Although complex in nature, industry heavy relies on this technology to separate a desirable solid phase. To precipitate a compound such a MAP, supersaturation of the solution has to be achieved in order to trigger the occurrence of crystal formation. The crystallization process MAP, as well as other crystals, can be divided into two parts: nucleation and crystal growth.

### Nucleation

The birth of a crystal into a liquid or gaseous media is known as nucleation. Ions within solution combine together, under the right conditions, to form the first state of crystals called embryos. This part of the crystallization process is mostly governed by kinetics of reaction. Nucleation rate was found to be closely dependent on supersaturation (B) of solution. An earlier study concluded that nucleation is controlled by surface diffusion mechanism. Corroborating that the supersaturation is a triggering factor in MAP nucleation. This work also revealed the importance of induction time on the crystallization process of MAP.

Induction time is described as the period between mixing solutions containing precipitant reagents and the first indication of solids being formed. This timing can be effected by the degree of supersaturation, temperature, and the presence of foreign ions in solution. Induction time is also highly dependent on chemical and mixing kinetics which fully control nucleation and crystal growth. An earlier study demonstrated that induction time and the degree of supersaturation are inversely proportional.

### Growth

The step that follows nucleation is crystal growth. Embryos begin to grow in size until they are detectable, and under the right conditions can be further matured. In general, mass transfer and surface integration mechanisms are what control the growth rate of crystals. Practically speaking, mixing conditions play a major role at promoting MAP growth within its formation stage. The size of the crystals being produced is an important metric that is used for the quality for MAP meant as a commercial product. Particle growth can be enhanced through different flowrates tested on a fluidized bed reactor (FRB). Parameters affecting MAP growth, such as mixing intensity and duration, are further explored in the preceding sections within this Example.

### Settling

Under normal precipitation conditions, MAP crystals are small (10-50 μm) in nature making them difficult to separate through sedimentation. Reaching certain effluent standards becomes difficult as colloidal particles remain suspended over long periods of time. The two main strategies are typically used, which are to design a reactor that prevents particles from exiting or using various techniques to enlarge the particle size of a MAP crystal. Reactor design tends to be too complex for universal applications, therefore settling often takes precedence as the separation strategy. Settling also has its drawbacks, as it requires energy to grow the particles and time to settle them out. To calculate the settleability of a crystal in water, Stoke's law, shown in Equation 2.3, is used. It provides an estimated settling velocity for a crystalline particle. Others report that a crystal with a 50 μm diameter is 16 times slower to settle than a crystal with a 200 μm diameter.

$$V = \frac{g ( {p}_{p} - {p}_{f} ) {d}_{p}^{2}}{18 μ} \qquad Equation 2.3$$

$$where :$$

$$V = terminal settling velocity for particle , m / s$$

$$g = gravity constant , m / {s}^{2}$$

$${p}_{p} = particle density , kg / {m}^{3}$$

$${p}_{f} = fluid density , kg / {m}^{3}$$

$${d}_{p} = particle diameter , m$$

$$μ = dynamic viscosity , Pa \cdot s$$

### Parameters Affecting MAP Crystallization

### Molar Ratios

Theoretically, the molar ratio of NH₄⁺: Mg²⁺: PO₄³⁻ under which MAP precipitation occurs is 1:1:1. Under real circumstances, the optimum ratios between the constituent ions are usually different than the theoretical ratio due to the presence of other species that uptake the ions to form by-products. Like pH, determining an optimum molar ratio will be dependent on the composition of the wastewater that is being treated. Therefore, an appropriate molar ratio between all three ions may be determined for each individual case.

In the context of wastewater containing high concentrations of NH₄⁺, literature corroborates that increasing P: N and/or Mg: N ratios result in an improved removal of NH₄⁺. Conflicting reports have been made regarding which constituent, either PO₄³⁻ or Mg²⁺, has the greater effect on NH₄⁺ removal. This disagreement can also be attributed to the varying compositions of the wastewater sources as well as different experimental conditions. It is important to consider that even if the addition of PO₄³⁻ yields more MAP, operators can run the risk of overdosing the salt in solution. Excess PO₄³⁻ could then become present in the effluent which would require further treatment downstream. Therefore, Mg²⁺ is likely to be a better option when choosing between which constituent to increase for improved MAP precipitation and NH₄⁺ removal.

The ratio between Mg: P also plays an important role in MAP crystallization. Once again, the theoretical molar ratio is that of one, but in practical applications it is always greater than that. A similar theme throughout MAP chemistry will be the need to determine the optimum value of a parameter through studying the specific wastewater being treated. Studies have tried to compile an appropriate Mg: P ratio that could be used to guide future research. Increasing the ratio to be greater than 1 will in effect increase the degree of supersaturation, thus improving precipitation. A further increase of the ratio did not yield improved P removal efficiency and instead just increased the chemical dosage cost.

pH

In an unbuffered solution, the pH will decline as the formation of MAP begins due to the release of hydrogen ions (H⁺) through the crystallization of soluble phosphorus (P). This means that the dominant form of P in MAP formation reaction is HPO₄²⁻ or H₂PO₄⁻ instead of phosphate (PO₄³⁻). Equations 2.4 and 2.5 demonstrate the balanced equations that help explain the decrease in pH.

Mg²⁺+NH₄⁺+HPO₄²⁻+6H₂O↔MgNH₄PO₄·6H₂O+H⁺ Equation 2.4

Mg²⁺+NH₄⁺+H₂PO₄⁻+6H₂O↔MgNH₄PO₄·6H₂O+2H⁺ Equation 2.5

Depending on the concentration of the reactants, an unregulated drop in pH may inhibit the precipitation reaction kinetics, affecting the removal of ions and purity of MAP. Research has shown that MAP precipitation is highly influenced by the pH of its solution. The pH has been linked to other important parameters such as supersaturation and solubility. To improve the crystallization process, an optimum pH can be maintained, for example, by either adding an alkali chemical or introducing air into the system. Both methods increase and maintain the overall pH of the solution until the reactants become liming. Some chemicals that can be used are sodium hydroxide (NaOH), magnesium oxide (MgO), magnesium hydroxide (Mg(OH)₂), potassium hydroxide (KOH), and potassium carbonate (K₂CO₃). In some cases, NaOH can be preferably selected due its low cost and easy acquisition.

Typically, optimum crystallization can occur when the pH range is set between 8 to 9. Exceptions to this may arise when the concentrations of NH₄⁺ and PO₄³⁻ both significantly exceed that of Mg²⁺. Under those conditions, precipitation can occur at pH levels as low as 5.3. In general, MAP is formed between the pH ranges of 7 to 10.5. In some cases, wide discrepancies in pH may be tied to the composition of the wastewater being treated.

Variations in pH can decrease the purity of the solids being formed by favoring the precipitation of other compounds. As previously mentioned, the range for pH is usually between 7 to 10.5, where a lower pH can result in the dissolution of crystals in solution. Neutral pH can favor the production of pure MAP, but it comes at the cost of slower precipitation depending on the concentration of ions. At higher pH ranges, such as above a pH of 10.5, calcium and magnesium phosphate complexes begin to form in larger ratios. It is assumed that this occurs because of the NH₄⁺ ion speciation that is controlled by pH and temperature. Above a pH of 9.3, NH₄⁺ might begin to volatilize from solution into its gaseous form of ammonia (NH₃), reducing the available ions for MAP precipitation. Hence, favoring other compounds to crystallize, such as newberyite (MgHPO₄·3H₂O), and trimagnesium phosphate in two states of hydration (Mg₃(PO₄)₂·22H₂O and Mg(PO₄)₂·8H₂O). This is the reason why typical operations stay below the pH of 10.5 for MAP recovery. It is worth noting that an optimum pH is ultimately dependent on the composition of the wastewater being treated and could therefore be determined on a per trial basis.

### Supersaturation

Saturation describes the state of a liquid, solid, or gas that can no longer absorb, combine, or accept an additive. In the context of liquid chemical solutions, reaching supersaturation entails that the concentration of a solute surpasses the concentration of its equilibrium solubility. Supersaturation is the driving force for the crystallization process as it controls morphology and the size distribution of crystals. MAP supersaturation (β) is defined by equation 2.6. Different studies have been found the activity solubility product of MAP to range between 10^{-9.42} to 10^{-13.36}.

$$B = {f}_{1} * [ {NH}_{4}^{+} ] * {f}_{2} * [ {Mg}^{2 +} ] * {f}_{3} * [ {PO}_{4}^{3 -} ] \qquad Equation 2.6$$

$$where :$$

$$β = MAP supersaturation$$

$${K}_{so} = Solubility product$$

$${f}_{1} = Activity coefficients of [ {NH}_{4}^{+} ] concentration$$

$${f}_{2} = Activity coefficients of [ {Mg}^{2 +} ] concentration$$

$${f}_{3} = Activity coefficients of [ {PO}_{4}^{3 -} ] concentration$$

Supersaturation is critical parameter that can be affected by multiple conditions of the reaction such as ionic strength, temperature, and pH. The state of supersaturation can be achieved by two techniques: increasing the concentration of MAP reactants and/or raising the pH of solution. At a fixed pH, the supersaturation of the solution influences the rate of crystallization through crystal induction time. The lower the concentration of the constituents, the longer the induction time. On the other hand, a constant supersaturation level will increase the crystal growth by up to seven times.

### Temperature

To achieve higher efficiency of ammonium (NH₄⁺) removal via MAP recovery, the temperature at which the reaction occurs should be controlled during the design of the reactors. In theory, the solubility of MAP may decrease at low temperatures (5-20° C.) due to its effect on the activity coefficients of NH₄⁺, Mg²⁺, and PO₄³⁻. Similarly, at temperatures of above 55° C. mass loss may begin to occur due to the increase in solubility. The relationship established is that as temperature decreases, solubility of MAP decreases thus avoiding dissolution of the formed crystals. Below the temperature of 55° C., MAP crystallization is found to be stable. To avoid mass loss and phase transformation it is suggested that MAP be rinsed with deionized water (DI) and dried at a temperature between 30-50° C. In the context of NH₄⁺ removal, temperature did not have a significant effect on over 90% removal obtained between 25-40° C.

### Feeding Sequence

Chemical equilibrium of MAP ions within a solution is reached instantaneously after mixing. This places significant importance on the feeding sequence of reactants and pH adjustment since the span of time between the feeding intervals is very short.

Following cases demonstrated the effect of adding Mg first, followed by the buffering reagent and then the P additive. Removal of NH₄⁺ was as low as 60%, with high level of PO₄³⁻ still present in the solution. This sequencing is speculated to be hindered by the reactions between Mg²⁺ and OH⁻, which can readily produce products such as magnesium hydroxide (Mg(OH)₂). These products increased the total suspended solids (TSS), due to having a higher density than that of MAP. When P was the first reagent added, followed by the buffer solution and g, NH₄⁺ removal efficiency increased to 70% and PO₄³⁻ was relatively low compared to past iterations. The final sequence consisted of adding the buffer reagent after Mg and P additions to the solution. The results showed a 90% removal of NH₄⁺ and a lower PO₄³⁻ and TSS concentration than what was seen before. This work indicated that MAP purity can be enhanced by the order in which reactants are added, effectively reducing the occurrence of unintended reactions.

### 2.2.3.6 Reactant Sources

Multiple kinds of magnesium (Mg) and phosphorus (P) sources have been studied in the field of MAP crystallization to determine their effects on NH₄⁺—N removal. Sources including laboratory grade chemicals, natural deposits, and wastes containing Mg have been investigated.

### Magnesium Sources

Magnesium is typically found in low concentrations in most wastewaters; therefore, MAP crystallization often requires an additional source to reach the minimum equimolar concentration. Laboratory grade sources of Mg that are commonly used include magnesium chloride (MgCl₂), magnesium oxide (MgO), and magnesium sulfate (MgSO₄). Commercial Mg salts yield high purity and contain high Mg content, which is why it is preferred in laboratory and pilot plant applications. Mg salts can influence the reaction-completion time due to different solubility and pH effects of reagents. When using MgO, the time to reach reaction completion was over 30 minutes, whereas when MgCl₂ was used the reaction took about 50 seconds. MgSO₄ performs similarly to MgCl₂ in the modeling conducted by one group. Mg salts most efficient for P removal were found to be in the order of MgCl₂>MgSO₄>MgO>Mg(OH)₂>MgCO₃. Where MgCO₃ was found to be the least effective due to its low solubility, requiring additional acid to dissolve it.

Aside from the slower reaction time, an additional thing to consider when using MgO is that it intertwines pH adjustment with Mg dosage. This reagent thus removes an operator's ability to control those parameters independently. It is possible that this could be used as an advantage to overcome MgO's reaction time limitation, but further research is required to determine an appropriate dosage to reach desired results. MgCl₂, on the other hand, has no effect on pH and simply acts as source for ionic Mg²⁺. Environmentally speaking, MgO offers a greater advantage. Both MgCl₂ and MgSO₄ produce effluents with high electrical conductivity due to the additional salt concentrations that are introduced. This can prove to be a challenge if the effluent is planned to be discharged to a natural body that may have sensitivity towards high salt concentrations.

Mg consumption can contribute up to 75% of total operational cost in some processes. To reduce the cost, different Mg alternatives can be used, such as raw materials and industrial by-products, with the goal of maintaining or improving product quality. Seawater is one example of an Mg alternative. A 99% PO₄³⁺ removal was achieved using a seawater to urine ratio below 3.3. In some cases, 98% of PO₄³⁻ can be removed via MAP precipitation using seawater as the Mg source.

Another alternative Mg source is bittern, which is a by-product of sea salt production. Bittern contains high magnesium concentrations and is comparable to MgCl₂ and seawater for P recovery. Wood ash has also been investigated for MAP precipitation, but the high heavy metal content rendered the product to be used as a soil conditioner instead of a fertilizer. Magnesite, a raw form of magnesium, may be effective at removing NH₄⁺, suspended solids, and PO₄³⁻. Using pyrolyzed magnesite reduced operational costs by 34% when compared to commercial Mg salts, proving that cost and quality can be achieved. Both bittern and magnesite are unstable compounds when large amounts are required, so an approach being considered for industrial operation is the combination of different sources for a single dosage.

### Phosphate Sources

Similar to magnesium (Mg), phosphate (P) is not typically present in as high of concentrations as nitrogen (N) in wastewaters. To induce MAP precipitation, in some cases, it is common for additional phosphate (PO₄³⁻) compounds to be added to reach the minimum 1:1:1 molar ratio between NH₄⁺: Mg²⁺: PO₄³⁺ in solution. Typical analytical grade chemicals used for P addition are disodium phosphate (Na₂HPO₄), phosphoric acid (H₃PO₄), ammonium dihydrogen phosphate ((NH₄)H₂PO₄).

A deviation from commercial P salts may be bone meal waste. Bone meal waste is a by-product produced from the meat-waste thermal treatment process that contains 61.6% of PO₄³⁻. Another alternative P source may include phosphoric acid waste. Both alternative P sources showed comparable results in NH₄⁺ removal to that of laboratory chemicals.

P is a limited resource that is slowly being depleted and lost in wastewater. MAP could offer a methodology in which both ammonia and phosphorus can not only be removed, but they can also be recovered for further use.

### Mixing Intensity and Time

Mixing intensity and duration considerably affect MAP crystallization, specifically nuclei generation and growth. Nuclei generation relies on initial mixing intensity, where crystal growth depends on the duration of mixing.

Mixing rates high enough to create significant turbulence can cause CO₂ liberation, resulting in a pH rise beneficial for precipitation. The favorable conditions created by high mixing can result in faster nucleation, but it may also lead to crystal breakage. MAP recovery has been shown to be inhibited by mixing strengths higher than 76 s⁻¹. In other cases, NH₄⁺ and PO₄³⁻ removal may have a logarithmic increase with mixing intensity. The mixing effect, both intensity and duration, enhanced the mass transfer of NH ions in solution. Thus, improving the potential of MAP crystallization. Insufficient mixing energy can produce other competing solids, reducing the purity of the finished product.

In some cases, a greater importance should be placed on the mixing time as opposed to the mixing intensity when the concern is MAP size. Nucleation stage requires anywhere between seconds to minutes to complete. Crystal size is something that increases over time and may therefore be considered if the product is meant to be within a certain dimension. In some cases, crystal size was increased significantly during a reaction time of 3 hours. In addition to size, it is possible to see an increase in ion removal if mixing duration is increased. In other cases, the removal efficiency of PO₄³⁻ went from 97.3% with 5 minutes of initial mixing to 99% at around 30 minutes.

### Foreign Ions

The precipitation of MAP can be applied to several types of wastewaters for removal and recovery of nutrients. Wastewater typically contains a wide range of pollutants and ions in different concentrations which can likely affect MAP production. Interfering ions such as calcium, potassium, chloride, sodium, sulfate, and heavy metals have been studied for their effect on MAP precipitation.

### Calcium and Potassium

Calcium (Ca²⁺) is one of the main foreign elements that inhibits ammonium (NH₄⁺) recovery in MAP formation. Depending on parameters like pH, initial concentrations, and reaction time, Ca²⁺ can outcompete magnesium (Mg²⁺) to form amorphous calcium phosphates. By binding with PO₄³⁻, Ca²⁺ effectively prevents NH₄⁺ and Mg²⁺ from joining together and forming MAP. A rule of thumb is to have a molar ratio of Ca: Mg that is less than 0.5. Above that ratio value, NH₄⁺ removal is stunted. Potassium (K⁺) is another ion that can be commonly found in wastewater. When concentrations of NH₄⁺ are low, co-precipitation of “struvite-K” or “potassium-struvite” is formed (MgKPO₄·6H₂O). Equations 2.7 and 2.8 demonstrate typical chemical reactions that may occur when either Ca²⁺ or K⁺ precipitants are favored.

5Ca²⁺+3PO₄³⁻+H₂O→Ca(PO₄)₃OH+H⁺ Equation 2.7

Mg²⁺+HPO₄³⁻+K⁺→MgKPO₄+H⁺ Equation 2.8

### Heavy Metals

Heavy metals have two sorption mechanisms during the MAP crystallization process, which are co-precipitation and adsorption. Metals such as copper (Cu²⁺), zinc (Zn²⁺) and arsenite (As(III)) may adsorb onto the surface of MAP. These metals can often be highly concentrated in swine wastewater and sludge digestion liquors. The presence of these heavy metals can also result in a reduced removal of nutrients. Co-precipitation may occur for metals like aluminum (Al³⁺) and arsenate (As(V)).

### Sodium

There may be implications of higher sodium, sulfate, chloride, and acetic acid concentrations on induction time of MAP crystals. In some cases, an increase in induction time when Na⁺ was increased over 5 mM. This may be due to possible accumulation around negatively charged molecule groups of MAP by positively charged Na⁺ ions. In other cases, there may be a slight compensating effect and improvement in induction time when chlorine (Cl⁻) was increased in concentration in comparison to Na⁺. Showcasing that non-reactive Na⁺ can slow down the transportation of Mg²⁺ and NH₄⁺ to the nucleus, thus hindering the induction time for moderately low constituent concentrations.

### Seeding

MAP particle size has been shown to be affected by the utilization of seed materials. Quartz, sand, granite, and MAP ranging in sizes below 75 μm and 75 to 150 μm may be considered as seeding materials. In some cases, certain seeding material types and sizes can greatly increase crystal size in MAP precipitation. In some cases, synthetic solution seeded with MAP powder (smaller than 75 μm) may achieve 5 times higher PO₄³⁻ removal than the unseeded solution. Seeding material can decrease the induction and equilibration time significantly. The seeds act as a starting platform for other ions to build upon and create crystals. By providing sufficient surface area for ions to bind, seeding materials can effectively reduce induction time for low-strength wastewater.

### Organic Substances

Organic substances can be present in high concentrations for different types of wastewaters such as domestic, leachate, and swine manure. It has been noted that the concentration of organic pollutants tends to be reduced during MAP precipitation. This is attributed to the possible co-precipitation of by-products and impurities alongside MAP. It is typical for MAP processes to overdose with Mg, forcing either N or P to be the limiting reactant, therefore leaving an excess amount of Mg in solution. Mg naturally acts as a flocculant, meaning it can cluster together suspended organic matter and increase its removal. Additionally, MAP surface can act as an adsorption site for organic matter, assisting in chemical oxygen demand (COD) reduction. The attachment onto the surface of MAP has can lead to increased induction time and growth inhibition. In general, organic matter has a slight effect on MAP composition. The relationship between organic matter and MAP have not been significant researched as it deemed to have a slight effect on MAP composition while not affecting purity.

### Sources of Wastewater for MAP Crystallization

### Leachate

Percolation of water through solid waste results in a waste stream referred to as leachate. Due to its high concentrations of NH₄⁺, PO₄³⁻, salt and organic matter, it is considered a great risk to environment. If left without treatment, discharged leachate could wreak havoc on surface water by causing algal blooms and fish kills. As leachate begins to age, organic matter present in the wastewater begins to decrease leaving a dominant concentration of inorganic compounds such as NH₄⁺ and PO₄³⁻. Conventional wastewater treatment at centralized locations relies on a sufficient supply of organic matter for the treatment of inorganic compounds. With this significant imbalance between the two, organic and inorganic, it becomes more difficult to treat older leachate. Therefore, MAP precipitation can provide a solution for removal and reduction of nutrients such as NH₄⁺ and PO₄³⁻ to facilitate further biological treatment of leachate.

### Urine

Humans remove excess water and nutrients through the release of urine. Human urine is complex, containing high concentrations of sodium chloride (NaCl) and urea (CO(NH₂)₂) as well as potassium (K), sulfate (SO₄), ammonium (NH₄⁺), phosphate (PO₄³⁻), and calcium (Ca) in lower concentrations. Previous studies have concluded that urine produced by humans contributes about 75-87% of total N, 40-50% of P, and 54-90% of K at municipal wastewater treatment plants. Although it constitutes such a high percentage of these ions, urine only makes up 1% of the raw sewage volume. Therefore, known applications have considered urine-source separation technologies to avoid combining wastewater streams. If the urine stream is separated it can then become a viable feed for MAP precipitation. A study conducted by Ishii and Boyer, 2015 looked at the comparison between centralized wastewater treatment and urine source separation with MAP precipitation. Their results concluded that conventional treatment requires high amounts of energy to achieve comparable removal. MAP precipitation allowed for significant recoveries of both N and P, but the upscale requirement of additional reactants (supplemental PO₄³⁻ and Mg dosing) for precipitation were substantial. The consideration for chemical addition will be further discussed in a separate section. Aside from that, urine source separation acts as an attractive feed source for MAP reactors due to its high concentrations of NH₄⁺ and PO₄³⁻.

### Industrial Effluent

Wastewater from steel plants, coal-based power plants, and leather tanning contain high concentration of NH₄⁺ due to the nature of the processes being conducted. Converting coal to coke, for the purposes of producing added heat in the steel-making process, requires thousands of gallons of water to clean the ovens postproduction. The large volume of wastewater generated from this process is overloaded with NH₄⁺ ions. Treating this effluent becomes difficult under normal approaches such as the biological activated sludge process, due to the lack of carbon sources needed for denitrification. Struvite can be a viable treatment option for the removal and recovery of NH₄⁺ from the enormous quantity of wastewater resulting from coke oven cleaning.

### Ion Exchange Regenerant

Ion exchange media such as synthetic cation resins and zeolites are used for the purposes of nutrient management in different treatment strategies. Zeolites are hydrated aluminosilicate minerals that can be used as an ion exchange material. This is due to its high affinity for NH₄⁺, and its efficient regenerative properties. Zeolite can adsorb between 3-30 mg of NH₄⁺ per gram of zeolite, with variability being explained by the composition of the wastewater and the type of zeolite used. Once zeolite becomes saturated with NH₄⁺, it is typically regenerated with large quantities of sodium chloride (NaCl) and sometimes sodium hypochlorite (NaClO). In a certain case, zeolite underwent 20 regenerations with an NaCl—NaOCl regenerant solution with continued high performance. Waste streams produced from the regeneration process contain high concentrations of NH₄⁺ and NaCl, which if left untreated could be hazardous for the environment. With the correct addition of Mg and PO₄³⁻, MAP could be precipitated to remove and recover the NH₄⁺ present regeneration eluent.

A modification to this process can be made by pre-treating zeolite with magnesium chloride (MgCl₂). The Mg²⁺ released when NH₄⁺ ions are exchanged can be used as the magnesium source in the MAP crystallization process. This modification relies on the fact that the waste stream being treated is high in NH₄⁺ concentration and that additional PO₄³⁻ will be added to reach the theoretical molar ratio of 1:1:1 (NH₄⁺: Mg: PO₄³⁻) for MAP precipitation. Certain cases have shown an 82% total ammonia-nitrogen (TAN) removal and a 98% total orthophosphate. The presence of foreign ions, such as potassium (K⁺), calcium (Ca²⁺), and sodium (Na⁺), may have a significant effect. This is due to the order preference of zeolite at identical molar ratios being K⁺>Na⁺>Ca²⁺. Additional optimization can be done to further develop this technology, as the presence of those ions also proves to be beneficial in removing PO₄³⁻ from solution.

### Crystallization Reactors

### Mechanically Stirred Reactors

Mechanically stirred crystallization reactors for MAP precipitation have been used in laboratory, pilot, and industrial scaled systems. Operation principles of this reactor include addition of dosing chemicals to the main body of the reactor, a mechanical stirrer, and a settling zone for the purposes of particle accumulation. Experiments were conducted to examine the effects of retention time, pH, recycling rate and NH₄⁺ concentration on MAP crystal growth. The second tank, volume size 1000 mL, was tested for the fines entering from the main crystallization reactor, volume size 1400 mL. A stirring motor with variable speed control was used to mix the reactants. MAP was precipitated from (NH₄)₂HPO₄ and MgSO₄. The pH of the reaction was kept at a value between 8 and 9 using NaOH as the pH adjusting solution. For solids to be collected from this reactor design, they'd need to be able to overcome the mixing energy and fluid viscosity. Otherwise, solids can only be collected after the mixing has stopped.

An initial struvite reactor was developed to observe effects on the precipitation of MAP using different seeding materials. A control (no seeding), sand, and MAP pellets were tested. This reactor has the crystallization occur at the bottom and the settling zone on top of it. The mixing zone is where all solutions are introduced and where the mechanical stirrer agitates them together. The cone shaped settling zone is situated above. This design allows for clearer effluent to be taken from the top of the reactor. The pH of the reaction was kept at a value of 9 with the addition of NaOH. The synthetic solution was made from NH₄Cl and NH₄H₂PO₄ and the Mg dosing was made of MgCl₂. This study found that the creation of fines occurs in all three variations. Ultimate, the conclusion was that no seeding was necessary, as all tests resulted with fines in the effluent. It is worth mentioning that the control experiment resulted with the least fines in the effluent water.

Mechanically stirred reactors have a main advantage over other processes, which is their simplicity in operation. Although simple, their efficiency at removing ammonia and phosphorus is relatively high. For example, mechanically stirred reactors can reach close to 90% removal of P from anaerobic digestion effluent, and over 60% removal of P from synthetic liquors. Magnesium removals have been achieved between a range of 76% to 88%, with specific crystallization operational parameters in a study conducted by another group. The mean crystal size from these studies were 425 μm and 300 μm respectively. Other design systems can reach crystal sizes of up to 0.18 mm. Crystal growth is one of the main challenges of the mechanically stirred technology. Addition of seeding material has not been proven to significantly assist crystal growth, since it is difficult to achieve the necessary mixing speed to fluidize the seed. This results in a large production of fines that may become present in the recovered effluent.

### Fluidized Bed Reactors

Air-agitated reactors or fluidized bed reactors (FBR) can also be used crystallization reactors for MAP precipitation from wastewater. In such processes, the growth of the crystals takes place after nucleation by either agglomeration (interaction of small MAP crystals together) or by contact on seed materials (e.g., MAP or sand). To achieve a continuous motion for the particles, the suspension can be controlled by either an up-flow of air or by liquid flowrates. Feed solutions are fed through the bottom of the reactor, which acts as the reacting zone. Influent flow rates vary depending on the reactor's configuration, values can range between 0.004 to 0.3 m³/hr. Upward flows cause particles to simulate the behavior of a dense fluid, creating a uniform fluidization of crystals. This prevents growing particles from settling down to the mixing zone.

The introduction of air can also help reach and maintain a desired level of pH for MAP crystallization. Turbulence of the solutions through the up flow of air causes the release of CO₂, which leads to an increase in pH. For example, a pH range of 7.6-8.2 can be acheived using the aeration method.

Although, even for FBR systems it is still possible for pH to be controlled through the addition of NaOH. The velocity of the fluid is at its highest in the mixing zone and as it moves upwards into the reactor it begins to decrease. An FBR may have sufficient length between the mixing zone and the effluent exit at the top to prevent most particles from exiting the reactor. The middle zone of the reactor is an area where particles are partly suspended and can grow. Due to the nature of bottom mixing, solids are usually only recovered once they have reached an appropriate size. Therefore, FBRs work continuously for the liquid phase and as batches for the solids phase.

FBR processes can vary in their efficiency at removing PO₄³⁻ and NH₄⁺. For phosphorus the removal can be between 60% to 94%, mainly depending on the nature of the crystallization process and the influent of the system. Solid retention times are kept in the order of days, experiments conducted by one group had retention times between 3 to 14 days. This is done to avoid having to stop the system for desludging as well as for the purposes of particle growth. Size of the solids have been proven to be strongly dependent on the use of seeding materials, therefore, keeping previous solids can be beneficial for the next run. For example, MAP size was increased from 0.9 mm to 0.14-0.18 mm in aeration reactor experiments after adding sand as the feeding material.

Once again, the size of the precipitate is an important parameter, as it relates to the practicality of future reuse as a fertilizer. FBR, unlike other MAP precipitation technologies, can succeed in the production of larger solids. This is due to its ability to successfully fluidize seeding material so precipitate can agglomerate together and grow. It is worth noting that this type of operation requires significant mixing energy and/or high flow rates to ensure continuous fluidization. The cost itself, due to energy consideration as well as raw materials, could be a limitation to its application by wastewater companies. For example, a smaller mixing zone can be used, and a MAP-accumulation face made of stainless-steel wire mesh to serve as the seeding surface. This can reduce the need for high flowrates to sustain a fluidization of heavier seed particles. Aside from cost, the high flowrates and mixing can also result in a large formation of fine particles. If not designed properly, the fine particles may appear in the effluent due to the upward flow and turbulence of the mixing zone.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A solid precipitation reactor comprising
a reaction chamber configured to receive feedwater and to allow particulates to at least partially precipitate from the feedwater to form an effluent; and
a membrane module having at least one membrane filter configured to receive effluent from the reaction chamber and to filter suspended particulates from the effluent to produce a permeate and a concentrate,
wherein the concentrate is reintroduced to the reaction chamber to allow additional particulates to precipitate.

2. The solid precipitation reactor of claim 1, wherein the reaction chamber comprises a completely stirred reactor (CSTR) or a fluidized bed reactor (FBR).

3. The solid precipitation reactor of claim 1, wherein the at least one membrane filter comprises at least one ultrafiltration membrane filter.

4. The solid precipitation reactor of claim 1, wherein the membrane module is at least partially submerged into the reaction chamber.

5. The solid precipitation reactor of claim 1, wherein the membrane module is configured for one of crossflow or dead-end filtration.

6. The solid precipitation reactor of claim 1, wherein the at least one membrane filter is a crossflow tubular ultrafiltration membrane.

7. The solid precipitation reactor of claim 1, wherein the at least one membrane filter is made of a polyvinylidene fluoride, polyethersulfone, polyacrylonitrile, or ceramic material.

8. The solid precipitation reactor of claim 1, wherein the at least one membrane filter comprises tubular, flat sheet, or hollow fiber.

9. The solid precipitation reactor of claim 1, wherein the at least one membrane filter has a pore size between 0.005 micrometers and 0.2 micrometers.

10. The solid precipitation reactor of claim 1, further comprising an agitator system configured to mix the feedwater within the reaction chamber.

11. The solid precipitation reactor of claim 1, further comprising a solids harvesting loop wherein suspended particulates in the reactor are removed and a liquid effluent is returned to the reactor.

12. The solid precipitation reactor of claim 11, wherein the solids harvesting loop comprises a media filter.

13. The solid precipitation reactor of claim 11, wherein the solids harvesting loop comprises a filtration sock or a paper filter.

14. The solid precipitation reactor of claim 11, wherein the media filter, filtration sock, or paper filter have pore sizes between 1 micrometer to 500 micrometers.

15. The solid precipitation reactor of claim 11, wherein the reaction chamber operates in at least one of a continuous mode or a batch mode.

16. The solid precipitation reactor of claim 1, further comprising a pump system configured to control a flow of feedwater through the reaction chamber and membrane module.

17. The solid precipitation reactor of claim 1, further comprising a transducer system.

18. The solid precipitation reactor of claim 17, wherein the transducer system measures at least one of a pressure of the feedwater, a pressure of the permeate, or a pressure of the concentrate.

19. The solid precipitation reactor of claim 1, wherein the reactor is configured for precipitation of magnesium ammonium phosphate (MAP).

20. A system for wastewater treatment, the system comprising:
a digesting unit configured to received wastewater and to pre-treat the wastewater to produce feedwater;
the solid precipitation reactor of claim 1 that receives feedwater from the digesting unit to produce a permeate; and
an ion exchange unit that receives the permeate from the reaction chamber of the solid precipitation reactor to produce treated permeate, optionally wherein the ion exchange unit comprises a zeolite cation exchanger.

21. (canceled)

22. (canceled)

23. (canceled)

24. (canceled)

25. (canceled)

26. A method for treating wastewater, comprising
injecting wastewater comprising ammonium ions (NH₄⁺) and phosphate ions (PO₄³⁻) into the solid precipitation reactor of claim 1;
contacting the injected wastewater in the reactor with magnesium ions (Mg²⁺) and optionally additional phosphate ions (PO₄³⁻), thereby producing a mixture comprising a solid; and
filtering the mixture thereby isolating the solid and producing precipitation-treated water.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A method of regenerating a zeolite cation exchanger having bound ammonium ions, comprising
contacting the zeolite cation exchanger having bound ammonium ions with a regenerating solution to produce a regenerated zeolite cation exchanger and a zeolite waste solution comprising the ammonium ions; and
introducing the zeolite waste solution to the solid precipitation reactor of claim 1 to generate a solid and a permeate.

46. (canceled)

47. (canceled)

48. (canceled)

49. (canceled)

50. (canceled)

51. A system for wastewater treatment, the system comprising:
a digesting unit configured to received wastewater and to pre-treat the wastewater to produce feedwater; and
an ion exchange unit comprising a zeolite cation exchanger, the ion exchange unit being configured to receive feedwater from the digesting unit to produce zeolite-treated water, whereby ammonium ions in the feedwater bind to the zeolite cation exchanger.

52. (canceled)

53. (canceled)

54. (canceled)

55. (canceled)

56. (canceled)

57. (canceled)
